(19) United States
(12) Patent Application Publication
(10) Pub. No.: US 2004/0024102 A1
(43) Pub. Date: Feb. 5, 2004

(54) Sulfonated aliphatic-aromatic polyetherester films, coatings, and laminates

(76) Inventors: Richard Allen Hayes, Brentwood, TN (US); Lori J. Pike, Newark, DE (US); Jennifier M. Schneider, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/279,391

(22) Filed: Oct. 24, 2002

Related U.S. Application Data
(63) Continuation-in-part of application No. 10/209,369, filed on Jul. 30, 2002.

(51) Int. Cl. C08K 3/26; C08K 3/34

(52) U.S. Cl. 524/445; 524/425

(57) ABSTRACT

Articles, including films, coatings and laminates, are produced from certain sulfonated aliphatic-aromatic polyetherester compositions, which have an optimized combination of fast biodegradation rates and enhanced thermal properties when compared to the sulfonated aliphatic-aromatic polyetherester compositions of the art. The articles may be further processed to form useful shaped articles, such as sheets, thermoformed containers, and coatings that can be applied to, for example, films or other substrates. The disclosed polyetheresters are based on copolyesters produced from a mixture containing aromatic dicarboxylic acids, aliphatic dicarboxylic acids, poly(alkylene ether) glycols, glycols, and components containing alkali metal or alkaline earth metal sulfo groups.

### CROSS-REFERENCE TO RELATED APPLICATIONS

This is a continuation-in-part of U.S. application Ser. No. 10/209,369 filed Jul. 30, 2002, herein incorporated by reference in its entirety.

### BACKGROUND OF THE INVENTION

1. Field of the Invention

This invention relates to polyetheresters films, coatings, and laminates. More particularly, this invention relates to sulfonated aliphatic-aromatic polyetheresters that have advantageous thermal properties and are biodegradable.

2. Description of Related Art

The inadequate treatment of municipal solid waste which is being put in landfills and the increasing addition of nondegradable materials, including plastics, to municipal solid waste streams are combining to drastically reduce the number of landfills available and to increase the costs of municipal solid waste disposal. While recycling of reusable components of the waste stream is desirable in many instances, the costs of recycling and the infrastructure required to recycle materials is sometimes prohibitive. In addition, there are some products which do not easily fit into the framework of recycling. The composting of non-recyclable solid waste is a recognized and growing method to reduce solid waste volume for landfilling and/or making a useful product from the waste to improve the fertility of fields and gardens. One of the limitations to marketing such compost is the visible contamination by undegraded plastic, such as film or fiber fragments.

It is desired to provide components which are useful in disposable products and which are degraded into less contaminating forms under the conditions typically existing in waste composting processes. These conditions may involve temperatures no higher than 70° C., and averaging in the 55-60° C. range, humid conditions as high as 100 percent relative humidity, and exposure times which range from weeks to months. It is further desirable to provide disposable components which will not only degrade aerobically/anaerobically in composting, but will continue to degrade in the soil or landfill. As long as water is present, they will continue to break down into low molecular weight fragments which can be ultimately biodegraded by microorganisms completely into biogas, biomass, and liquid leachate, as for natural organics like wood.

Polyesters have been considered for biodegradable articles and end uses in the past. These biodegradable polyesters can be described as belonging to three general classes: aliphatic polyesters; aliphatic-aromatic polyesters; and sulfonated aliphatic-aromatic polyesters.

Materials that incorporate too high levels of poly(alkylene ether) glycols may not provide the desired thermal properties for some end uses such as films, coatings or laminates. Other known materials have an undesirably low biodegradation rate.

Improvements in some physical properties of materials used for films, coatings or laminates can be obtained by the use of blends, as disclosed in WO 02/16468 A1. However, the use of polymeric blends may require the use of additional and/or complicated steps in forming films, coating, or laminates.

The present invention overcomes shortcomings found in known materials used in biodegradable packaging, and provides sulfonated aliphatic-aromatic polyetherester materials that combine an optimized combination of good biodegradation rates with enhanced thermal properties for utility into shaped articles, such as films, coatings, and laminates.

### BRIEF SUMMARY OF THE INVENTION

The present invention provides sulfonated aliphatic-aromatic copolyetheresters that offer improved physical properties as compared to conventional polymers typically used in packaging and particularly biodegradable packaging. Also within the scope of the present invention are articles made from the sulfonated aliphatic-aromatic copolyetheresters, including packaging materials, and processes for making the articles. Although the processes and compositions of the present invention can eliminate the need to use blends of polymers for use in forming articles such as films, coatings or laminates, compositions comprising blends of two or more sulfonated aliphatic-aromatic copolyetheresters, or blends of one or more sulfonated aliphatic-aromatic copolyetheresters with one or more other polymers, are within the scope of the invention.

One aspect of the present invention includes film comprised of sulfonated aliphatic-aromatic copolyetheresters that contain from about 0.1 to 4.0 mole percent of a poly (alkylene ether) glycol component. Said sulfonated aliphatic-aromatic copolyetheresters comprise 80.0 to 20.0 mole percent of an aromatic dicarboxylic acid component and 20.0 to 80.0 mole percent of an aliphatic dicarboxylic acid component, based on 100 total mole percent of dicarboxylic acid components; and from 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent, based on a total of 100 mole percent of glycol components, sulfonate component, and polyfunctional branching agent. The sulfonate component can include one, two or more sulfonate compounds. Also, the term “polyfunctional branching agent” as used herein can include one, two or more compounds that function as polyfunctional branching agents. Said sulfonated aliphatic-aromatic copolyetheresters may optionally incorporate fillers. The films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes oriented film, such as uniaxially or biaxially oriented film, comprised of sulfonated aliphatic-aromatic copolyetheresters that incorporate between 0.1 to 4.0 mole percent of a poly (alkylene ether) glycol component. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The oriented films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes films laminated onto substrates comprised of sulfonated aliphatic-aromatic copolyetheresters that incorporate between 0.1 to 4.0 mole percent of a poly (alkylene ether) glycol component. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The laminated films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes films coated onto substrates comprised of sulfonated aliphatic-aromatic copolyetheresters that incorporate between 0.1 to 4.0 mole percent of a poly (alkylene ether) glycol component. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The coated films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes processes to produce film comprised of sulfonated aliphatic-aromatic copolyetheresters that incorporate between 0.1 to 4.0 mole percent of a poly (alkylene ether) glycol component. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes processes to produce oriented film, such as uniaxially or biaxially oriented film, comprised of sulfonated aliphatic-aromatic copolyetheresters that incorporate between 0.1 to 4.0 mole percent of a poly (alkylene ether) glycol component and processes to produce same. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The oriented films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes processes to produce films laminated onto substrates comprised of sulfonated aliphatic-aromatic copolyetheresters that incorporate between 0.1 to 4.0 mole percent of a poly (alkylene ether) glycol component and processes to produce same. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The laminated films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes processes to produce films coated onto substrates comprised of sulfonated aliphatic-aromatic copolyetheresters that incorporate between 0.1 to 4.0 mole percent of a poly (alkylene ether) glycol component and processes to produce same. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The coated films of said sulfonated aliphatic-aromatic copolyetheresters of the present invention are found to have an optimized balance of physical properties, such as toughness, thermal dimensional stability and moisture barrier, than found for films of the sulfonated aliphatic-aromatic copolyetheresters of the art.

A further aspect of the present invention includes the use of film comprised of sulfonated aliphatic-aromatic copolyetheresters that incorporate between 0.1 to 4.0 mole percent of a poly (alkylene ether) glycol component for food packaging end uses, especially for disposable food packaging end uses such as food wraps. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The food packaging films of said sulfonated aliphatic-aromatic copolyetheresters of the present invention are found to have an optimized balance of physical properties, such as toughness, thermal dimensional stability and moisture barrier, than found for food packaging films of the sulfonated aliphatic-aromatic copolyetheresters of the art.

A further aspect of the present invention includes the use of oriented film, such as uniaxially or biaxially oriented film, comprised of sulfonated aliphatic-aromatic copolyetheresters that incorporate between 0.1 to 4.0 mole percent of a poly (alkylene ether) glycol component for food packaging end uses. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The oriented food packaging films of said sulfonated aliphatic-aromatic copolyetheresters of the present invention are found to have an optimized balance of physical properties, such as toughness, thermal dimensional stability and moisture barrier, than found for food packaging films of the sulfonated aliphatic-aromatic copolyetheresters of the art.

A further aspect of the present invention includes the use of films laminated onto substrates comprised of sulfonated aliphatic-aromatic copolyetheresters that incorporate between 0.1 to 4.0 mole percent of a poly (alkylene ether) glycol component for food packaging or food service end uses. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The foods packaging or food service laminated films of said sulfonated aliphatic-aromatic copolyetheresters of the present invention are found to have an optimized balance of physical properties, such as toughness, thermal dimensional stability and moisture barrier, than found for food packaging or food service laminated films of the sulfonated aliphatic-aromatic copolyetheresters of the art.

A further aspect of the present invention includes the use of films coated onto substrates comprised of sulfonated aliphatic-aromatic copolyetheresters that incorporate between 0.1 to 4.0 mole percent of a poly (alkylene ether) glycol component for food packaging or food service end uses. Said substrates may include, for example, paper, paperboard, inorganic foams, organic foams, inorganic-organic foams, and the like. Said sulfonated aliphatic-aromatic copolyetheresters are comprised essentially of 80.0 to 20.0 mole percent of an aromatic dicarboxylic acid component, 20.0 to 80.0 mole percent of an aliphatic dicarboxylic acid component, 0.1 to 10.0 mole percent of a sulfonate component, 99.9 to 76.0 mole percent of a glycol component, 0.1 to 4.0 mole percent of a poly (alkylene ether) glycol component, and 0 to 5.0 mole percent of a polyfunctional branching agent. Said sulfonated aliphatic-aromatic copolyetheresters may optionally incorporate fillers. The food packaging or food service coated films of said sulfonated aliphatic-aromatic copolyetheresters of the present invention are found to have an optimized balance of physical properties, such as toughness, thermal dimensional stability and moisture barrier, than found for food packaging or food service coated films of the sulfonated aliphatic-aromatic copolyetheresters of the art.

### DETAILED DESCRIPTION OF THE INVENTION

The present invention includes articles, such as films, coatings, and laminates of certain sulfonated aliphatic-aromatic copolyetheresters and processes to produce the articles. The present invention further includes uses of the films, coatings and laminates. Such uses include depositing or adhering them onto substrates, such as for example, paper, paperboard, inorganic foams, organic foams, inorganic-organic foams, and the like, for food packaging end uses, especially for disposable food packaging such as wraps, cups, bowls, plates and the like. The sulfonated aliphatic-aromatic copolyetheresters comprise 80.0 to 20.0 mole percent of an aromatic dicarboxylic acid component, and 20.0 to 80.0 mole percent of an aliphatic dicarboxylic acid component, based on 100 mole percent total of aromatic dicarboxylic acid component and aliphatic dicarboxylic acid component; and 0.1 to 10.0 mole percent of a sulfonate component, 99.9 to 76.0 mole percent of a first glycol selected from the group consisting of ethylene glycol, 1,3-propanediol and 1,4-butanediol; 0.1 to 4.0 mole percent of a poly (alkylene ether) glycol component; 0 to 5.0 mole percent of a second glycol component; and 0 to 5.0 mole percent of a polyfunctional branching agent, based on 100 mole percent total of first glycol, poly (alkylene ether) glycol component, optional second glycol component and optional polyfunctional branching agent.

The term “component” as used herein to refer to dicarboxylic acids, sulfonates, and glycols contained within the disclosed sulfonated aliphatic-aromatic copolyetheresters, is not intended to limit the dicarboxylic acid, sulfonate and/or glycol to a single chemical moiety. Thus, for example, a “dicarboxylic acid component” can include one, two, or more distinct dicarboxylic acids. However, the first glycol component preferably consists of a single glycol selected from the group consisting of ethylene glycol, 1,3-propanediol and 1,4-butanediol.

The sulfonated aliphatic-aromatic copolyetheresters disclosed herein may be referred to herein for simplicity as “copolyetheresters” or “sulfonated copolyetheresters”. Unless stated otherwise, the terms “copolyetheresters” or “sulfonated copolyetheresters” are intended to refer to the sulfonated aliphatic-aromatic copolyetheresters disclosed and claimed herein.

The aromatic dicarboxylic acid component is selected from unsubstituted and substituted aromatic dicarboxylic acid and the lower alkyl esters of aromatic dicarboxylic acids having from 8 carbons to 20 carbons. Examples of desirable diacid moieties include those derived from terephthalates, isophthalates, naphthalates and bibenzoates. Specific examples of the desirable aromatic dicarboxylic acid component include terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), and the like and mixtures derived therefrom. Preferably, the aromatic dicarboxylic acid component is derived from terephthalic acid, dimethyl terephthalate, isophthalic acid, dimethyl isophthalate, 2,6-naphthalene dicarboxylic acid, dimethyl-2,6-naphthalate, and mixtures derived therefrom. This should not be considered limiting. Essentially any aromatic dicarboxylic acid known in the art may find utility within the present invention. Preferably, the sulfonated polyetherester compositions of the present invention should include between 80 and 50 mole percent of said aromatic dicarboxylic acid component.

The aliphatic dicarboxylic acid component is selected from unsubstituted, substituted, linear, and branched, aliphatic dicarboxylic acids and the lower alkyl esters of aliphatic dicarboxylic acids having 2 to 36 carbon atoms. Specific examples of desirable aliphatic dicarboxylic acid component include, oxalic acid, dimethyl oxalate, malonic acid, dimethyl malonate, succinic acid, dimethyl succinate, methylsuccinc acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, and the like and mixtures derived therefrom. Preferably, the aliphatic dicarboxylic acid component is selected from the group consisting of succinc acid, dimethyl succinate, glutaric acid, dimethyl glutarate, adipic acid, dimethyl adipate and mixtures thereof. This should not be considered limiting. Essentially any aliphatic dicarboxylic acid known within the art may find utility within the present invention. Preferably, the sulfonated polyetherester compositions of the present invention should include between 20 and 50 mole percent of said aliphatic dicarboxylic acid component.

The sulfonated aliphatic-aromatic copolyetheresters preferably includes about 0.1 to 10.0 mole percent of sulfo groups. Said sulfo groups may be introduced in aliphatic or aromatic monomers or may be introduced as end groups. A monomer or other moiety that provides a sulfo group is referred to herein as a “sulfonate component”. Exemplary aliphatic sufonate components include the metal salts of sulfosuccinic acid. Specific examples of aromatic sulfonate components useful as end groups include the metal salts of 3-sulfobenzoic acid, 4-sulfobenzoic acid, 5-sulfosalicylic acid. Preferred are sulfonate components whereby the sulfonate salt group is attached to an aromatic dicarboxylic acid. Said aromatic dicarboxylic acid may be benzene, naphthalene, diphenyl, oxydiphenyl, sulfonyldiphenyl, methylenediphenyl or the like. Preferably, the sulfonate monomer is the residue of a sulfonate-substituted phthalic acid, terephthalic acid, isophthalic acid, and 2,6-naphthalenedicarboxylic acid. More preferably, the sulfonate component is a metal salt of 5-sulfoisophthalic acid or a lower alkyl ester of 5-sulfoisophthalate. The metal salt may be a monovalent or polyvalent alkali metal ion, alkaline earth metal ion, other metal ion or the like. Preferred alkali metal ions include, for example, sodium, potassium and lithium. However, alkaline earth metals such as magnesium are also useful. Other useful metal ions include the transition metal ions, such as zinc, cobalt or iron. The multivalent metal ions may be used when an increase in the melt viscosity of a sulfonated aliphatic-aromatic copolyester is desired. End use examples where such melt viscosity enhancements may prove useful include melt extrusion coatings, melt blown containers or film, and foam. It has been found that as little as 0.1 mole percent of the sulfo group contributes significantly to the property characteristics of the resultant films or coatings. Preferably, the amount of sulfonate component in the sulfonated polyetherester compositions of the present invention is from about 0.1 to about 4.0 mole percent.

The poly (alkylene ether) glycols preferably have a molecular weight in the range of about 500 to about 4000. Specific examples of poly (alkylene ether) glycols useful within the present invention include, for example; poly (ethylene glycol), poly (1,3-propylene glycol), poly (1,4-butylene glycol), (polytetrahydrofuran), poly (pentamethylene glycol), poly (hexamethylene glycol), poly (heptamethylene glycol), poly (ethylene glycol)-block-poly (propylene glycol)-block-poly (ethylene glycol), 4,4′-isopropylidenediphenol ethoxylate (Bisphenol A ethoxylate), 4,4′-(1-phenylethylidene)bisphenol ethoxylate (Bisphenol AP ethoxylate), 4,4′-ethylidenebisphenol ethoxylate (Bisphenol E ethoxylate), bis(4-hydroxyphenyl)methane ethoxylate (Bisphenol F ethoxylate), 4,4′-(1,3-phenylenediisopropylidene)bisphenol ethoxylate (Bisphenol M ethoxylate), 4,4′-(1,4-phenylenediisopropylidene)bisphenol ethoxylate (Bisphenol P ethoxylate), 4,4′sulfonyldiphenol ethoxylate (Bisphenol S ethoxylate), 4,4′-cyclohexylidenebisphenol ethoxylate (Bisphenol Z ethoxylate) and the like, and mixtures thereof. This should not be considered limiting. Essentially any poly (alkylene ether) glycols known within the art may find use in the compositions and processes of the present invention.

The optional second glycol component is selected from unsubstituted, substituted, straight chain, branched, cyclic aliphatic, aliphatic-aromatic and aromatic diols having from 2 carbon atoms to 36 carbon atoms. Specific examples of suitable second glycol components include ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 4,8-bis (hydroxymethyl)-tricyclo (5.2.1.0/2.6) decane, 1,4-cyclohexanedimethanol, isosorbide, di (ethylene glycol), tri (ethylene glycol) and the like and mixtures derived therefrom. This should not be taken as limiting. Essentially any other glycol known within the art may find use in the compositions and processes of the present invention.

The optional polyfunctional branching agent can be any agent having three or more carboxylic acid functions, hydroxy functions or a mixture thereof. Specific examples of suitable polyfunctional branching agents include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, 2,2-bis(hydroxymethyl)propionic acid, and the like and mixture therefrom. This should not be considered limiting. Essentially any polyfunctional material that includes three or more carboxylic acid or hydroxyl functions may find use within the present invention. Said polyfunctional branching agent may be included when higher resin melt viscosity is desired for specific end uses. Examples of said end uses may include melt extrusion coatings, melt blown films or containers, foam and the like. Preferably, the sulfonated polyetherester composition includes 0 to 1.0 mole percent of said polyfunctional branching agent.

The sulfonated aliphatic-aromatic copolyetheresters preferably have an inherent viscosity of at least equal to or greater than 0.15. For some applications, the inherent viscosity, (IV), of said sulfonated aliphatic-aromatic copolyesters is preferably at least 0.35 dL/g, as measured on a 0.5 percent (weight/volume) solution of the copolyester in a 50:50 (weight) solution of trifluoroacetic acid:dichloromethane at room temperature. Higher inherent viscosities are desirable for other applications, such as films, bottles, sheet, molding resin and the like. The polymerization conditions may be adjusted to obtain the desired inherent viscosities up to at least about 0.5 and desirably higher than 0.65 dL/g. Further processing of the copolyester may achieve inherent viscosities of 0.7, 0.8, 0.9, 1.0, 1.5, 2.0 dL/g and even higher.

The inherent viscosity is an indicator of the molecular weight of the sulfonated aliphatic-aromatic copolyetheresters. Instead of measuring the molecular weight of the polymer directly, the inherent viscosity of the polymer in solution or the melt viscosity is used as an indicator of molecular weight. The inherent viscosities are useful for comparisons of molecular weights within a polymer family, such as poly (ethylene terephthalate), poly (butylene terephthalate), etc., and are used as the indicator of molecular weight herein.

The sulfonated aliphatic-aromatic copolyetheresters can be prepared by conventional polycondensation techniques. The product compositions may vary somewhat based on the method of preparation used, particularly in the amount of diol that is present within the polymer. These methods include the reaction of the diol monomers with the acid chlorides. For example, acid chlorides of the aromatic dicarboxylic acid component, acid chlorides of the aliphatic dicarboxylic acid component, and acid chlorides of the sulfonate component may be combined with the glycol, the poly (alkylene ether) glycol, and the other glycol component in a solvent, such as toluene, in the presence of a base, such as pyridine, which neutralizes the hydrochloric acid as it is produced. Such procedures are disclosed, for example, by R. Storbeck, et al., in J. Appl. Polymer Science, Vol. 59, pp. 1199-1202 (1996). Other well-known variations using acid chlorides may also be used, such as interfacial polymerization methods, or the monomers may simply be stirred together while heating.

When the polymer is made using acid chlorides, the ratio of the monomer units in the product polymer is about the same as the ratio of reacting monomers. Therefore, the ratio of monomers charged to the reactor is about the same as the desired ratio in the product. A stoichiometric equivalent of the diol components and the diacid components generally will be used to obtain a desirably high molecular weight polymer.

Preferably, the sulfonated aliphatic-aromatic copolyetheresters of the present invention are produced by melt polymerization. In melt polymerization, the aromatic dicarboxylic acid component, (either as acids, esters, or mixtures thereof, the aliphatic dicarboxylic acid component, (either as acids, esters, or mixtures thereof), the sulfonate component, the glycol, the poly (alkylene ether) glycol, the other glycol component and optionally the polyfunctional branching agent, are combined in the presence of a catalyst to a high enough temperature that the monomers combine to form esters and diesters, then oligomers, and finally polymers. The polymeric product at the end of the polymerization process is a molten product. Generally, the other diol component and the ethylene glycol are volatile and distill from the reactor as the polymerization proceeds. Such procedures are generally known to those skilled in the art.

The melt process conditions, particularly the amounts of monomers used, depend on the polymer composition that is desired. The amount of ethylene glycol, second glycol component, aromatic dicarboxylic acid component, aliphatic acid component, sulfonate compound and branching agent are chosen so that the final polymeric product contains the desired amounts of the various monomer units. In some preferred embodiments, the product contains equimolar amounts of monomer units derived from the respective diol and diacid components. Because of the volatility of some of the monomers, especially some of the first and/or second glycol components, and depending on such variables as whether the reactor is sealed, (i.e.; is under pressure), the polymerization temperature ramp rate, and the efficiency of distillation columns used in synthesizing the polymer, it may be desirable to provide some of the monomers in excess at the beginning of the polymerization reaction and remove the excess by distillation as the reaction proceeds. For example, it may be preferable that the first glycol component and/or the second glycol component are provided in excess at the beginning of polymerization.

The exact amount of monomers to be charged to a particular reactor is readily determined by a skilled practitioner, but often will be within the following ranges. Excesses of the diacid, the first glycol, and/or the second glycol component are often desirably charged, and the excess diacid, first glycol and/or second glycol is desirably removed by distillation or other method of evaporation as the polymerization reaction proceeds. Ethylene glycol, 1,3-propanediol, and 1,4-butanediol are desirably charged at a level 10 to 100 percent greater than the level desired in the final polymer. More preferably, the first glycol component is charged at a level 20 to 70 percent greater than the desired incorporation level in the final polymer. The second glycol component is desirably charged at a level 0 to 100 percent greater than the desired level desired in the final product, depending on the volatility of the second glycol component.

It will be appreciated by one skilled in the art that the ranges for the amount of each monomer vary due to the wide variation in the monomer loss during polymerization, depending on the efficiency of distillation columns and other kinds of recovery and recycle systems and the like, and are only an approximation. Exact amounts of monomers that are charged to a specific reactor to achieve a specific composition are readily determined by a skilled practitioner.

In the polymerization process, the monomers are combined, and heated gradually with mixing in the presence of a catalyst or catalyst mixture to a temperature in the range of about 230° C. to about 300° C., desirably 250° C. to 295° C. The exact conditions and the nature of the catalyst or catalysts depend on whether the diacids are polymerized as true acids or as dimethyl esters. The catalyst may be combined initially with the monomers, and/or may be added one or more times to the mixture as it is heated. The catalyst used may be changed as the reaction proceeds. The heating and stirring are continued for a sufficient time and to a sufficient temperature, generally with removal by distillation of excess reactants, to yield a molten polymer having a molecular weight suitable for making fabricated products.

Catalysts that may be used include salts of Li, Ca, Mg, Mn, Zn, Pb, Sb, Sn, Ge, and Ti, such as acetate salts and oxides, including glycol adducts, and Ti alkoxides. These are generally known in the art, and the specific catalyst or combination or sequence of catalysts used may be readily selected by a skilled practitioner. The preferred catalyst and preferred conditions differ depending on, for example, whether the diacid monomer is polymerized as the free diacid or as a dimethyl ester and the exact chemical identity of the glycol components. This should not be considered limiting. Essentially any catalyst system known within the art will find use within the present invention.

The monomer composition of the polymer is chosen for specific uses and for specific sets of properties. As one skilled in the art will appreciate, the exact thermal properties observed are determined, in part, by the chemical identity and amount of each component utilized in the copolyester composition.

Polymers can be made by the melt condensation process above having adequate inherent viscosity for many applications. Solid state polymerization may be used to achieve even higher inherent viscosities and higher molecular weights.

Polymers made by melt polymerization, after extruding, cooling and pelletizing, may be essentially noncrystalline. Noncrystalline material can be made semicrystalline heating it to a temperature above the glass transition temperature for an extended period of time. This induces crystallization so that the product can then be heated to a higher temperature to raise the molecular weight. Such procedures are known to those skilled in the art. The polymer may also be crystallized prior to solid state polymerization by treatment with a relatively poor solvent for polyesters, which induces crystallization. Such solvents reduce the glass transition temperature (Tg) allowing for crystallization. Solvent induced crystallization is known for polyesters and is described in U.S. Pat. No. 5,164,478 and U.S. Pat. No. 3,684,766, the disclosures of which are hereby incorporated herein by reference. The semicrystalline polymer can be subjected to solid state polymerization by placing the polymer in pelletized or pulverized form into a stream of an inert gas, such as nitrogen, or under a vacuum of 1 Torr, at an elevated temperature, below the melting temperature of the polymer, for an extended period of time.

It is understood that the sulfonated aliphatic-aromatic copolyetheresters of the present invention may be used with additives known within the art. It is preferred that said additives are nontoxic, biodegradable and biobenign. Such additives may include thermal stabilizers, for example, phenolic antioxidants, secondary thermal stabilizers, for example, thioethers and phosphites, UV absorbers, for example benzophenone- and benzotriazole-derivatives, UV stabilizers, for example, hindered amine light stabilizers, (HALS), and the like. Said additives may further include plasticizers, processing aids, flow enhancing additives, lubricants, pigments, flame retardants, impact modifiers, nucleating agents to increase crystallinity, antiblocking agents such as silica, base buffers, such as sodium acetate, potassium acetate, and tetramethyl ammonium hydroxide, for example as disclosed in U.S. Pat. No. 3,779,993, U.S. Pat. No. 4,340,519, U.S. Pat. No. 5,171,308, U.S. Pat. No. 5,171,309, and U.S. Pat. No. 5,219,646 and references cited therein.

Preferred plasticizers are nontoxic and biodegradable and/or bioderived. Specific examples of plasticizers, which may be added to improve processing, provide specific desired final mechanical properties, or to reduce rattle or rustle of the films, coatings and laminates produced from the polymers, include: soybean oil, epoxidized soybean oil, corn oil, caster oil, linseed oil, epoxidized linseed oil, mineral oil, alkyl phosphate esters, Tween® 20 plasticizer, Tween® 40 plasticizer, Tween® 60 plasticizer, Tween® 80 plasticizer, Tween® 85 plasticizer, sorbitan monolaurate, sorbitan monooleate, sorbitan monopalmitate, sorbitan trioleate, sorbitan monostearate, citrate esters, such as trimethyl citrate, triethyl citrate (e.g., Citroflex® 2 triethyl citrate, produced by Morflex, Inc. Greensboro, N.C.), tributyl citrate (e.g., Citroflex® 4 tributyl citrate, produced by Morflex, Inc., Greensboro, N.C.), trioctyl citrate, acetyl tri-n-butyl citrate (e.g., Citroflex® A-4 acetyl tri-n-butyl citrate, produced by Morflex, Inc., Greensboro, N.C.), acetyltriethyl citrate (e.g., Citroflex® A-2 acetyltriethyl citrate, produced by Morflex, Inc., Greensboro, N.C.), acetyltri-n-hexyl citrate (e.g., Citroflex® A-6 acetyltri-n-citrate, produced by Morflex, Inc., Greensboro, N.C.), and butyryltri-n-hexyl citrate (e.g, Citroflex® B-6 butyryltri-n-hexyl citrate, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex® 600 concentrated glycerol monostearates, Nyvaplex® concentrated glycerol monostearate, which is a 90% minimum distilled monoglyceride produced from hydrogenated soybean oil and which is composed primarily of stearic acid esters), Myvacet® distilled acetylated monoglycerides of modified fats, Myvacet® 507 (48.5 to 51.5 percent acetylation), Myvacete 707, (66.5 to 69.5 percent acetylation), Myvacet® 908, (minimum of 96 percent acetylation), Myverol® concentrated glyceryl monostearates), Acrawax® N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex® plasticizer, and other compatible low molecular weight polymers and the like, and mixtures thereof.

In addition, the compositions of the present invention may be filled with inorganic, organic and/or clay fillers, such as, for example, wood flour, gypsum, talc, mica, carbon black, wollastonite, montmorillonite minerals, chalk, diatomaceous earth, sand, gravel, crushed rock, bauxite, limestone, sandstone, aerogels, xerogels, microspheres, porous ceramic spheres, gypsum dehydrate, calcium aluminate, magnesium carbonate, ceramic materials, pozzolamic materials, zirconium compounds, xonotlite (a crystalline calcium silicate gel), perlite, vermiculite, hydrated or unhydrated hydraulic cement particles, pumice, perlite, zeolites, kaolin, clay fillers, including both natural and synthetic clays and treated and untreated clays, such as organoclays and clays that have been surface treated with silanes and stearic acid to enhance adhesion with the copolyester matrix, smectite clays, magnesium aluminum silicate, bentonite clays, hectorite clays, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, seagel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, recycled paper fibers, for example, from repulping operations, and the like. Fillers may tend to increase the Young's modulus, improve the dead-fold properties, improve the rigidity of the film, coating or laminate, decrease the cost, and/or reduce the tendency of a film, coating, or laminate to block or self-adhere during processing or use. The use of fillers has also been found to produce plastic articles that have many of the qualities of paper, such as texture and feel, as disclosed by, for example, Miyazaki, et. al., in U.S. Pat. No. 4,578,296.

Clay fillers include both natural and synthetic clays and untreated and treated clays, such as organoclays and clays that have been surface treated with silanes or stearic acid to enhance their adhesion to the copolyester matrix. Specific usable clay materials include, for example, kaolin, smectite clays, magnesium aluminum silicate, bentonite clays, montmorillonite clays, hectorite clays, and the like and mixtures thereof. The clays may be treated with organic materials, such as surfactants, to make them organophilic. Specific commercial examples of usable clay fillers include Gelwhite® MAS 100, a commercial product of the Southern Clay Company, which is described in manufacturer literature as a white smectite clay (magnesium aluminum silicate); Claytone® 2000, a commercial product of the Southern Clay Company, which is described in manufacturer literature as a an organophilic smectite clay; Gelwhite® L, a commercial product of the Southern Clay Company, which is defined as a montmorillonite clay from a white bentonite clay; Cloisite® 30 B, a commercial product of the Southern Clay Company, which is defined as an organphilic natural montmorillonite clay with bis(2-hydroxyethyl)methyl tallow quarternary ammonium chloride salt; Cloisite® Na, a commercial product of the Southern Clay Company, which is described in manufacturer literature as a natural montmorillonite clay; Garamite 1958, a commercial product of the Southern Clay Company, which is described in manufacturer literature as a mixture of minerals; Laponite® RDS, a commercial product of the Southern Clay Company, which is described in manufacturer literature as a synthetic layered silicate with an inorganic polyphosphate peptiser; Laponite® RD, a commercial product of the Southern Clay Company, which is described in manufacturer literature as a synthetic colloidal clay; Nanomers®, which are commercial products of the Nanocor Company, which are described in manufacturer literature as montmorillonite minerals that have been treated with compatibilizing agents; Nanomer® 1.24TL, a commercial product of the Nanocor Company, which is described in manufacturer literature as a montmorillonite mineral surface treated with amino acids; “P Series” Nanomers®, which are commercial products of the Nanocor Company, which are described in manufacturer literature as surface modified montmorillonite minerals; Polymer Grade (PG) Montmorillonite PGW, a commercial product of the Nanocor Company, which is described in manufacturer literature as a high purity aluminosilicate mineral, sometimes referred to as a phyllosilicate; Polymer Grade (PG) Montmorillonite PGA, a commercial product of the Nanocor Company, which is described in manufacturer literature as a high purity aluminosilicate mineral, sometimes referred to as a phyllosilicate; Polymer Grade (PG) Montmorillonite PGV, a commercial product of the Nanocor Company, which is described in manufacturer literature as a high purity aluminosilicate mineral, sometimes referred to as a phyllosilicate; Polymer Grade (PG) Montmorillonite PGN, a commercial product of the Nanocor Company, which is described in manufacturer literature as a high purity aluminosilicate mineral, sometimes referred to as a phyllosilicate; and the like and mixtures thereof. This should not be considered limiting. Essentially any clay filler known within the art will find utility in the present invention.

Some of the desirable clay fillers of the present invention may exfoliate to provide nanocomposites. This is especially true for the layered silicate clays, such as smectite clays, magnesium aluminum silicate, bentonite clays, montmorillonite clays, hectorite clays, and the like. As discussed above, such clays may be natural or synthetic, treated or not. This should not be considered limiting. The clay particle size in the final filled sulfonated aliphatic aromatic copolyetherester may be within a wide range.

The particle size of the filler may vary, and, as one skilled within the art will appreciate, the filler particle size may be tailored based in part on the desired use of the filled copolyester composition. It is generally preferable that the average particle diameter of the filler be less than about 40 microns. It is more preferable that the average diameter of the filler be less than about 20 microns. However, this should not be considered limiting, and for certain end use applications, particle sizes larger than 40 microns may be suitable or desired. The filler may include particle sizes ranging up to 40 mesh, (US Standard), or larger. Mixtures of filler particle sizes may also be advantageously utilized. For example, mixtures of calcium carbonate fillers with average particle sizes of about 5 microns and of about 0.7 microns may provide better space filling of the filler within the copolyester matrix. Use of two or more filler particle sizes allows for improved particle packing. Particle packing is the process of selecting two or more ranges of filler particle sizes in order that the spaces between a group of large particles is substantially occupied by a selected group of smaller filler particles. In general, the particle packing will be increased whenever any given set of particles is mixed with another set of particles having a particle size that is at least about 2 times larger or smaller than the first group of particles. The particle packing density for a two-particle system will be maximized whenever the size ratio of a given set of particles is from about 3 to 10 times the size of another set of particles. Similarly, three or more different sets of particles may be used to further increase the particle packing density. The degree of packing density that is optimal for a particular application or composition depends on a number of factors, including, for example, the types and concentrations of the various components within both the thermoplastic phase and the solid filler phase, the film, coating or lamination process used, and the desired mechanical, thermal and other performance properties of the final products to be manufactured. Andersen, et al., in U.S. Pat. No. 5,527,387, disclose particle packing techniques. Filler concentrates that incorporate a mixture of filler particle sizes based on the above particle packing techniques are commercially available from the Shulman Company under the trademark Papermatch®.

Filler may be added to a copolyester at any stage during the polymerization or after the polymerization is completed. For example, the filler may be added with the copolyester monomers at the start of the polymerization process. This is preferable for, for example, the silica and titanium dioxide fillers, to provide adequate dispersion of the fillers within the polyester matrix. Alternatively, the filler may be added at an intermediate stage of the polymerization, for example, when a precondensate has formed and as the precondensate passes into the polymerization vessel. As yet a further alternative, the filler may be added after the copolyester exits the polymerizer. For example, the copolyester may be melt fed to any intensive mixing operation, such as a static mixer or a single- or twin-screw extruder and compounded with the filler.

In a further method to produce filled copolyesters, a copolyester may be combined with the filler in a subsequent postpolymerization process. Typically, such a process would involve intensive mixing of the molten copolyester with the filler. Said intensive mixing may be provided through static mixers, Brabender mixers, single screw extruders, twin screw extruders and the like. In a typical process, the copolyester is dried, and then mixed with the filler. Alternatively, the copolyester and the filler may be co-fed through two different feeders. In an extrusion process, the copolyester and the filler would typically be fed into the back, feed section of the extruder. However, this should not be considered limiting. The copolyester and the filler may be advantageously fed into two different locations of the extruder. For example, the copolyester may be added in the back, feed section of the extruder while the filler is fed, (“side-stuffed”), in the front of the extruder near the die plate. The extruder temperature profile is set up to allow the copolyester to melt under the processing conditions. The screw design will also provide stress and, in turn, heat, to the resin as it mixes the molten copolyester with the filler. Processes for melt-mixing fillers are disclosed, for example, by Dohrer, et. Al., in U.S. Pat. No. 6,359,050. Alternatively, the filler may be blended with the polyester materials of the present invention during the formation of the films and coatings of the present invention, as described below.

The amount of organic, inorganic and/or clay filler to be used in a copolyester composition as disclosed herein can be determined by one skilled in the art, depending upon the intended end use of the composition. For example, filler in the amount of 0.01 to 95 weight percent, based on the total weight of the copolyester composition, may be advantageously used. Preferably, the amount of filler is from about 0.1 to about 80 weight percent.

Said additives, fillers or blend materials may be added before the polymerization process, at any stage during the polymerization process or as a post polymerization process. Essentially any filler material of the art may find use in the sulfonated aliphatic-aromatic copolyetheresters. Any additives known within the art for use in polymeric materials may find use in the compositions and processes of the present invention.

The copolyesters of the present invention may be blended with other polymeric materials. Such materials for blending with one or more copolyesters may be biodegradable or not biodegradable, and may be naturally derived, modified naturally derived or synthetic.

Examples of blendable biodegradable materials include sulfonated aliphatic-aromatic copolyesters, such as are sold under the Biomax® trademark by the DuPont Company, aliphatic-aromatic copolyesters, such as are sold under the Eastar Bio® trademark by the Eastman Chemical Company, sold under the Ecoflex® trademark by the BASF corporation, and sold under the EnPol® trademark by the Ire Chemical Company; aliphatic polyesters, such as poly (1,4-butylene succinate), (Bionolle® 1001, from Showa High Polymer Company), poly(ethylene succinate), poly(1,4-butylene adipate-co-succinate), (Bionolle® 3001, from the Showa High Polymer Company), and poly(1,4-butylene adipate) as, for example, sold by the Ire Chemical Company under the trademark of EnPol®, sold by the Showa High Polymer Company under the trademark of Bionolle®, sold by the Mitsui Toatsu Company, sold by the Nippon Shokubai Company, sold by the Cheil Synthetics Company, sold by the Eastman Chemical Company, and sold by the Sunkyon Industries Company, poly(amide esters), for example, as sold under the Bak® trademark by the Bayer Company), polycarbonates, for example such as poly(ethylene carbonate) sold by the PAC Polymers Company, poly(hydroxyalkanoates), such as poly(hydroxybutyrate)s, poly(hydroxyvalerate)s, poly(hydroxybutyrate-co-hydroxyvalerate)s, for example such as sold by the Monsanto Company under the Biopol® trademark, poly(lactide-co-glycolide-co-caprolactone), for example as sold by the Mitsui Chemicals Company under the grade designations of H100J, S100, and T100, poly(caprolactone), for example as sold under the Tone(R) trademark by the Union Carbide Company and as sold by the Daicel Chemical Company and the Solvay Company, and poly(lactide), for example as sold by the Cargill Dow Company under the trademark of EcoPLA® and the Dainippon Company and the like and mixtures thereof.

Examples of blendable nonbiodegradable polymeric materials include polyethylene, high density polyethylene, low density polyethylene, linear low density polyethylene, ultralow density polyethylene, polyolefins, poly (ethylene-co-glycidylmethacrylate), poly (ethylene-co-methyl (meth) acrylate-co-glycidyl acrylate), poly (ethylene-co-n-butyl acrylate-co-glycidyl acrylate), poly (ethylene-co-methyl acrylate), poly (ethylene-co-ethyl acrylate), poly (ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), and the like, poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propyl terephthalate), poly(1,4-butylene terephthalate), PETG, poly(ethylene-co-1,4-cyclohexanedimethanol terephthalate), poly(vinyl chloride), PVDC, poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and the like and copolymers thereof and mixtures thereof.

Examples of blendable natural polymeric materials include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose propionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, gum tragacanth, proteins, Zein®, (a prolamine derived from corn), collagen, (extracted from animal connective tissue and bones), and derivatives thereof such as gelatin and glue, casein, (the principle protein in cow milk), sunflower protein, egg protein, soybean protein, vegetable gelatins, gluten, and the like and mixtures thereof. Thermoplastic starch may be produced, for example, as disclosed within U.S. Pat. No. 5,362,777. The disclosed method includes the mixing and heating of native or modified starch with high boiling plasticizers, such as glycerin or sorbitol, in such a way that the starch has little or no crystallinity, a low glass transition temperature and a low water content. This should not be taken as limiting. Essentially any polymeric material known within the art may be blended with the sulfonated polyetheresters of the present invention.

One or more polymeric materials to be blended with a copolyester may be added to the monomers used to form the copolyester at any stage during the polymerization, or after the polymerization is completed. For example, the polymeric material may be added with the copolyester monomers at the start of the polymerization process. Alternatively, the polymeric material may be added at an intermediate stage of the polymerization, for example, as the precondensate passes into the polymerization vessel. As yet a further alternative, the polymeric material may be added after the copolyester exits the polymerizer. For example, the copolyester and the polymeric material may be melt fed to any intensive mixing operation, such as a static mixer or a single- or twin-screw extruder and compounded with the polymeric material.

As yet a further method to produce the blends of the copolyesters of the present invention and the polymeric material, the copolyester may be combined with the polymeric material in a subsequent postpolymerization process. Typically, such a process involves intensive mixing of the molten copolyester with the polymeric material. Said intensive mixing may be provided through static mixers, Brabender mixers, single screw extruders, twin screw extruders and the like. In a typical process, the copolyester is dried prior to the mixing. The polymeric material to be blended with the copolyester may also be dried. The dried copolyester may then be mixed with the polymeric material. Alternatively, the copolyester and the polymeric material may be co-fed through two different feeders. In an extrusion process, the copolyester and the polymeric material to be blended therewith are typically fed into the back, feed section of the extruder. However, this should not be considered limiting. The copolyester and the polymeric material may be advantageously fed into two different locations of the extruder. For example, the copolyester may be added in the back, feed section of the extruder while the polymeric material is fed, (“side-stuffed”), in the front of the extruder near the die plate. The extruder temperature profile is set up to allow the copolyester to melt under the processing conditions. The screw design will also provide stress and, in turn, heat, to the resin as it mixes the molten copolyester with the polymeric material. Alternatively, the polymeric material may be blended with the copolyester during the formation of a film or coating, as described below.

An aspect of the present invention relates to film comprising the sulfonated aliphatic-aromatic polyetheresters of the present invention and production processes thereof and articles derived therefrom. Polymeric films have a variety of uses, such as, for example, in packaging, especially of foodstuffs, adhesives tapes, insulators, capacitors, photographic development, and x-ray development and as laminates. For some uses, the heat resistance of the film is an important factor. Therefore, a higher melting point and glass transition temperature are desirable to provide better heat resistance and more stable electrical characteristics, along with a desirably rapid biodegradation rate. Further, it is desired that films have good barrier properties, for example; moisture barrier, oxygen barrier and carbon dioxide barrier, good grease resistance, good tensile strength and a high elongation at break.

The sulfonated aliphatic-aromatic copolyetheresters of the present invention may be formed into a film for use in any one of the many different applications, such as food packaging, labels, dielectric insulation, a water vapor barrier or the like. While not limiting, the monomer composition of the copolyetherester polymer preferably provides a partially crystalline polymer desirable for the formation of film, wherein the crystallinity provides strength and elasticity. As first produced, the polyester is generally semi-crystalline in structure. The crystallinity increases on re-heating and/or stretching of the polymer, as occurs in the production of film.

Film can be made from the copolyester by processes known to those skilled in the art. For example, thin films may be formed through dip-coating as disclosed in U.S. Pat. No. 4,372,311, through compression molding as disclosed in U.S. Pat. No. 4,427,614, through melt extrusion as disclosed in U.S. Pat. No. 4,880,592, through melt blowing as disclosed in U.S. Pat. No. 5,525,281, or other processes. The difference between a film and a sheet is the thickness, but there is no set industry standard as to the thickness required to distinguish a film from a sheet. As used herein, the term “film” refers to articles having a thickness of about 0.25 mm (10 mils) or less, preferably between about 0.025 mm and 0.15 mm (1 mil and 6 mils). However, thicker films can be formed, for example, having a thickness as great as about 0.50 mm (20 mils).

Films made from the copolyesters are preferably formed by either solution casting or extrusion. Extrusion is particularly preferred for formation of “endless” products, such as films and sheets, which emerge as a continuous length. In extrusion, the polymeric material, whether provided as a molten polymer or as plastic pellets or granules, is fluidized and homogenized to form a mixture. Additives, as described above, such as thermal or UV stabilizers, plasticizers, fillers and/or blendable polymeric materials, may be included in the mixture, if desired. The mixture is then forced through a suitably shaped die to produce the desired cross-sectional film shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. A variety of dies are used to produce different products, such as blown film (formed by a blow head for blown extrusions), sheets and strips (slot dies) and hollow and solid sections (circular dies). In this manner, films of different widths and thickness may be produced. After extrusion, the polymeric film is taken up on rollers, cooled and removed. The film can be removed using suitable devices that are preferably designed to prevent subsequent deformation of the film.

Using extruders as known in the art, film can be produced by extruding a thin layer of polymer over chilled rolls and then further drawing down the film to size by tension rolls. In the extrusion casting process, the polymer melt is conveyed from the extruder through a slot die, (T-shaped or “coat hanger” die). Said die may be as wide as 10 feet and typically have thick wall sections on the final lands to minimize deflection of the lips from internal pressure. Die openings may be within a wide range, but 0.015 inch to 0.030 inch is typical. Extrusion produces a nascent cast film. The nascent cast film may be drawn down, and thinned significantly, depending on the speed of the rolls taking up the film. The film is then solidified by cooling below the crystalline melting point or glass transition temperature. Solidification may be accomplished by passing the film through a water bath or over two or more chrome-plated chill rolls that have been cored for water cooling. The cast film is then conveyed though nip rolls, a slifter to trim the edges, and then wound up. In cast film, conditions may be tailored to allow a relatively high degree of orientation in the machine direction, especially at high draw down conditions and wind up speeds, and a much lower level of orientation in the transverse direction. Alternatively, the conditions may be tailored to minimize the level of orientation, thus providing films with essentially equivalent physical properties in both the machine direction and the transverse direction. Preferably, the finished film is less than or equal to 0.25 mm thick.

Blown film, which is generally stronger, tougher, and made more rapidly than cast film, is made by extruding a tube. In producing blown film, molten polymer is typically turned upward from the extruder and fed through an annular die. The melt flows around a mandrel and emerges through a ring-shaped opening as a tubular film. As the tubular film leaves the die, internal pressure is introduced through the die mandrel with air, which expands the tubular film to a diameter of about 1.5 to about 2.5 times the die diameter and simultaneously draws the film, causing a reduction in thickness. The film is in the form of a bubble, sealed by the die on one end and by nip (or pinch) rolls on the other, and the air cannot escape. Desirably, a consistent air pressure is maintained to ensure uniform thickness of the film bubble. The tubular film may be cooled internally and/or externally by directing air onto the film. Faster quenching in the blown film method may be accomplished by passing the expanded film about a cooled mandrel that is situated within the bubble. For example, one such method using a cooled mandrel is disclosed by Bunga, et al., in Canadian Patent 893,216. If the polymer used to prepare blown film is semicrystalline, the bubble may become cloudy as it cools below the softening point of the polymer. Drawdown of the extrudate is not essential, but preferably the drawdown ratio is between 2 and 40. The draw down ratio is defined as the ratio of the die gap to the product of the thickness of the cooled film and the blow-up ratio. Draw down may be induced by tension from pinch rolls. Blow-up ratio is the ratio of the diameter of the cooled film bubble to the diameter of the circular die. The blow up ratio may be as great as 4 or 5, but 2.5 is more typical. The draw down induces molecular orientation within the film in the machine direction, (i.e.; direction of the extrudate flow), and the blow-up ratio defines the level of molecular orientation induced in the film in the transverse direction, also referred to as hoop direction (perpendicular to machine direction). The quenched bubble moves upward through guiding devices into a set of pinch rolls that flatten it to form a sleeve. The resulting sleeve may subsequently be slit along one side, providing a film having greater width than could be conveniently made via the cast film method. The slit film may be further gusseted and/or surface-treated in line. In addition, the blown film may be produced through more elaborate techniques, such as the double bubble, tape bubble, or trapped bubble processes, which are known to those skilled in the art. The double-bubble process is a technique in which the polymeric tube is first quenched and then reheated and oriented by inflating the polymeric tube above the glass transition temperature, (Tg), but below the crystalline melting temperature, (Tm), of the polyester, (if the polyester is crystalline). The double bubble technique has been described, for example, by Pahkle in U.S. Pat. No. 3,456,044.

The conditions used to produce blown film are determined by factors such as the chemical composition of the polymer, the amount and type of additives, such as plasticizers, the thermal properties of the polymeric composition, and the like. However, the blown film process offers advantages, such as the relative ease of changing the film width and caliber simply by changing the volume of air in the bubble and the speed of the screw, the elimination of end effects, and the capability of providing biaxial orientation in the produced film. Typical film thicknesses from a blown film operation may be in the range of about 0.004 to 0.008 inch and the flat film width may range up to 24 feet or larger after slitting.

For manufacturing large quantities of film, a sheeting calender may be employed. A sheeting calender is a machine having a plurality of heatable parallel cylindrical rollers that rotate in opposite directions and spread out the polymer and stretch it to the required thickness. A rough film is fed into the gap of the calender. The last roller smooths the film thus produced. If the film is required to have a textured surface, the final roller is provided with an appropriate embossing pattern. Alternatively, the film may be reheated and then passed through an embossing calender. The calender is followed by one or more cooling drums. Finally, the finished film is reeled up.

Extruded films may also be used as the starting material for other products. For example, the film may be cut into smaller segments for use as feed material for other processing methods, such as injection molding. As a further example, the film may be laminated onto a substrate as described below. As yet a further example, the films may be metallized, using techniques known to those skilled in the art. The film tubes available from blown film operations may be converted to bags through, for example, heat-sealing processes.

Extrusion can be combined with a variety of post-extruding operations for expanded versatility. Such post-forming operations include altering round to oval shapes, blowing the film to different dimensions, machining and punching, biaxial stretching and the like, as known to those skilled in the art.

Alternatively, a film may be made by solution casting, which produces more consistently uniform gauge film than that made by melt extrusion. Solution casting comprises dissolving polymeric granules, powder or the like in a suitable solvent with any desired additives or processing aids, such as a plasticizer or colorant. The solution is filtered to remove dirt or large particles and cast from a slot die onto a moving belt, preferably of stainless steel, dried, whereon the film cools. The extrudate thickness is five to ten times that of the finished film. The film may then be finished in a like manner to the extruded film. One of ordinary skill in the art will be able to identify appropriate process parameters based on the polymeric composition and process used for film formation. The solution cast film may then be treated to the same post treatments as described for the extrusion cast film.

Multilayer films incorporating one or more layers of the copolyesters described herein and one or more additional layers may also be produced, such as bilayer, trilayer, and multilayer film structures. Additional layers can include the polyesters of the present invention or other materials that may be biodegradable or not biodegradable. Said materials may be naturally derived, modified naturally derived or synthetic. One advantage to multilayer films is that specific properties can be tailored into the film to solve critical use needs while allowing the more costly ingredients to be relegated to the outer layers where they provide the greater needs. Said multilayer film structures may be formed through coextrusion, blown film, dip-coating, solution coating, blade, puddle, air-knife, printing, Dahlgren, gravure, powder coating, spraying, or other art processes. Generally, the multilayer films are produced through extrusion casting processes. For example, the resin materials are heated in a uniform manner. The molten materials are conveyed to a coextrusion adapter that combines the molten materials to form a multilayer coextruded structure. The multilayer coextruded structure is transferred through an extrusion die opened to a predetermined gap, commonly in the range of between about 0.05 inch (0.13 cm) and 0.012 inch (0.03 cm). The material is then drawn down to the intended gauge thickness by a primary chill or casting roll maintained at typically in the range of about 15 to 55 C, (60-130 F). Typical draw down ratios range from about 5:1 to about 40:1. Individual layers in a multilayer film may serve as barrier layers, adhesive layers, antiblocking layers, or for other purposes. Further, for example, the inner layers may be filled and the outer layers may be unfilled, as disclosed within U.S. Pat. No. 4,842,741 and U.S. Pat. No. 6,309,736. Production processes are disclosed, for example, in U.S. Pat. No. 3,748,962, U.S. Pat. No. 4,522,203, U.S. Pat. No. 4,734,324, U.S. Pat. No. 5,261,899 and U.S. Pat. No. 6,309,736. For example, El-Afandi, et al., in U.S. Pat. No. 5,849,374, U.S. Pat. No. 5,849,401, and U.S. Pat. No. 6,312,823, disclose compostable multilayer films with a core poly (lactide) layer with inner and outer layers of blocking reducing layers composed of, for example, aliphatic polyesters.

Examples of biodegradable materials suitable as additional layers include the exemplary biodegradable materials disclosed herein above for use in blending.

Examples of nonbiodegradable polymeric materials suitable as additional layers include the exemplary nonbiodegradable polymeric materials disclosed herein above with regard to blending with the sulfonated aliphatic-aromatic copolyesters.

Examples of natural polymeric materials suitable as additional layers include natural polymers disclosed herein above for use in blending with the sulfonated aliphatic-aromatic copolyesters.

Regardless of how the film is formed, it may be subjected to biaxial orientation by stretching in both the machine and transverse direction after formation. The machine direction stretch is initiated in forming the film simply by rolling out and taking up the film. This inherently stretches the film in the direction of takeup, orienting some of the fibers. Although this strengthens the film in the machine direction, it allows the film to tear easily in the direction at right angles because all of the fibers are oriented in one direction. The biaxially oriented film may further be subjected to additional drawing of the film in the machine direction, in a process known as tensilizing.

Biaxial stretching orients the fibers parallel to the plane of the film, but leaves the fibers randomly oriented within the plane of the film, which provides superior tensile strength, flexibility, toughness and shrinkability, for example, in comparison to non-oriented films. It is desirable to stretch the film along two axes at right angles to each other. This increases tensile strength and elastic modulus in the directions of stretch. It is most desirable for the amount of stretch in each direction to be substantially equivalent, thereby providing similar properties and/or behavior within the film when tested from any direction. However, certain applications, such as those in which a certain amount of shrinkage or greater strength in one direction is preferred over another, as in labels or adhesive and magnetic tapes, will require uneven, or uniaxial, orientation of the fibers of the film.

The biaxial orientation may be obtained by any process known in the art. However, tentering is preferred. Tentering a material means that the material is stretched while heating in the transverse direction simultaneously with, or subsequent to, stretching in the machine direction. The orientation may be performed on commercially available equipment. For example, suitable equipment is available from Bruckner Maschenenbau of West Germany. One example of such equipment operates by clamping on the edges of the sheet to be drawn and, at the appropriate temperature, separating the edges of the sheet at a controlled rate. For example, a film may be fed into a temperature-controlled box, heated above its glass transition temperature and grasped on either side by tenterhooks which simultaneously exert a drawing tension (longitudinal stretching) and a widening tension (lateral stretching). Typically, stretch ratios of 3:1 to 4:1 may be employed. Alternatively, and preferably for commercial purposes, the biaxial drawing process is conducted continuously at high production rates in multistage roll drawing equipment, as available from Bruckner, where the drawing of the extruded film stock takes place in a series of steps between heated rolls rotating at different and increasing rates. When the appropriate combinations of draw temperatures and draw rates are employed, the monoaxial stretching will be preferably from about 4 to about 20, more preferably from about 4 to about 10. Draw ratio is defined as the ratio of a dimension of a stretched film to a non-stretched film.

Uniaxial orientation may be obtained through stretching the film in only one direction in the above-described biaxial processes or by directing the film through a machine direction orienter, (“MDO”), such as is commercially available from vendors such as the Marshall and Williams Company of Providence. Rhode Island. Said MDO apparatus has a plurality of stretching rollers that progressively stretch and thin the film in the machine direction of the film, which is the direction of travel of the film through the apparatus.

Preferably, the stretching process takes place at a temperature of at least 10° C. above the glass transition temperature of the film material and preferably below the Vicat softening temperature of the film material, especially at least 10° C. below the Vicat softening point, depending on some degree to the rate of stretching.

Orientation may be enhanced within blown film operations by adjusting the blow-up ratio, (BUR), which is defined as the ratio of the diameter of the film bubble to the die diameter. For example, it is generally preferred to have a BUR of 1 to 5 for the production of bags or wraps. However, this may be modified based on the desired balance of properties desired in the machine direction and the transverse direction. For a balanced film, a BUR of about 3:1 is generally appropriate. If it is desired to have a “splitty” film, i.e. one that easily tears in one direction, then a BUR of 1:1 to about 1.5:1 is generally preferred.

Shrinkage can be controlled by holding the film in a stretched position and heating for a few seconds before quenching. This heat stabilizes the oriented film, which then may be forced to shrink only at temperatures above the heat stabilization temperature. Further, the film may also be subjected to rolling, calendering, coating, embossing, printing, or any other typical finishing operations known within the art.

The above-described process conditions and parameters for film making by any method in the art may be accomplished by a skilled artisan for any given polymeric composition and desired application.

The properties exhibited by a film will depend on several factors, including the polymeric composition, the method of forming the polymer, the method of forming the film, and whether the film was treated for stretch or biaxially oriented. These factors affect properties of the film such as, for example, shrinkage, tensile strength, elongation at break, impact strength, dielectric strength and constant, tensile modulus, chemical resistance, melting point, heat deflection temperature, and the like.

The film properties may be further adjusted by adding certain additives and fillers to the polymeric composition, such as colorants, dyes, UV and thermal stabilizers, antioxidants, plasticizers, lubricants antiblock agents, slip agents, and the like, as recited above. Alternatively, the sulfonated aliphatic-aromatic copolyetheresters of the present invention may be blended with one or more other polymeric materials to improve certain characteristics, as described above.

As disclosed by Moss, in U.S. Pat. No. 4,698,372, Haffner, et al., in U.S. Pat. No. 6,045,900, and McCormack, in WO 95/16562, the films, especially the filled films, may be formed microporous, if desired. Further disclosures regarding the formation of microporous films can be found, for example, in U.S. Pat. No. 4,626,252, U.S. Pat. No. 5,073,316, and U.S. Pat. No. 6,359,050. As is known within the art, the stretching of a filled film may create fine pores. This allows the film to serve as a barrier to liquids and particulate matter, yet allow air and water vapor to pass through.

To enhance the printability, ink receptivity of the surface, adhesion or other desirable characteristics, the films of the present invention may be treated by known, conventional post forming operations, such as corona discharge, chemical treatments, flame treatment, and the like.

The films made from the sulfonated aliphatic-aromatic copolyesters are useful in a wide variety of areas. For example, the films are useful as a component of personal sanitary items, such as disposable diapers, incontinence briefs, feminine pads, sanitary napkins, tampons, tampon applicators, motion sickness bags, baby pants, personal absorbent products, and the like. The films combine water barrier properties to avoid leak through with toughness to conform to the body and to stretch with the body movements during use. After their use, the soiled articles will biocompost when discarded appropriately.

As further examples, films made from the sulfonated aliphatic-aromatic copolyesters are useful as protective films for agriculture, such as mulch films, seed coverings, agriculture mats containing seeds, (“seed tapes”), garbage and lawn waste bags, and the like. Additional examples of the use of films made from the sulfonated aliphatic-aromatic polyesters include: adhesive tape substrates, bags, bag closures bed sheets, bottles, cartons, dust bags, fabric softener sheets, garment bags, industrial bags, trash bags, waste bin liners, compost bags, labels, tags, pillow cases, bed liners, bedpan liners, bandages, boxes, handkerchiefs, pouches, wipes, protective clothing, surgical gowns, surgical sheets, surgical sponges, temporary enclosures, temporary siding, toys, wipes, table clothes and the like.

A particularly preferred use of the films comprising the sulfonated aliphatic-aromatic copolyesters is food packaging, especially fast food packaging. Specific examples of food packaging uses include food wrappers, stretch wrap films, hermetic seals, food bags, snack bags, grocery bags, cups, trays, cartons, boxes, bottles, crates, food packaging films, blister pack wrappers, skin packaging, and the like.

Specifically preferred end uses for the films of the present invention include wraps. Wraps may be used to enclose meats, other perishable items, and especially fast food items, such as sandwiches, burgers, dessert items, and the like. Desirably, the films of the present invention used as wraps will combine a balance of physical properties, including paper-like stiffness combined with sufficient toughness so as not to tear when used to wrap, for example, a sandwich, deadfold characteristics that once folded, wrapped or otherwise manipulated into the desired shape, the wraps will maintain their shape and not tend to spontaneously unfold or unwrap; grease resistance where desired, and a balance of moisture barrier properties that provides a moisture barrier while not allowing for moisture to condense onto food packaged within the film. The films used to make wraps may have a smooth surface or a textured surface, and texture may be imparted to the film by process such as embossing, crimping, quilting, and the like. The wraps may be filled, with, for example, inorganic particles, organic particles, such as starch, combinations of fillers and the like.

The films may be further processed to produce additional desirable articles, such as containers. For example, the films may be thermoformed as disclosed, for example, in U.S. Pat. No. 3,303,628, U.S. Pat. No. 3,674,626, and U.S. Pat. No. 5,011,735. The films of the present invention may also serve to package foods, such as meats, through vacuum skin packaging techniques, as disclosed within, for example, U.S. Pat. No. 3,835,618, U.S. Pat. No. 3,950,919, U.S. Pat. No. Re 30,009, and U.S. Pat. No. 5,011,735. The films may further be laminated onto substrates, as described below.

A further aspect of the present invention relates to coatings of the sulfonated aliphatic-aromatic copolyesters of the present invention onto substrates and the production processes thereof and articles derived therefrom. Coatings may be produced by coating a substrate with polymer solutions, dispersions, latexes, and emulsions of the copolyesters of the present invention through rolling, spreading, spraying, brushing, or pouring processes, followed by drying, by coextruding the copolyesters of the present invention with other materials, powder coating onto a preformed substrate, or by melt/extrusion coating a preformed substrate with the copolyesters of the present invention. The substrate may be coated on one side with the polymeric composition of the present invention or on both sides. Said polymeric coated substrates have a variety of uses, such as in packaging, especially of foodstuffs, and as disposable cups, plates, bowls and cutlery. For many of these uses, the heat resistance of the coating is an important factor. Therefore, a higher melting point and glass transition temperature are desirable to provide better heat resistance, along with a rapid biodegradation rate. Further, it is desired that these coatings provide barrier properties for moisture, grease, oxygen, and carbon dioxide, and have good tensile strength and a high elongation at break.

Coatings may be made from the sulfonated aliphatic-aromatic copolyesters by any process known in the art. For example, thin coatings may be formed through dipcoating as disclosed within U.S. Pat. No. 4,372,311 and U.S. Pat. No. 4,503,098, extrusion onto substrates, as disclosed, for example, in U.S. Pat. No. 5,294,483, U.S. Pat. No. 5,475,080, U.S. Pat. No. 5,611,859, U.S. Pat. No. 5,795,320, U.S. Pat. No. 6,183,814, and U.S. Pat. No. 6,197,380, blade, puddle, air-knife, printing, Dahigren, gravure, powder coating, spraying, or other art processes. The coatings may be of any thickness. Preferably, the polymeric coating will be less than or equal to 0.25 mm (10 mils) thick, more preferably between about 0.025 mm and 0.15 mm (1 mil and 6 mils). However, thicker coatings can be formed up to a thickness of about 0.50 mm (20 mils) or greater.

Various substrates may be coated directly with a film. Coatings from the sulfonated aliphatic-aromatic polyesters are preferably formed by solution, dispersion, latex, or emulsion casting, powder coating, or extrusion onto a preformed substrate.

A coating may also be made by solution casting onto a substrate, which produces more consistently uniform gauge coating than that made by melt extrusion. Solution casting comprises dissolving polymeric granules, powder or the like in a suitable solvent with any desired formulant, such as a plasticizer, filler, blendable polymeric material, or colorant. The solution is filtered to remove dirt or large particles and cast from a slot die onto a moving preformed substrate, forming an extrudate then dried, whereupon the extrudate cools. The extrudate thickness is five to ten times that of the finished coating. The coating may then be finished in a like manner to an extruded coating. Similarly, polymeric dispersions and emulsions may be coated onto substrates through equivalent processes. Coatings may be applied to textiles, nonwovens, foil, paper, paperboard, and other sheet materials by continuously operating spread-coating machines. A coating knife, such as a “doctor knife”, ensures uniform spreading of the coating materials (in the form of solution, emulsions, or dispersions in water or an organic medium) onto the substrate, which is moved along by rollers. The coating is then dried. Alternatively, the polymeric solution, emulsion, or dispersion may be sprayed, brushed, rolled or poured onto the substrate.

For example, Potts, in U.S. Pat. No. 4,372,311 and U.S. Pat. No. 4,503,098, discloses coating water-soluble substrates with solutions of water-insoluble materials. U.S. Pat. No. 3,378,424 discloses processes for coating a fibrous substrate with an aqueous polymeric emulsion.

Coatings comprising the sulfonated aliphatic-aromatic copolyesters may also be applied to substrates through powder coating processes. In a powder coating process, the copolyester is coated onto a substrate in the form of a powder with a fine particle size. The substrate to be coated may be heated to above the fusion temperature of the copolyester and the substrate is dipped into a bed of the powdered copolyester that is fluidized by the passage of air through a porous plate. The fluidized bed is typically not heated. A layer of the copolyester adheres to the hot substrate surface and melts to provide the coating. Coating thick nesses may be in the range of about 0.005 inch to 0.080 inch, (0.13 to 2.00 mm). Other powder coating processes include spray coating, whereby the substrate is not heated until after it is coated, and electrostatic coating. For example, paperboard containers may be electrostatically spray-coated with a thermoplastic polymer powder, as disclosed within U.S. Pat. No. 4,117,971, U.S. Pat. No. 4,168,676, U.S. Pat. No. 4,180,844, U.S. Pat. No. 4,211,339, and U.S. Pat. No. 4,283,189. The paperboard containers are then heated, causing the polymeric powder to melt to form a laminated polymeric coating. Coatings of the sulfonated aliphatic-aromatic polyesters may also be applied by spraying the molten, atomized copolyesters onto substrates, such as paperboard. Such processes are disclosed for wax coatings in, for example, U.S. Pat. No. 5,078,313, U.S. Pat. No. 5,281,446, and U.S. Pat. No. 5,456,754.

Metal articles of complex shapes can also be coated with films of the sulfonated aliphatic-aromatic polyesters by a whirl sintering process. The articles, heated to above the melting point of the polyester, are introduced into a fluidized bed of powdered polyester particles held in suspension by a rising stream of air, thus depositing a coating on the metal by sintering.

The coatings are preferably formed through melt or extrusion coating processes. Extrusion is particularly preferred for formation of “endless” products, such as coated paper and paperboard, which emerge as a continuous length. In extrusion, the polymeric material, whether provided as a molten polymer or as plastic pellets or granules, is fluidized and homogenized. Additives, such as thermal or UV stabilizers, plasticizers, fillers and/or blendable polymeric materials, may be added to the polymer during extrusion to form a mixture. The mixture is then forced through a suitably shaped die to produce the desired cross-sectional film shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used. Different kinds of die are used to produce different products. Typically slot dies, such as T-shaped or “coat hanger” dies, are used for extrusion coatings. In this manner, films of different widths and thickness may be produced and may be extruded directly onto the object to be coated. The extruded polymer in the form of a thin molten nascent film exits the die and is pulled down onto the substrate and into a nip between a chill roll and a pressure roll situated directly below the die. Typically the nip rolls are a pair of cooperating, axially parallel rolls, one being a pressure roll having a rubber surface and the other being a chill roll. Typically the uncoated side of the substrate to be coated contacts the pressure roll while the polymer-coated side of the substrate contacts the chill roll. The pressure between these two rolls forces the film onto the substrate. At the same time, the substrate is moving at a speed faster than the extruded film and is drawing the film down to the required thickness. In extrusion coating, the substrate (paper, foil, fabric, polymeric film, and the like) is compressed together with the extruded polymeric melt by pressure rolls so that the polymer impregnates the substrate for maximum adhesion. The molten film is then cooled by the water-cooled, chromium-plated chill rolls. Once coated, the substrate may be then pass through a slitter to trim the edges and may be taken off by suitable devices designed to prevent subsequent deformation of the coated substrate.

Extrusion coating of polyesters onto paperboard is disclosed, for example, within U.S. Pat. No. 3,924,013, U.S. Pat. No. 4,147,836, U.S. Pat. No. 4,391,833, U.S. Pat. No. 4,595,611, U.S. Pat. No. 4,957,578, and U.S. Pat. No. 5,942,295. For example, Kane, in U.S. Pat. No. 3,924,013, disclose the formation of ovenable trays mechanically formed from paperboard previously laminated with polyester. For example, Chaffey, et al., in U.S. Pat. No. 4,836,400, disclose the production of cups formed from paper stock that has been coated with a polymer on both sides, and Beavers, et al., in U.S. Pat. No. 5,294,483, disclose the extrusion coating of certain polyesters onto paper substrates.

As a further example of extrusion coating, wires and cable may be sheathed directly with polymeric films extruded from oblique heads.

Calendering processes may also be used to put polymeric laminates onto substrates. Calenders may consist of two, three, four, or five hollow rolls arranged for steam heating or water-cooling. Typically, the polymer to be calendered is softened, for example in ribbon blenders, such as a Banbury mixer. Other components may be mixed in, such as plasticizers. The softened polymeric composition is then fed to the roller arrangement and is squeezed into the form of films. If desired, thicker sections may be formed by applying one layer of polymer onto a previous layer, (double plying). The substrate, such as a textile or nonwoven fabric or paper, is fed through the last two rolls of the calender so that the film is pressed into the substrate. The thickness of the laminate is determined by the gap between the last two rolls of the calender. The surface may be made glossy, matte, or embossed. The laminate is then cooled and may be wound up on rolls.

Multilayer films can be used to form coatings or laminates on substrates, such as bilayer, trilayer, and multilayer film structures disclosed herein above. The multiple layers can include a layer of the copolyester and one or more additional layers of the same and/or different polymer(s). One advantage to multilayer films is that specific properties can be tailored into the film to solve critical use needs while allowing the more costly ingredients to be relegated to the outer layers where they provide the greater needs. Said multilayer composite structures may be formed through coextrusion, dipcoating, solution coating, blade, puddle, air-knife, printing, Dahlgren, gravure, powder coating, spraying, or other art processes. Generally, the multilayer films are produced through extrusion casting processes. For example, the polymer and any optional additives are heated in a uniform manner to form a molten material. The molten materials are conveyed to a coextrusion adapter that combines the molten materials to form a multilayer coextruded structure. The layered polymeric material is transferred through an extrusion die opened to a predetermined gap, commonly in the range of between about 0.05 inch (0.13 cm) and 0.012 inch (0.03 cm) and is pulled down onto a substrate and into a nip between a chill roll and a pressure roll situated directly below the die. The material is drawn down to the intended gauge thickness based on the speed of the substrate. The primary chill or casting roll is maintained typically at a temperature in the range of about 15 to 55 C, (60-130 F). Typical draw down ratios range from about 5:1 to about 40:1. The additional layers may serve as barrier layers, adhesive layers, antiblocking layers, or for other purposes. Further, for example, the inner layers may be filled and the outer layers may be unfilled, as disclosed within U.S. Pat. No. 4,842,741 and U.S. Pat. No. 6,309,736. Production processes are well known within the art, for example, as disclosed within U.S. Pat. No. 3,748,962, U.S. Pat. No. 4,522,203, U.S. Pat. No. 4,734,324, U.S. Pat. No. 5,261,899 and U.S. Pat. No. 6,309,736. For example, El-Afandi, et al., in U.S. Pat. No. 5,849,374, U.S. Pat. No. 5,849,401, and U.S. Pat. No. 6,312,823, disclose compostable multilayer films with a core poly (lactide) layer with inner and outer layers of blocking reducing layers composed of, for example, aliphatic polyesters. For example, Kuusipalo, et al., in WO Application 00/01530, disclose paper and paperboard coated with poly (lactide) and biodegradable adhesive layers, such as aliphatic-aromatic polyesters.

Said additional layers may contain the sulfonated aliphatic-aromatic polyetheresters, or other polymeric materials that may be biodegradable or nonbiodegradable. Said materials may be naturally derived, modified naturally derived or synthetic.

Examples of biodegradable materials suitable as additional layers are disclosed herein above for use in blending.

Examples of nonbiodegradable polymeric materials suitable as additional layers the exemplary nonbiodegradable polymeric materials disclosed herein above for use in blending or for forming additional layers.

Examples of natural polymeric materials suitable as additional layers are disclosed herein above for use in blending.

Generally, the coating is applied to a thickness of between about 0.2 to 15 mils, more generally in the range of between 0.5 to 2 mils. The substrates may vary widely in thickness, but the range of between 0.5 to more than 24 mils thickness is common.

Suitable for use with coatings may include articles composed of paper, paperboard, cardboard, fiberboard, cellulose, such as Cellophane®, starch, plastic polystyrene foam, glass, metal, for example; aluminum or tin cans, metal foils, polymeric foams, organic foams, inorganic foams, organic-inorganic foams, polymeric films, and the like. Preferred are biodegradable substrates, such as paper, paperboard, cardboard, cellulose, starch and the like and biobenign substrates such as inorganic and inorganic-organic foams.

Polymeric films that are suitable as substrates within the present invention may be comprised of the polyesters of the present invention or of materials that may be biodegradable or not biodegradable. Said materials may be naturally derived, modified naturally derived or synthetic.

Examples of biodegradable materials suitable as substrates include the exemplary biodegradable materials disclosed herein above for use in forming additional layers in multilayer compositions.

Examples of nonbiodegradable polymeric materials suitable as substrates include the exemplary nonbiodegradable polymeric materials disclosed herein above for use in blending or for forming additional layers.

Examples of natural polymeric materials suitable as substrates include the exemplary natural polymeric materials disclosed herein above for use in blending or forming additional layers.

Organic foams, such as derived from expanded starches and grains, may be used in the present invention. Such materials are disclosed, for example, in U.S. Pat. No. 3,137,592, U.S. Pat. No. 4,673,438, U.S. Pat. No. 4,863,655, U.S. Pat. No. 5,035,930, U.S. Pat. No. 5,043,196, U.S. Pat. No. 5,095,054, U.S. Pat. No. 5,300,333, U.S. Pat. No. 5,413,855, U.S. Pat. No. 5,512,090, and U.S. Pat. No. 6,106,753. Specific examples of said materials include: EcoFoam®, a product of the National Starch Company of Bridgewater, N.J., which is a hydroxypropylated starch product, and EnviroFil®, a product of the EnPac Company, a DuPont-Con Agra Company.

Specific preferred organic-inorganic foams are cellular foams highly inorganically filled with, for example, calcium carbonate, clays, cement, or limestone; and having a starch-based binder, such as, for example, potato starch, cornstarch, waxy cornstarch, rice starch, wheat starch, or tapioca, and a small amount of fiber, as disclosed, for example, by Andersen, et al., in U.S. Pat. No. 6,030,673. A foam is produced by mixing the ingredients together, such as, for example, limestone, potato starch, fiber and water, to from a batter, then pressing the batter between two heated molds. During heating, the water contained within the batter is turned to steam, raising the pressure within the mold. This forms the foamed product. Products produced through such process that are suitable for substrates are commercially available from the EarthShell Packaging Company. Exemplary foamed products include 9-inch plates, 12-ounce bowls and hinged-lid sandwich and salad containers, (“clam shells”).

Further disclosures of organic, inorganic and organic-inorganic foam substrates include, for example; U.S. Pat. No. 5,095,054, U.S. Pat. No. 5,108,677, U.S. Pat. No. 5,234,977, U.S. Pat. No. 5,258,430, U.S. Pat. No. 5,262,458, U.S. Pat. No. 5,292,782, U.S. Pat. No. 5,376,320, U.S. Pat. No. 5,382,611, U.S. Pat. No. 5,405,564, U.S. Pat. No. 5,412,005, U.S. Pat. No. 5,462,980, U.S. Pat. No. 5,462,982, U.S. Pat. No. 5,512,378, U.S. Pat. No. 5,514,430, U.S. Pat. No. 5,549,859, U.S. Pat. No. 5,569,514, U.S. Pat. No. 5,569,692, U.S. Pat. No. 5,576,049, U.S. Pat. No. 5,580,409, U.S. Pat. No. 5,580,624, U.S. Pat. No. 5,582,670, U.S. Pat. No. 5,614,307, U.S. Pat. No. 5,618,341, U.S. Pat. No. 5,626,954, U.S. Pat. No. 5,631,053, U.S. Pat. No. 5,658,603, U.S. Pat. No. 5,658,624, U.S. Pat. No. 5,660,900, U.S. Pat. No. 5,660,903, U.S. Pat. No. 5,660,904, U.S. Pat. No. 5,665,442, U.S. Pat. No. 5,679,145, U.S. Pat. No. 5,683,772, U.S. Pat. No. 5,705,238, U.S. Pat. No. 5,705,239, U.S. Pat. No. 5,709,827, U.S. Pat. No. 5,709,913, U.S. Pat. No. 5,753,308, U.S. Pat. No. 5,766,525, U.S. Pat. No. 5,770,137, U.S. Pat. No. 5,776,388, U.S. Pat. No. 5,783,126, U.S. Pat. No. 5,800,647, U.S. Pat. No. 5,810,961, U.S. Pat. No. 5,830,305, U.S. Pat. No. 5,830,548, U.S. Pat. No. 5,843,544, U.S. Pat. No. 5,849,155, U.S. Pat. No. 5,868,824, U.S. Pat. No. 5,879,722, U.S. Pat. No. 5,897,944, U.S. Pat. No. 5,910,350, U.S. Pat. No. 5,928,741, U.S. Pat. No. 5,976,235, U.S. Pat. No. 6,083,586, U.S. Pat. No. 6,090,195, U.S. Pat. No. 6,146,573, U.S. Pat. No. 6,168,857, U.S. Pat. No. 6,180,037, U.S. Pat. No. 6,200,404, U.S. Pat. No. 6,214,907, U.S. Pat. No. 6,231,970, U.S. Pat. No. 6,242,102, U.S. Pat. No. 6,347,934, U.S. Pat. No. 6,348,524, and U.S. Pat. No. 6,379,446.

To enhance the coating process, the substrates may be treated by known, conventional post forming operations, such as corona discharge, chemical treatments, such as primers, flame treatments, adhesives, and the like. The substrate layer may be primed with, for example, an aqueous solution of polyethyleneimine, (Adcote® 313), or a styrene-acrylic latex, or may be flame treated, as disclosed within U.S. Pat. No. 4,957,578 and U.S. Pat. No. 5,868,309.

The substrate may be coated with an adhesive, either through conventional coating technologies or through extrusion. Specific examples of suitable adhesives include: glue, gelatin, caesin, starch, cellulose esters, aliphatic polyesters, poly (alkanoates), aliphatic-aromatic polyesters, sulfonated aliphatic-aromatic polyesters, polyamide esters, rosin/polycaprolactone triblock copolymers, rosin/poly (ethylene adipate) triblock copolymers, rosin/poly (ethylene succinate) triblock copolymers, poly (vinyl acetates), poly (ethylene-co-vinyl acetate), poly (ethylene-co-ethyl acrylate), poly (ethylene-co-methyl acrylate), poly(ethylene-co-propylene), poly(ethylene-co-1-butene), poly(ethylene-co-1-pentene), poly(styrene), acrylics, Rhoplex® N-1031, (an acrylic latex from the Rohm & Haas Company), polyurethanes, AS 390, (an aqueous polyurethane adhesive base for Adhesion Systems, Inc.) with AS 316, (an adhesion catalyst from Adhesion Systems, Inc.), Airflex® 421, (a water-based vinyl acetate adhesive formulated with a crosslinking agent), sulfonated polyester urethane dispersions, (such as sold as Dispercoll® U-54, Dispercoll® U-53, and Dispercoll® KA-8756 by the Bayer Corporation), nonsulfonated urethane dispersions, (such as Aquathane® 97949 and Aquathane® 97959 by the Reichold Company; Flexthane® 620 and Flexthane® 630 by the Air Products Company; Luphen® D DS 3418 and Luphen® D 200A by the BASF Corporation; Neorez® 9617 and Neorez® 9437 by the Zeneca Resins Company; Quilastic® DEP 170 and Quilastic® 172 by the Merquinsa Company; Sancure® 1601 and Sancure® 815 by the B. F. Goodrich Company), urethane-styrene polymer dispersions, (such as Flexthane® 790 and Flexthane® 791 of the Air Products & Chemicals Company), Non-ionic polyester urethane dispersions, (such as Neorez® 9249 of the Zeneca Resins Company), acrylic dispersions, (such as Jagotex® KEA-5050 and Jagotex® KEA 5040 by the Jager Company; Hycar® 26084, Hycar® 26091, Hycar® 26315, Hycar® 26447, Hycar® 26450, and Hycar® 26373 by the B. F. Goodrich Company; Rhoplex® AC-264, Rhoplex® HA-16, Rhoplex® B-60A, Rhoplex® AC-234, Rhoplex® E-358, and Rhoplex® N-619 by the Rohm & Haas Company), silanated anionic acrylate-styrene polymer dispersions, (such as Acronal®, S-710 by the BASF Corporation and Texigel® 13-057 by Scott Bader. Inc.), anionic acrylate-styrene dispersions, (such as Acronal (®296D, Acronal® NX 4786, Acronal® S-305D, Acronal® S-400, Acronal® S-610, Acronal® S-702, Acronal® S-714, Acronal® S-728, and Acronal® S-760 by the BASF Corporation; Carboset ® CR-760 by the B. F. Goodrich Company; Rhoplex® P-376, Rhoplex® P-308, and Rhoplex® NW-1715K by the Rohm & Haas Company; Synthemul® 40402 and Synthemul® 40403 by the Reichold Chemicals Company; Texigel® 13-57 Texigel® 13-034, and Texigel® 13-031 by Scott Bader Inc.; and Vancryl® 954, Vancryl® 937 and Vancryl® 989 by the Air Products & Chemicals Company), anionic acrylate-styrene-acrylonitrile dispersions, (such as Acronal® S 886S, Acronal® S 504, and Acronal® DS 2285 X by the BASF Corporation), acrylate-acrylonitrile dispersions, (such as Acronal® 35D, Acronal® 81 D, Acronal® B 37D, Acronal® DS 3390, and Acronal® V275 by the BASF Corporation), vinyl chloride-ethylene emulsions, (such as Vancryl® 600, Vancryl® 605, Vancryl® 610, and Vancryl® 635 by Air Products and Chemicals Inc.), vinylpyrrolidone/styrene copolymer emulsions, (such as Polectron® 430 by ISP Chemicals), carboxylated and noncarboxylated vinyl acetate ethylene dispersions, (such as Airflex® 420, Airflex® 421, Airflex® 426, Airflex® 7200, and Airflex® A-7216 by Air Products and Chemicals Inc. and Dur-o-set® E150 and Dur-o-set® E-230 by ICI), vinyl acetate homopolymer dispersions, (such as Resyn® 68-5799 and Resyn® 25-2828 by ICI), polyvinyl chloride emulsions, (such as Vycar® 460×24, Vycar® 460×6 and Vycar® 460×58 by the B. F. Goodrich Company), polyvinylidene fluoride dispersions, (such as Kynar® 32 by Elf Atochem), ethylene acrylic acid dispersions, (such as Adcote® 50T4990 and Adcote® 50T4983 by Morton International), polyamide dispersions, (such as Micromid® 121RC, Micromid® 141L, Micromid® 142LTL, Micromid® 143LTL, Micromid® 144LTL, Micromid® 321 RC, and Micromid® 632HPL by the Union Camp Corporation), anionic carboxylated or noncarboxylated acrylonitrile-butadiene-styrene emulsions and acrylonitrile emulsions, (such as Hycar® 1552, Hycar® 1562×107, Hycar® 1562×117 and Hycar® 1572×64 by B. F. Goodrich), resin dispersions derived from styrene, (such as Tacolyn® 5001 and Piccotex® LC-55WK by Hercules), resin dispersions derived from aliphatic and/or aromatic hydrocarbons, (such as Escorez® 9191, Escorez® 9241, and Escorez® 9271 by Exxon), styrene-maleic anhydrides, (such as SMA® 1440 H and SMA® 1000 by AtoChem), and the like and mixtures thereof.

In some preferred embodiments, the substrate may be coated with a biodegradable adhesion binder layer such as, for example: glue, gelatin, casein, or starch.

The adhesives may be applied through melt processes or through solution, emulsion, dispersion, or other known coating processes. For example, U.S. Pat. No. 4,343,858 discloses a coated paperboard formed by the coextrusion of a polyester top film and an intermediate layer of an ester of acrylic acid, methacrylic acid, or ethacrylic acid, on a paperboard substrate. U.S. Pat. No. 4,455,184, discloses a process to coextrude a polyester layer and a polymeric adhesive layer onto a paperboard substrate. Fujita, et al., in U.S. Pat. No. 4,543,280, disclose the use of adhesives in the extrusion coating of polyester onto ovenable paperboard. Huffman, et al., in U.S. Pat. No. 4,957,578, disclose the extrusion of a polyester layer on top of a polyethylene-coated paperboard. The polyethylene layer may be corona discharged or flame treated to promote adhesion. They further disclose the direct formation of a coated structure by coextrusion of a polyethylene layer onto paperboard with the polyester on top of the polyethylene and a coextruded tie layer of Bynel® adhesive between the polyethylene layer and the polyester layer.

One of ordinary skill in the art will be able to identify appropriate process parameters based on the polymeric composition and process used for the coating formation. Process conditions and parameters for making coatings by any method in the art are easily determined by a skilled artisan for any given polymeric composition and desired application.

The properties exhibited by a coating depend on several factors, such as, for example, the polymeric composition, the method of forming the polymer, the method of forming the coating, and whether the coating was oriented during manufacture. These factors affect properties of the coating such as shrinkage, tensile strength, elongation at break, impact strength, dielectric strength and constant, tensile modulus, chemical resistance, melting point, heat deflection temperature, and the like.

The coating properties may be further adjusted by adding additives and/or fillers, such as colorants, dyes, UV and thermal stabilizers, antioxidants, plasticizers, lubricants antiblock agents, slip agents, and the like, as recited above. Alternatively, the sulfonated aliphatic-aromatic copolyetheresters of the present invention may be blended with one or more other polymeric materials to improve certain characteristics, as described above.

The substrates may be formed into certain articles prior to coating or may be formed into certain articles after they are coated. For example, containers may be produced from flat, coated paperboard by pressforming them, by being vacuum formed, or by folding and adhering them into the final desired shape. Coated, flat paperboard stock may be formed into trays through the application of heat and pressure, as disclosed within, for example, U.S. Pat. No. 4,900,594. They may be vacuum formed into containers for foods and beverages, as disclosed within U.S. Pat. No. 5,294,483. Articles into which substrates can be formed prior to or after coating include, for example, cutlery, flower pots, mailing tubes, light fixtures, ash trays, gameboards, food containers, fast food containers, cartons, boxes, milk cartons, fruit juice containers, carriers for beverage containers, ice cream cartons, cups, disposable drinking cups, two-piece cups, one-piece pleated cups, cone cups, coffee cups, lidding, lids, straws, cup tops, french fry containers, fast food carry out boxes, packaging, support boxes, confectionery boxes, boxes for cosmetics, plates, bowls, vending plates, pie plates, trays, baking trays, breakfast plates, microwaveable dinner trays, “TV” dinner trays, egg cartons, meat packaging platters, disposable single use liners that can be utilized with containers such as cups or food containers, substantially spherical objects, bottles, jars, crates, dishes, medicine vials, interior packaging, such as partitions, liners, anchor pads, corner braces, corner protectors, clearance pads, hinged sheets, trays, funnels, cushioning materials, and other objects used in packaging, storing, shipping, portioning, serving, or dispensing an object within a container.

Water-resistant polymer coated paper and paperboard are used in packaging material for foodstuffs and as disposable containers. Coating polymers, and multilamellar coating structures including the same, have been developed that provide desired oxygen, water vapor, and aroma tightness for preservation of products by packaging.

The coatings containing sulfonated aliphatic-aromatic polyesters are useful in a wide variety of areas, including, for example, personal sanitary items, such as disposable diapers, incontinence briefs, feminine pads, sanitary napkins, tampons, tampon applicators, motion sickness bags, baby pants, personal absorbent products, and the like. The coatings of the present invention combine excellent water barrier properties to avoid leak through with excellent toughness to easily conform to the body and to stretch with the body movements during use. After their use, the soiled articles will biocompost rapidly when discarded appropriately.

As further examples, the coatings are useful as protective films for use in agriculture, such as mulch films, seed coverings, agriculture mats containing seeds, (“seed tapes”), garbage and lawn waste bags, and the like. Further uses include coatings for adhesive tape substrates, bags, bag closures, bed sheets, bottles, cartons, dust bags, fabric softener sheets, garment bags, industrial bags, trash bags, waste bin liners, compost bags, labels, tags, pillow cases, bed liners, bedpan liners, bandages, boxes, handkerchiefs, pouches, wipes, protective clothing, surgical gowns, surgical sheets, surgical sponges, temporary enclosures, temporary siding, toys, wipes, table clothes and the like.

A particularly preferred use of coatings comprising the sulfonated aliphatic-aromatic polyesters is food packaging, especially for fast food packaging. Specific examples of food packaging uses include fast food wrappers, stretch wrap films, hermetic seals, food bags, snack bags, grocery bags, cups, trays, cartons, boxes, bottles, crates, food packaging films, blister pack wrappers, skin packaging, hinged lid sandwich and salad containers, (“clam shells”), and the like.

A specifically preferred end use for the coatings comprising the sulfonated aliphatic-aromatic polyesters includes wraps. Wraps can be made from polymeric coated paper. Wraps may be used to enclose meats, other perishable items, and especially fast food items, such as sandwiches, burgers, dessert items, and the like. Preferably, the coatings of the present invention used as wraps will combine a desired balance of physical properties, including paper-like stiffness combined with sufficient toughness so as not to tear when used to wrap food; sufficient deadfold characteristics that once folded, wrapped or otherwise manipulated into the desired shape, the wraps will maintain their shape and not tend to spontaneously unfold or unwrap; grease resistance, where desired, and a balance of moisture barrier properties that avoids condensation of moisture on the packaged food. The wraps may have smooth surface or a textured surface, and texture may be provided, for example, by embossing, crimping, quilting, and the like. The wraps may be filled, with, for example, inorganic particles, organic particles, such as starch, combinations of fillers and the like.

Also within the scope of the present invention are laminates of sulfonated aliphatic-aromatic polyesters onto substrates, production processes therefor and articles derived therefrom. Films comprising the sulfonated aliphatic-aromatic polyesters, prepared as described above, may be laminated onto a wide variety of substrates by known processes, such as, for example: thermoforming, vacuum thermoforming, vacuum lamination, pressure lamination, mechanical lamination, skin packaging, and adhesion lamination. A laminate is differentiated from a coating in that in lamination, a preformed film is attached to a substrate. The substrate may be shaped into the final use shape, such as in the form of a plate, cup, bowl, tray prior to the application of a film to form a laminated substrate, or may be in an intermediate shape still to be formed, such as a sheet or film. The film may be attached to the substrate through the application of heat and/or pressure, as with, for example heated bonding rolls. Generally speaking, the laminate bond strength or peel strength may be enhanced through the use of higher temperatures and/or pressures. When adhesives are used, the adhesives may be hot melt adhesives or solvent-based adhesives. To enhance the lamination process, the films of the present invention and/or the substrates may be treated by known, conventional post forming operations, such as corona discharge, chemical treatments, such as primers, flame treatments, as previously described. For example, U.S. Pat. No. 4,147,836 describes subjecting a paperboard to a corona discharge to enhance the lamination process with a poly (ethylene terephthalate) film. Quick, et al., in U.S. Pat. No. 4,900,594, disclose the corona treatment of a polyester film to aide in the lamination to paperstock with adhesives. For example, Schirmer, in U.S. Pat. No. 5,011,735, discloses the use of corona treatments to aid the adhesion between various blown films. U.S. Pat. No. 6,071,577, and U.S. Pat. No. 5,679,201 disclose the use of flame treatments to aid in the adhesion within polymeric lamination processes. Sandstrom, et al., in U.S. Pat. No. 5,868,309, disclose the use of paperboard substrate primer consisting of certain styrene-acrylic materials to improve the adhesion with polymeric laminates.

Processes for producing polymeric coated or laminated paper and paperboard substrates for use as containers and cartons are disclosed, for example, in U.S. Pat. No. 3,863,832, U.S. Pat. No. 3,866,816, U.S. Pat. No. 4,337,116, U.S. Pat. No. 4,456,164, U.S. Pat. No. 4,698,246, U.S. Pat. No. 4,701,360, U.S. Pat. No. 4,789,575, U.S. Pat. No. 4,806,399, U.S. Pat. No. 4,888,222, and U.S. Pat. No. 5,002,833. For example, Kane, in U.S. Pat. No. 3,924,013, disclose the formation of ovenable trays mechanically formed from paperboard previously laminated polyester. For example, Schmidt, in U.S. Pat. No. 4,130,234, discloses the lamination of paper cups with polymeric film. For example, the lamination of films onto nonwoven fabrics is disclosed within U.S. Pat. No. 6,045,900 and U.S. Pat. No. 6,309,736. Depending on the intended use of the polyester laminated substrate, the substrate may be laminated on one side or on both sides.

A film may be passed through heating and pressure/nip rolls to be laminated onto flat substrates. In some processes, the films can be laminated onto substrates utilizing processes derived from thermoforming. As such, the films may be laminated onto substrates through vacuum lamination, pressure lamination, blow lamination, mechanical lamination, and the like. When the films are heated, they soften and may be stretched onto a substrate of any given shape. Processes to adhere a polymeric film to a preformed substrate are disclosed, for example, within U.S. Pat. No. 2,590,221.

In vacuum lamination, a film may be clamped or otherwise held against a substrate and then heated until it becomes soft. A vacuum is then applied, causing the softened film to mold into the contours of the substrate and laminate onto the substrates. The formed laminate is then cooled. The vacuum may be maintained or not during the cooling process. Vacuum lamination is typically used for lamination of porous substrates.

For substrate shapes that require a deep draw, such as cups, deep bowls, boxes, cartons, and the like, a plug assist may be utilized. In such substrate shapes, the softened film tends to thin out significantly before it reaches the base or bottom of the substrate shape, leaving only a thin and weak laminate on the bottom of the substrate shape. A plug assist is a mechanical helper that carries more film stock toward an area of the substrate shape where the lamination would otherwise be too thin. Plug assist techniques may be adapted to vacuum and pressure lamination processes.

Vacuum lamination processes for laminating films onto preformed substrates are disclosed, for example, in U.S. Pat. No. 4,611,456 and U.S. Pat. No. 4,862,671. For example, Knoell, in U.S. Pat. No. 3,932,105, discloses processes for the vacuum lamination of a film onto a folded paperboard carton. , Lee, et al., in U.S. Pat. No. 3,957,558, disclose the vacuum lamination of thermoplastic films onto a molded pulp product, such as a plate. Foster, et al., in U.S. Pat. No. 4,337,116, disclose the lamination of poly (ethylene terephthalate) films onto preformed molded pulp containers by preheating the pulp container and the film, pressing the film into contact with the substrate and applying vacuum through the molded pulp container substrate. Plug assisted, vacuum lamination processes are also known within the art. Wommelsdorf, et al., in U.S. Pat. No. 4,124,434, disclose such processes for deep drawn laminates, such as coated cups. Faller, in U.S. Pat. No. 4,200,481 and U.S. Pat. No. 4,257,530, disclose the production processes of lined trays by such processes.

In contrast to vacuum lamination, pressure lamination includes the application of positive pressure rather than negative pressure to a film during lamination. The film is clamped, heated until it softens, and then forced into the contours of the substrate to be laminated through air pressure being applied to the side of the film opposite to the substrate. Exhaust holes may be present to allow the trapped air to escape, or in the more common situation, the substrate is porous to air and the air escapes through the substrate. The air pressure may be released once the laminated substrate cools and the film solidifies. Pressure lamination tends to allow a faster production cycle, improved part definition and greater dimensional control in comparison to vacuum lamination.

Pressure lamination of films onto preformed substrates is disclosed, for example, within U.S. Pat. No. 3,657,044 and U.S. Pat. No. 4,862,671. Wommelsdorf, in U.S. Pat. No. 4,092,201, discloses a process for lining an air-permeable container, such as a paper cup, with a thermoplastic foil through use of a warm pressurized stream of gas.

Mechanical lamination includes any lamination method that does not use vacuum or air pressure. In this method, the film of the present invention is heated and then mechanically applied to the substrate. Examples of the mechanical application include molds or pressure rolls.

Suitable substrates for the present invention may include articles composed of paper, paperboard, cardboard, fiberboard, cellulose, such as Cellophane®, starch, plastic polystyrene foam, glass, metal, for example; aluminum or tin cans, metal foils, polymeric foams, organic foams, inorganic foams, organic-inorganic foams, polymeric films, and the like. Preferred are biodegradable substrates, such as paper, paperboard, cardboard, cellulose, starch and the like and biobenign substrates such as inorganic and inorganic-organic foams.

Polymeric films that are suitable as substrates may consist of, or contain, the sulfonated aliphatic-aromatic polyetherester disclosed herein, and/or or other polymeric materials that may be biodegradable or not biodegradable. Said materials may be naturally derived, modified naturally derived or synthetic.

Examples of biodegradable and nonbiodegradable polymeric materials suitable as substrates are disclosed herein above with regard to coating. Examples of natural polymeric materials suitable as substrates are also disclosed herein above with regard to coating.

Organic foams, such as those derived from expanded starches and grains, may be used as substrates. Such materials are disclosed, for example, in U.S. Pat. No. 3,137,592, U.S. Pat. No. 4,673,438, U.S. Pat. No. 4,863,655, U.S. Pat. No. 5,035,930, U.S. Pat. No. 5,043,196, U.S. Pat. No. 5,095,054, U.S. Pat. No. 5,300,333, U.S. Pat. No. 5,413,855, U.S. Pat. No. 5,512,090, and U.S. Pat. No. 6,106,753. Specific examples of said materials include: EcoFoam®, a product of the National Starch Company of Bridgewater, N.J., which is a hydroxypropylated starch product, and EnviroFil®, a product of the EnPac Company, a DuPont-Con Agra Company.

Particularly preferred organic-inorganic foams are cellular foams filled with inorganic fillers such as, for example, calcium carbonate, clays, cement, or limestone, having a starch-based binder, for example, potato starch, corn starch, waxy corn starch, rice starch, wheat starch, tapioca, and the like, and a small amount of fiber, as disclosed, for example, by Andersen, et. al., in U.S. Pat. No. 6,030,673. These materials are produced by mixing together ingredients, such as limestone, potato starch, fiber and water, to from a batter. The substrate is formed by pressing the batter between two heated molds. The water contained within the batter is turned to steam, raising the pressure within the mold. This forms the foamed product. Products produced through said process are commercially available by the EarthShell Packaging Company. The products include 9-inch plates, 12-ounce bowls and hinged-lid sandwich and salad containers, (“clam shells”). Further examples of organic, inorganic and organic-inorganic foam substrates are disclosed herein above.

The substrates may be formed into their final shape prior to lamination. Any conventional forming process may be used. For example, for molded pulp substrates, a “precision molding”, “die-drying”, and “close-drying” process may be used. Said processes include molding fibrous pulp from an aqueous slurry against a screen-covered open-face suction mold to the substantially finished contoured shape, followed by drying the damp pre-form under a strong pressure applied by a mated pair of heated dies. Such processes are disclosed, for example, in U.S. Pat. No. 2,183,869, U.S. Pat. No. 4,337,116, and U.S. Pat. No. 4,456,164. Precision molded pulp articles tend to be dense, hard and boardy, with an extremely smooth, hot-ironed surface finish. Disposable paper plates produced by such processes have been sold under the Chinet® trademark by the Huhtamaki Company.

Molded pulp substrates may also be produced through the commonly known “free-dried” or “open-dried” processes. The free-dried process includes molding fibrous pulp from an aqueous slurry against a screen-covered, open-face suction mold to essentially the final molded shape and then drying the damp pre-from in a free space, such as placing it on a conveyor, and moving it slowly through a heated drying oven. Said molded pulp articles tend to be characterized by a non-compacted consistency, resilient softness, and an irregular fibrous feel and appearance. Molded pulp substrates may also be produced by being “after pressed” after forming through a free-dried process, i.e., dried in the absence of constraints or pressure, for example, as disclosed within U.S. Pat. No. 2,704,493. They may also be produced through other conventional processes, such as described, for example, in U.S. Pat. No. 3,185,370.

The laminated substrates may be converted to the final shape through well-known art processes, such a press forming or folding up. Such processes are disclosed, for example in U.S. Pat. No. 3,924,013, 4,026,458, and U.S. Pat. No. 4,456,164. For example, Quick, et al., in U.S. Pat. No. 4,900,594, disclose the production of trays from flat, polyester laminated paperstock through the use of pressure and heat.

In forming a laminate, adhesives may be applied to a copolyetherpolyester film, to the substrate or to the film and the substrate to enhance the bond strength of the laminate. Adhesive lamination of films onto preformed substrates is disclosed, for example, within U.S. Pat. No. 2,434,106, U.S. Pat. No. 2,510,908, U.S. Pat. No. 2,628,180, U.S. Pat. No. 2,917,217, U.S. Pat. No. 2,975,093, U.S. Pat. No. 3,112,235, U.S. Pat. No. 3,135,648, U.S. Pat. No. 3,616,197, U.S. Pat. No. 3,697,369, U.S. Pat. No. 4,257,530, U.S. Pat. No. 4,016,327, U.S. Pat. No. 4,352,925, U.S. Pat. No. 5,037,700, U.S. Pat. No. 5,132,391, and U.S. Pat. No. 5,942,295. Schmidt, in U.S. Pat. No. 4,130,234, discloses the use of hot melt adhesives in the lamination of polymeric films to paper cups. Dropsy, in U.S. Pat. No. 4,722,474, discloses the use of adhesives for plastic laminated cardboard packaging articles. Quick, et al., in U.S. Pat. No. 4,900,594, disclose the formation of paperboard trays through pressure and heat forming of a flat polyester laminated paperboard stock adhered with a cross-linkable adhesives system. Martini, et al., in U.S. Pat. No. 5,110,390, disclose the lamination of coextruded bilayer films onto water soluble substrates through the use of adhesives. Gardiner, in U.S. Pat. No. 5,679,201 and U.S. Pat. No. 6,071,577, discloses the use of adhesives to provide improved bond strengths between polyester coated paperboard onto polyethylene coated paperboard to produce, for example, juice containers.

The film may be coated with an adhesive, either through conventional coating technologies or through coextrusion, or the substrate may be coated with adhesives, or both the film and the substrate may be coated with adhesives.

Specific examples of adhesives useful in forming laminates include the exemplary adhesives disclosed herein above for use in applying coatings to substrates.

The laminates that are comprised of the sulfonated aliphatic-aromatic polyesters of the present invention will find use in a wide variety of areas. For example, the laminates will find use as a component of personal sanitary items, such as disposable diapers, incontinence briefs, feminine pads, sanitary napkins, tampons, tampon applicators, motion sickness bags, baby pants, personal absorbent products, and the like. The laminates of the present invention combine excellent water barrier properties to avoid leak through with excellent toughness to easily conform to the body and to stretch with the body movements during use. After their use, the soiled articles will biocompost rapidly when discarded appropriately.

As further examples, the laminates of the present invention will find use as protective films for agriculture, such as mulch films, seed coverings, agriculture mats containing seeds, (“seed tapes”), garbage and lawn waste bags, and the like.

As yet further examples of the use of the laminates of the present invention; adhesive tape substrates, bags, bag closures, bed sheets, bottles, cartons, dust bags, fabric softener sheets, garment bags, industrial bags, trash bags, waste bin liners, compost bags, labels, tags, pillow cases, bed liners, bedpan liners, bandages, boxes, handkerchiefs, pouches, wipes, protective clothing, surgical gowns, surgical sheets, surgical sponges, temporary enclosures, temporary siding, toys, wipes, table clothes and the like.

Particularly preferred uses of the laminates comprising the sulfonated aliphatic-aromatic polyesters include food packaging, especially for fast food packaging. Specific examples of food packaging uses include fast food wrappers, stretch wrap films, hermetic seals, food bags, snack bags, containers for frozen food, drinking cups or goblets, heat-sealed cartons for liquid food stuffs, disposable dishes, disposable containers, grocery bags, cups, trays, cartons, boxes, bottles, crates, food packaging films, blister pack wrappers, skin packaging, hinged lid sandwich and salad containers, (“clam shells”), and the like. In cups intended for hot drinks, it is preferable to have the watertight polyester coating only on the inner surface. On the other hand, for cups intended for cold drinks, it is preferable to have the polyester coating on both the inner and outer surface of the cup to protect from water condensing on the outer surface of the cup. For heat-sealed cartons, it is preferable that the sealable polyester coating be on both the inner and outer surface of the container. A specifically preferred end use for the laminates of the present invention includes wraps. Such wraps may take the form of a polymeric laminated paper. Wraps may be used to enclose meats, other perishable items, and especially fast food items, such as sandwiches, burgers, dessert items, and the like. Desirably, the laminates of the present invention used as wraps will provide a balance of physical properties, including paper-like stiffness combined with sufficient toughness so as not to tear when used to wrap, for example, a sandwich, deadfold characteristics that once folded, wrapped or otherwise manipulated into the desired shape, the wraps will maintain their shape and not tend to spontaneously unfold or unwrap; grease resistance, where desired, and a balance of moisture barrier properties that avoids condensation of moisture on the packaged food. The wraps may have smooth surface or a textured surface, and texture may be imparted to the surface by processes such as embossing, crimping, quilting, and the like. The wraps may be filled, with, for example, inorganic particles, organic particles, such as starch, combinations of fillers and the like.

Test Methods:

Unless otherwise stated, the following methods are used for all tests and measurements disclosed herein.

Differential Scanning Calorimetry (DSC) was performed on a TA Instruments Model Number 2920 machine. Samples were heated under a nitrogen atmosphere at a rate of 20° C./minute to 300° C., programmed cooled back to room temperature at a rate of 20° C./minute, and then reheated to 300° C. at a rate of 20° C./minute. The observed sample glass transition temperature (Tg) and crystalline melting temperature (Tm) noted below were from the second heat.

Inherent Viscosity (IV) was as defined in “Preparative Methods of Polymer Chemistry”, W. R. Sorenson and T. W. Campbell, 1961, p. 35. The IV was determined at a concentration of 0.5 g./100 mL of a 50:50 weight percent trifluoroacetic acid:dichloromethane acid solvent system at room temperature by a Goodyear R-103B method.

Laboratory Relative Viscosity (LRV) was the ratio of the viscosity of a solution of 0.6 gram of the polyester sample dissolved in 10 mL of hexafluoroisopropanol (HFIP) containing 80 ppm sulfuric acid to the viscosity of the sulfuric acid-containing hexafluoroisopropanol itself, both measured at 25° C. in a capillary viscometer. The LRV may be numerically related to IV. Where this relationship is utilized, the term “calculated IV” is noted.

Biodegradation was performed according to the ISO 14855 method: “Determination of the ultimate aerobic biodegradability and disintegration of plastic materials under controlled composting conditions—Method by analysis of evolved carbon”. This test involved injecting an inoculum consisting of a stabilized and mature compost derived from the organic fraction of municipal solid waste with ground powder of the polymer to be tested on a vermiculite matrix, composting under standard conditions at an incubation temperature controlled at 58° C.+/−2° C. The test was conducted with one polymer sample. The carbon dioxide evolved was used to determine the extent of biodegradation.

### COMPARATIVE PREPARATIVE EXAMPLE CPE 1

To a 1.0 liter glass flask was added bis(2-hydroxyethyl)terephthalate (508.48 grams), dimethyl glutarate (83.00 grams), dimethyl 5-sulfoisophthalate, sodium salt (15.19 grams), tris(2-hydroxyethyl)trimellitate (2.23 grams), sodium acetate (0.76 grams), manganese(II) acetate tetrahydrate (0.2363 grams), and antimony(III) trioxide (0.1902 grams). The reaction mixture was stirred and heated to 180° C. under a slow nitrogen purge. After achieving 180° C., the reaction mixture was heated to 200° C. over 0.5 hours with stirring under a slow nitrogen purge. The resulting reaction mixture was stirred at 200° C. under a slight nitrogen purge for 1 hour. The reaction mixture was then heated to 275° C. over 0.5 hours with stirring under a slight nitrogen purge. The resulting reaction mixture was stirred at 275° C. for 1 hour while under a slight nitrogen purge. 77.2 grams of a colorless distillate was collected over this heating cycle. The reaction mixture was then staged to full vacuum with stirring at 275° C. The resulting reaction mixture was stirred for 3.4 hours under full vacuum (pressure less than 100 mtorr). The vacuum was then released with nitrogen and the reaction mass allowed to cool to room temperature. An additional 54.6 grams of distillate was recovered and 403.7 grams of a solid product was recovered.

The sample was measured for inherent viscosity, as described above, and was found to have an inherent viscosity (IV) of 0.58 dL/g.

The sample underwent differential scanning calorimetry (DSC) analysis. A glass transition temperature (Tg) was found with an onset temperature of 47.6° C., a midpoint temperature of 50.4° C., and an endpoint temperature of 53.1° C. A crystalline melting temperature (Tm) was observed at 214.9° C. (28.0 J/g).

This sample underwent biodegradation testing as described above. After 26.3 days of composting, 7.5 weight percent of the sample was found to have been biodegraded.

Prior to testing film properties, the film samples were conditioned for 40 hours at 72 F and 50 percent humidity. Elmendorf Tear was determined as per ASTM 1922. Graves Tear was determined as per ASTM D1004. Tensile Strength at break, tensile modulus and percent elongation at break was determined as per ASTM D882.

### COMPARATIVE PREPARATIVE EXAMPLE CPE 2

To a 1.0 liter glass flask was added bis(2-hydroxyethyl)terephthalate (635.60 grams), dimethyl glutarate (2.05 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), and antimony(III) trioxide (0.1902 grams). The reaction mixture was stirred and heated to 180° C. under a slow nitrogen purge. After achieving 180° C., the reaction mixture was heated to 200° C. over 0.5 hours with stirring under a slow nitrogen purge. The resulting reaction mixture was stirred at 200° C. under a slight nitrogen purge for 1.1 hours. The reaction mixture was then heated to 275° C. over 0.8 hours with stirring under a slight nitrogen purge. The resulting reaction mixture was stirred at 275° C. for 1.0 hour while under a slight nitrogen purge. 82.4 grams of a colorless distillate was collected over this heating cycle. The reaction mixture was then staged to full vacuum with stirring at 275° C. The resulting reaction mixture was stirred for 2.3 hours under full vacuum (pressure less than 100 mtorr). The vacuum was then released with nitrogen and the reaction mass allowed to cool to room temperature. An additional 62.6 grams of distillate was recovered and 423.6 grams of a solid product was recovered.

The sample was measured for inherent viscosity (IV) as described above, and was found to have an IV of 0.61 dL/g.

The sample underwent differential scanning calorimetry (DSC) analysis. A crystalline melting temperature (Tm) was observed at 247.6° C. (37.3 J/g).

This sample underwent biodegradation testing as described above. After 26.3 days of composting, 9.8 weight percent of the sample was found to have been biodegraded.

### PREPARATIVE EXAMPLE PE 1

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), and antimony(III) trioxide (0.1902 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1 hour. The reaction mixture was then heated to 275° C. over 1.3 hours with stirring under a slight nitrogen purge. The resulting reaction mixture was stirred at 275° C. for 1.2 hour while under a slight nitrogen purge. 67.0 grams of a colorless distillate was collected over this heating cycle. The reaction mixture was then staged to full vacuum with stirring at 275° C. The resulting reaction mixture was stirred for 3.2 hours under full vacuum (pressure less than 100 mtorr). The vacuum was then released with nitrogen and the reaction mass allowed to cool to room temperature. An additional 68.2 grams of distillate was recovered and 400.0 grams of a solid product was recovered.

The sample was measured for laboratory relative viscosity (LRV) as described above and was found to have an LRV of 25.62. This sample was calculated to have an inherent viscosity of 0.71 dL/g.

The sample underwent differential scanning calorimetry (DSC) analysis. A glass transition temperature (Tg) was found with an onset temperature of 37.6° C., a midpoint temperature of 38.9° C., and an endpoint temperature of 39.7° C. A broad crystalline melting temperature (Tm) was observed at 206.6° C. (20.6 J/g).

This sample underwent biodegradation testing as described above. After 26.5 days of composting, 22.7 weight percent of the sample was found to have been biodegraded.

### PREPARATIVE EXAMPLE PE 2

To a 250 milliliter glass flask was added bis(2-hydroxyethyl)terephthalate (99.15 grams), dimethyl glutarate (16.02 grams), dimethyl 5-sulfoisophthalate, sodium salt (2.96 grams), polyethylene glycol (average molecular weight=1000) (8.14 grams), manganese(II) acetate tetrahydrate (0.042 grams), and antimony(III) trioxide (0.034 grams). The reaction mixture was stirred and heated to 180° C. under a slow nitrogen purge. After achieving 180° C., the reaction mixture was heated to 200° C. over 0.4 hours with stirring under a slow nitrogen purge. The resulting reaction mixture was stirred at 200° C. under a slight nitrogen purge for 1.1 hours. The reaction mixture was then heated to 275° C. over 1.6 hours with stirring under a slight nitrogen purge. The resulting reaction mixture was stirred at 275° C. for 1.2 hours while under a slight nitrogen purge. 9.67 grams of a colorless distillate was collected over this heating cycle. The reaction mixture was then staged to full vacuum with stirring at 275° C. The resulting reaction mixture was stirred for 4.0 hours under full vacuum (pressure less than 100 mtorr). The vacuum was then released with nitrogen and the reaction mass allowed to cool to room temperature. An additional 7.12 grams of distillate was recovered and 100.54 grams of a solid product was recovered.

The sample was measured for laboratory relative viscosity (LRV) as described above and was found to have an LRV of 26.32. This sample was calculated to have an inherent viscosity of 0.72 dL/g.

The sample underwent differential scanning calorimetry (DSC) analysis. A broad crystalline melting temperature (Tm) was observed at 169.0° C. (14.1 J/g).

### PREPARATIVE EXAMPLE PE 3

To a 250 milliliter glass flask was added bis(2-hydroxyethyl)terephthalate (99.15 grams), dimethyl glutarate (16.02 grams), dimethyl 5-sulfoisophthalate, sodium salt (2.96 grams), poly(ethylene glycol) (average molecular weight=2000) (8.14 grams), manganese(II) acetate tetrahydrate (0.042 grams), and antimony(III) trioxide (0.034 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1.1 hours. The reaction mixture was then heated to 275° C. over 1.3 hours with stirring under a slight nitrogen purge. The resulting reaction mixture was stirred at 275° C. for 1.0 hour while under a slight nitrogen purge. 7.60 grams of a colorless distillate was collected over this heating cycle. The reaction mixture was then staged to full vacuum with stirring at 275° C. The resulting reaction mixture was stirred for 1.8 hours under full vacuum (pressure less than 100 mtorr). The vacuum was then released with nitrogen and the reaction mass allowed to cool to room temperature. An additional 12.08 grams of distillate was recovered and 80.89 grams of a solid product was recovered.

The sample was measured for laboratory relative viscosity (LRV) as described above and was found to have an LRV of 34.54. This sample was calculated to have an inherent viscosity of 0.87 dL/g.

The sample underwent differential scanning calorimetry (DSC) analysis. A broad crystalline melting temperature (Tm) was observed at 190.0° C. (19.7 J/g).

### PREPARATIVE EXAMPLE PE 4

To a 250 milliliter glass flask was added bis(2-hydroxyethyl)terephthalate (99.15 grams), dimethyl glutarate (16.02 grams), dimethyl 5-sulfoisophthalate, sodium salt (2.96 grams), poly(ethylene glycol)-block-poly(propylene glycol)-block-poly(ethylene glycol) (10 weight percent poly(ethylene glycol) content, CAS # 9003-11-6, average molecular weight=1100)) (8.14 grams), manganese(II) acetate tetrahydrate (0.042 grams), and antimony(III) trioxide (0.034 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1.0 hour. The reaction mixture was then heated to 275° C. over 1.3 hours with stirring under a slight nitrogen purge. The resulting reaction mixture was stirred at 275° C. for 1.0 hour while under a slight nitrogen purge. 23.88 grams of a colorless distillate was collected over this heating cycle. The reaction mixture was then staged to full vacuum with stirring at 275° C. The resulting reaction mixture was stirred for 4.2 hours under full vacuum (pressure less than 100 mtorr). The vacuum was then released with nitrogen and the reaction mass allowed to cool to room temperature. An additional 2.87 grams of distillate was recovered and 81.78 grams of a solid product was recovered.

The sample was measured for laboratory relative viscosity (LRV) as described above and was found to have an LRV of 17.25. This sample was calculated to have an inherent viscosity of 0.56 dL/g.

The sample underwent differential scanning calorimetry (DSC) analysis. A broad crystalline melting temperature (Tm) was observed at 207.1° C. (27.0 J/g).

### PREPARATIVE EXAMPLE PE 5

To a 250 milliliter glass flask was added bis(2-hydroxyethyl)terephthalate (99.15 grams), dimethyl glutarate (16.02 grams), dimethyl 5-sulfoisophthalate, sodium salt (2.96 grams), poly(ethylene glycol)-block-poly(propylene glycol)-block-poly(ethylene glycol) (10 weight percent poly(ethylene glycol) content, CAS # 9003-11-6, average molecular weight=2000)) (8.14 grams), manganese(II) acetate tetrahydrate (0.042 grams), and antimony(III) trioxide (0.034 grams). The reaction mixture was stirred and heated to 180° C. under a slow nitrogen purge. After achieving 180° C., the reaction mixture was heated to 200° C. over 1.0 hours with stirring under a slow nitrogen purge. The resulting reaction mixture was stirred at 200° C. under a slight nitrogen purge for 1.0 hour. The reaction mixture was then heated to 275° C. over 0.5 hours with stirring under a slight nitrogen purge. The resulting reaction mixture was stirred at 275° C. for 1.0 hour while under a slight nitrogen purge. 10.93 grams of a colorless distillate was collected over this heating cycle. The reaction mixture was then staged to full vacuum with stirring at 275° C. The resulting reaction mixture was stirred for 2.3 hours under full vacuum (pressure less than 100 mtorr). The vacuum was then released with nitrogen and the reaction mass allowed to cool to room temperature. An additional 8.31 grams of distillate was recovered and 87.70 grams of a solid product was recovered.

The sample was measured for laboratory relative viscosity (LRV) as described above and was found to have an LRV of 26.27. This sample was calculated to have an inherent viscosity of 0.72 dL/g.

The sample underwent differential scanning calorimetry (DSC) analysis. A broad crystalline melting temperature (Tm) was observed at 185.6° C. (6.5 J/g).

### PREPARATIVE EXAMPLE PE 6

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Fuji Silica 310 P (27.88 grams). The reaction mixture was stirred and heated to 180° C. under a slow nitrogen purge. After achieving 180° C., the reaction mixture was heated to 200° C. over 1.1 hours with stirring under a slow nitrogen purge. The resulting reaction mixture was stirred at 200° C. under a slight nitrogen purge for 1 hour. The reaction mixture was then heated to 275° C. over 1.5 hours with stirring under a slight nitrogen purge. The resulting reaction mixture was stirred at 275° C. for 1 hour while under a slight nitrogen purge. 68.40 grams of a colorless distillate was collected over this heating cycle. The reaction mixture was then staged to full vacuum with stirring at 275° C. The resulting reaction mixture was stirred for 3.2 hours under full vacuum (pressure less than 100 mtorr). The vacuum was then released with nitrogen and the reaction mass allowed to cool to room temperature. An additional 56.7 grams of distillate was recovered and 482.9 grams of a solid product was recovered.

The sample was measured for laboratory relative viscosity (LRV) as described above and was found to have an LRV of 12.85. This sample was calculated to have an inherent viscosity of 0.48 dL/g.

The sample underwent differential scanning calorimetry (DSC) analysis. A glass transition temperature (Tg) was found with an onset temperature of 105.6° C., a midpoint temperature of 106.4° C., and an endpoint temperature of 107.2° C. A crystalline melting temperature (Tm) was observed at 203.9° C. (21.2 J/g).

This sample underwent biodegradation testing as described above. After 26.5 days of composting, 13.1 weight percent of the sample was found to have been biodegraded.

### PREPARATIVE EXAMPLE PE 7

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a kaolin (27.88 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 0.9 hours. The reaction mixture was then heated to 275° C. over 2.0 hours with stirring under a slight nitrogen purge. The resulting reaction mixture was stirred at 275° C. for 0.8 hours while under a slight nitrogen purge. 81.7 grams of a colorless distillate was collected over this heating cycle. The reaction mixture was then staged to full vacuum with stirring at 275° C. The resulting reaction mixture was stirred for 2.4 hours under full vacuum (pressure less than 100 mtorr). The vacuum was then released with nitrogen and the reaction mass allowed to cool to room temperature. An additional 54.6 grams of distillate was recovered and 473.3 grams of a solid product was recovered.

The sample was measured for laboratory relative viscosity (LRV) as described above and was found to have an LRV of 23.26. This sample was calculated to have an inherent viscosity of 0.67 dL/g.

The sample underwent differential scanning calorimetry (DSC) analysis. A glass transition temperature (Tg) was found with an onset temperature of 41.1° C., a midpoint temperature of 45.3° C., and an endpoint temperature of 48.9° C. A crystalline melting temperature (Tm) was observed at 203.5° C. (22.9 J/g).

This sample underwent biodegradation testing as described above. After 26.5 days of composting, 22.1 weight percent of the sample was found to have been biodegraded.

### PREPARATIVE EXAMPLE PE 8

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and Cloisite 30B (27.88 grams, supplied by Southern Clay, Inc., a natural montmorillonite clay coated with a quarternary ammonium tallow derivative (bis(2-hyrdroxyethyl)-methyl-tallow ammonium chloride)). The reaction mixture was stirred and heated to 180° C. under a slow nitrogen purge. After achieving 180° C., the reaction mixture was heated to 200° C. over 1.1 hours with stirring under a slow nitrogen purge. The resulting reaction mixture was stirred at 200° C. under a slight nitrogen purge for 1 hour. The reaction mixture was then heated to 275° C. over 1.2 hours with stirring under a slight nitrogen purge. The resulting reaction mixture was stirred at 275° C. for 1 hour while under a slight nitrogen purge. 83.2 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 51.4 grams of distillate was recovered and 454.3 grams of a solid product was recovered.

The sample was measured for laboratory relative viscosity (LRV) as described above and was found to have an LRV of 24.42. This sample was calculated to have an inherent viscosity of 0.69 dL/g.

The sample underwent differential scanning calorimetry (DSC) analysis. A glass transition temperature (Tg) was found with an onset temperature of 35.3° C., a midpoint temperature of 35.5° C., and an endpoint temperature of 35.9° C. A crystalline melting temperature (Tm) was observed at 188.3 CC (20.9 J/g).

This sample underwent biodegradation testing as described above. After 26.5 days of composting, 24.2 weight percent of the sample was found to have been biodegraded.

### PREPARATIVE EXAMPLE PE 9

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and Cloisite Na (27.88 grams, a Southern Clay product which is a natural montomorillonite clay). The reaction mixture was stirred and heated to 180° C. under a slow nitrogen purge. After achieving 180° C., the reaction mixture was heated to 200° C. over 0.8 hours with stirring under a slow nitrogen purge. The resulting reaction mixture was stirred at 200° C. under a slight nitrogen purge for 0.9 hours. The reaction mixture was then heated to 275° C. over 0.7 hours with stirring under a slight nitrogen purge. The resulting reaction mixture was stirred at 275° C. for 0.9 hours while under a slight nitrogen purge. 91.8 grams of a colorless distillate was collected over this heating cycle. The reaction mixture was then staged to full vacuum with stirring at 275° C. The resulting reaction mixture was stirred for 2.3 hours under full vacuum (pressure less than 100 mtorr). The vacuum was then released with nitrogen and the reaction mass allowed to cool to room temperature. An additional 56.6 grams of distillate was recovered and 445.1 grams of a solid product was recovered.

The sample was measured for laboratory relative viscosity (LRV) as described above and was found to have an LRV of 24.39. This sample was calculated to have an inherent viscosity of 0.69 dL/g.

The sample underwent differential scanning calorimetry (DSC) analysis. Within the first heating cycle, a glass transition temperature (Tg) was found with an onset temperature of 46.0° C., a midpoint temperature of 50.6° C., and an endpoint temperature of 53.2° C. This glass transition temperature was not observed in the second heating cycle of the DSC experiment. During the second heating cycle of the DSC experiment, a crystalline melting temperature (Tm) was observed at 209.8° C. (25.4 J/g).

This sample underwent biodegradation testing as described above. After 26.5 days of composting, 22.7 weight percent of the sample was found to have been biodegraded.

### PREPARATIVE EXAMPLE PE 10

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Claytone 2000 (27.88 grams, a Southern Clay, Inc., product which is an organophilic smectite clay). The reaction mixture was stirred and heated to 180° C. under a slow nitrogen purge. After achieving 180° C., the reaction mixture was heated to 200° C. over 0.6 hours with stirring under a slow nitrogen purge. The resulting reaction mixture was stirred at 200° C. under a slight nitrogen purge for 0.9 hours. The reaction mixture was then heated to 275° C. over 1.5 hours with stirring under a slight nitrogen purge. The resulting reaction mixture was stirred at 275° C. for 1.1 hours while under a slight nitrogen purge. 62.6 grams of a colorless distillate was collected over this heating cycle. The reaction mixture was then staged to full vacuum with stirring at 275° C. The resulting reaction mixture was stirred for 1.3 hours under full vacuum (pressure less than 100 mtorr). The vacuum was then released with nitrogen and the reaction mass allowed to cool to room temperature. An additional 53.7 grams of distillate was recovered and 509.2 grams of a solid product was recovered.

The sample was measured for laboratory relative viscosity (LRV) as described above and was found to have an LRV of 28.59. This sample was calculated to have an inherent viscosity of 0.76 dL/g.

The sample underwent differential scanning calorimetry (DSC) analysis. A glass transition temperature (Tg) was found with an onset temperature of 26.0° C., a midpoint temperature of 28.2° C., and an endpoint temperature of 30.1° C. A crystalline melting temperature (Tm) was observed at 181.2° C. (18.9 J/g).

This sample underwent biodegradation testing as described above. After 26.5 days of composting, 26.5 weight percent of the sample was found to have been biodegraded.

### PREPARATIVE EXAMPLE PE 11

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Garamite 1958 (27.88 grams, a Southern Clay, Inc., product which is a mixture of minerals). The reaction mixture was stirred and heated to 180° C. under a slow nitrogen purge. After achieving 180° C., the reaction mixture was heated to 200° C. over 1.0 hour with stirring under a slow nitrogen purge. The resulting reaction mixture was stirred at 200° C. under a slight nitrogen purge for 1.0 hour. The reaction mixture was then heated to 275° C. over 0.67 hours with stirring under a slight nitrogen purge. The resulting reaction mixture was stirred at 275° C. for 1.0 hour while under a slight nitrogen purge. 88.5 grams of a colorless distillate was collected over this heating cycle. The reaction mixture was then staged to full vacuum with stirring at 275° C. The resulting reaction mixture was stirred for 2.3 hours under full vacuum (pressure less than 100 mtorr). The vacuum was then released with nitrogen and the reaction mass allowed to cool to room temperature. An additional 56.7 grams of distillate was recovered and 436.6 grams of a solid product was recovered.

The sample was measured for laboratory relative viscosity (LRV) as described above and was found to have an LRV of 24.97. This sample was calculated to have an inherent viscosity of 0.70 dL/g.

The sample underwent differential scanning calorimetry (DSC) analysis. A crystalline melting temperature (Tm) was observed at 208.6° C. 22.3 J/g).

This sample underwent biodegradation testing as described above. After 22.9 days of composting, 13.6 weight percent of the sample was found to have been biodegraded.

### PREPARATIVE EXAMPLE PE 12

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Laponite RD (27.88 grams, a Southern Clay, Inc., product which is a synthetic colloidal clay). The reaction mixture was stirred and heated to 180° C. under a slow nitrogen purge. After achieving 180° C., the reaction mixture was heated to 200° C. over 0.4 hours with stirring under a slow nitrogen purge. The resulting reaction mixture was stirred at 200° C. under a slight nitrogen purge for 0.8 hours. The reaction mixture was then heated to 275° C. over 0.9 hours with stirring under a slight nitrogen purge. The resulting reaction mixture was stirred at 275° C. for 1.3 hours while under a slight nitrogen purge. 112.4 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 36.1 grams of distillate was recovered and 425.0 grams of a solid product was recovered.

The sample was measured for laboratory relative viscosity (LRV) as described above and was found to have an LRV of 21.35. This sample was calculated to have an inherent viscosity of 0.63 dL/g.

The sample underwent differential scanning calorimetry (DSC) analysis. A crystalline melting temperature (Tm) was observed at 217.5° C. (27.2 J/g).

This sample underwent biodegradation testing as described above. After 22.9 days of composting, 10.0 weight percent of the sample was found to have been biodegraded.

### PREPARATIVE EXAMPLE PE 13

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Laponite RDS (27.88 grams, a Southern Clay, Inc., product which is a synthetic layered silicate with a inorganic polyphosphate peptiser). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1.1 hours. The reaction mixture was then heated to 275° C. over 0.8 hours with stirring under a slight nitrogen purge. The resulting reaction mixture was stirred at 275° C. for 1.0 hour while under a slight nitrogen purge. 111.3 grams of a colorless distillate was collected over this heating cycle. The reaction mixture was then staged to full vacuum with stirring at 275° C. The resulting reaction mixture was stirred for 2.9 hours under full vacuum (pressure less than 100 mtorr). The vacuum was then released with nitrogen and the reaction mass allowed to cool to room temperature. An additional 38.9 grams of distillate was recovered and 450.6 grams of a solid product was recovered.

The sample was measured for laboratory relative viscosity (LRV) as described above and was found to have an LRV of 22.40. This sample was calculated to have an inherent viscosity of 0.65 dL/g.

The sample underwent differential scanning calorimetry (DSC) analysis. A crystalline melting temperature (Tm) was observed at 216.3° C. (26.5 J/g).

This sample underwent biodegradation testing as described above. After 22.9 days of composting, 10.1 weight percent of the sample was found to have been biodegraded.

### PREPARATIVE EXAMPLE PE 14

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Gelwhite L (27.88 grams. A Southern Clay, Inc., product which is a montmorillonite clay from white bentonite). The reaction mixture was stirred and heated to 180° C. under a slow nitrogen purge. After achieving 180° C., the reaction mixture was heated to 200° C. over 0.8 hours with stirring under a slow nitrogen purge. The resulting reaction mixture was stirred at 200° C. under a slight nitrogen purge for 1.1 hours. The reaction mixture was then heated to 275° C. over 1.7 hours with stirring under a slight nitrogen purge. The resulting reaction mixture was stirred at 275° C. for 1.0 hour while under a slight nitrogen purge. 57.1 grams of a colorless distillate was collected over this heating cycle. The reaction mixture was then staged to full vacuum with stirring at 275° C. The resulting reaction mixture was stirred for 3.4 hours under full vacuum (pressure less than 100 mtorr). The vacuum was then released with nitrogen and the reaction mass allowed to cool to room temperature. An additional 63.5 grams of distillate was recovered and 522.0 grams of a solid product was recovered.

The sample was measured for inherent viscosity (IV) as described above and was found to have an inherent viscosity of 0.58 dL/g.

The sample underwent differential scanning calorimetry (DSC) analysis. A crystalline melting temperature (Tm) was observed at 181.6° C. (17.2 J/g).

This sample underwent biodegradation testing as described above. After 22.9 days of composting, 16.4 weight percent of the sample was found to have been biodegraded.

### PREPARATIVE EXAMPLE PE 15

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a Gelwhite MAS 100 (27.88 grams, a Southern Clay, Inc., product which is a white smectite clay (magnesium aluminum silicate)). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1.1 hours. The reaction mixture was then heated to 275° C. over 0.7 hours with stirring under a slight nitrogen purge. The resulting reaction mixture was stirred at 275° C. for 1.1 hours while under a slight nitrogen purge. 87.5 grams of a colorless distillate was collected over this heating cycle. The reaction mixture was then staged to full vacuum with stirring at 275° C. The resulting reaction mixture was stirred for 1.8 hours under full vacuum (pressure less than 100 mtorr). The vacuum was then released with nitrogen and the reaction mass allowed to cool to room temperature. An additional 27.3 grams of distillate was recovered and 524.3 grams of a solid product was recovered.

The sample was measured for laboratory relative viscosity (LRV) as described above and was found to have an LRV of 32.87. This sample was calculated to have an inherent viscosity of 0.84 dL/g.

The sample underwent differential scanning calorimetry (DSC) analysis. A glass transition temperature (Tg) was found with an onset temperature of 26.0° C., a midpoint temperature of 28.2° C., and an endpoint temperature of 30.1° C. A crystalline melting temperature (Tm) was observed at 171.1° C. (1.2 J/g).

This sample underwent biodegradation testing as described above. After 22.9 days of composting, 12.2 weight percent of the sample was found to have been biodegraded.

### PREPARATIVE EXAMPLE PE 16

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a talc (27.88 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 0.9 hours. The reaction mixture was then heated to 275° C. over 0.7 hours with stirring under a slight nitrogen purge. The resulting reaction mixture was stirred at 275° C. for 1.0 hour while under a slight nitrogen purge. 91.0 grams of a colorless distillate was collected over this heating cycle. The reaction mixture was then staged to full vacuum with stirring at 275° C. The resulting reaction mixture was stirred for 3.2 hours under full vacuum (pressure less than 100 mtorr). The vacuum was then released with nitrogen and the reaction mass allowed to cool to room temperature. An additional 49.6 grams of distillate was recovered and 442.8 grams of a solid product was recovered.

The sample was measured for laboratory relative viscosity (LRV) as described above and was found to have an LRV of 25.72. This sample was calculated to have an inherent viscosity of 0.71 dL/g.

The sample underwent differential scanning calorimetry (DSC) analysis. A crystalline melting temperature (Tm) was observed at 207.0° C. (19.2 J/g).

This sample underwent biodegradation testing as described above. After 23.6 days of composting, 26.6 weight percent of the sample was found to have been biodegraded.

### PREPARATIVE EXAMPLE PE 17

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a mica (27.88 grams). The reaction mixture was stirred and heated to 180° C. under a slow nitrogen purge. After achieving 180° C., the reaction mixture was heated to 200° C. over 0.5 hours with stirring under a slow nitrogen purge. The resulting reaction mixture was stirred at 200° C. under a slight nitrogen purge for 1.1 hours. The reaction mixture was then heated to 275° C. over 0.8 hours with stirring under a slight nitrogen purge. The resulting reaction mixture was stirred at 275° C. for 1.2 hours while under a slight nitrogen purge. 91.0 grams of a colorless distillate was collected over this heating cycle. The reaction mixture was then staged to full vacuum with stirring at 275° C. The resulting reaction mixture was stirred for 2.4 hours under full vacuum (pressure less than 100 mtorr). The vacuum was then released with nitrogen and the reaction mass allowed to cool to room temperature. An additional 53.1 grams of distillate was recovered and 446.1 grams of a solid product was recovered.

The sample was measured for laboratory relative viscosity (LRV) as described above and was found to have an LRV of 24.07. This sample was calculated to have an inherent viscosity of 0.68 dL/g.

The sample underwent differential scanning calorimetry (DSC) analysis. A glass transition temperature (Tg) was found with an onset temperature of 37.4° C., a midpoint temperature of 38.1° C., and an endpoint temperature of 38.3° C. A crystalline melting temperature (Tm) was observed at 207.2° C. (19.9 J/g).

This sample underwent biodegradation testing as described above. After 23.6 days of composting, 18.0 weight percent of the sample was found to have been biodegraded.

### PREPARATIVE EXAMPLE PE 18

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a 50 weight percent slurry of calcium carbonate in ethylene glycol (55.76 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 0.9 hours. The reaction mixture was then heated to 275° C. over 0.8 hours with stirring under a slight nitrogen purge. The resulting reaction mixture was stirred at 275° C. for 1.8 hours while under a slight nitrogen purge. 100.6 grams of a colorless distillate was collected over this heating cycle. The reaction mixture was then staged to full vacuum with stirring at 275° C. The resulting reaction mixture was stirred for 2.4 hours under full vacuum (pressure less than 100 mtorr). The vacuum was then released with nitrogen and the reaction mass allowed to cool to room temperature. An additional 60.8 grams of distillate was recovered and 455.0 grams of a solid product was recovered.

The sample was measured for laboratory relative viscosity (LRV) as described above and was found to have an LRV of 25.13. This sample was calculated to have an inherent viscosity of 0.70 dL/g.

The sample underwent differential scanning calorimetry (DSC) analysis. A crystalline melting temperature (Tm) was observed at 209.1° C. (23.4 J/g).

This sample underwent biodegradation testing as described above. After 23.6 days of composting, 18.3 weight percent of the sample was found to have been biodegraded.

### PREPARATIVE EXAMPLE PE 19

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 66.46 grams), sodium acetate (0.76 grams), manganese(II) acetate tetrahydrate (0.2363 grams), antimony(III) trioxide (0.1902 grams) and a 50 weight percent slurry of calcium carbonate in ethylene glycol (58.31 grams). The reaction mixture was stirred and heated to 180° C. under a slow nitrogen purge. After achieving 180° C., the reaction mixture was heated to 200° C. over 0.6 hours with stirring under a slow nitrogen purge. The resulting reaction mixture was stirred at 200° C. under a slight nitrogen purge for 0.8 hours. The reaction mixture was then heated to 275° C. over 0.8 hours with stirring under a slight nitrogen purge. The resulting reaction mixture was stirred at 275° C. for 1.3 hours while under a slight nitrogen purge. 95.9 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 64.7 grams of distillate was recovered and 484.1 grams of a solid product was recovered.

The sample was measured for laboratory relative viscosity (LRV) as described above and was found to have an LRV of 19.97. This sample was calculated to have an inherent viscosity of 0.61 dL/g.

The sample underwent differential scanning calorimetry (DSC) analysis. A crystalline melting temperature (Tm) was observed at 206.9° C. (22.3 J/g).

This sample underwent biodegradation testing as described above. After 23.6 days of composting, 17.4 weight percent of the sample was found to have been biodegraded.

### PREPARATIVE EXAMPLE PE 20

To a 1.0 liter glass flask was added bis(2-hydroxyethyl)terephthalate (406.78 grams), dimethyl glutarate (65.71 grams), dimethyl 5-sulfoisophthalate, sodium salt (12.15 grams), tris(2-hydroxyethyl)trimellitate (1.78 grams), polyethylene glycol (average molecular weight=1450, 74.27 grams), sodium acetate (0.61 grams), manganese(II) acetate tetrahydrate (0.1890 grams), antimony(III) trioxide (0.1522 grams) and a 50 weight percent slurry of calcium carbonate in ethylene glycol (48.86 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1.0 hour. The reaction mixture was then heated to 275° C. over 0.8 hours with stirring under a slight nitrogen purge. The resulting reaction mixture was stirred at 275° C. for 1.1 hours while under a slight nitrogen purge. 77.5 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 56.2 grams of distillate was recovered and 425.0 grams of a solid product was recovered.

The sample was measured for laboratory relative viscosity (LRV) as described above and was found to have an LRV of 30.98. This sample was calculated to have an inherent viscosity of 0.81 dL/g.

The sample underwent differential scanning calorimetry (DSC) analysis. A crystalline melting temperature (Tm) was observed at 204.9° C. (21.6 J/g).

This sample underwent biodegradation testing as described above. After 23.6 days of composting, 9.6 weight percent of the sample was found to have been biodegraded.

### PREPARATIVE EXAMPLE PE 21

To a 1.0 liter glass flask was added bis(2-hydroxyethyl)terephthalate (508.48 grams), dimethyl glutarate (82.14 grams), dimethyl 5-sulfoisophthalate, sodium salt (15.19 grams), tris(2-hydroxyethyl)trimellitate (2.23 grams), polyethylene glycol (average molecular weight=1450, 42.38 grams), sodium acetate (0.76 grams), manganese(II) acetate tetrahydrate (0.2363 grams), antimony(III) trioxide (0.1902 grams) and a calcium hydroxide (2.66 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1.3 hours. The reaction mixture was then heated to 275° C. over 1.3 hours with stirring under a slight nitrogen purge. The resulting reaction mixture was stirred at 275° C. for 1.3 hours while under a slight nitrogen purge. 70.0 grams of a colorless distillate was collected over this heating cycle. The reaction mixture was then staged to full vacuum with stirring at 275° C. The resulting reaction mixture was stirred for 2.7 hours under full vacuum (pressure less than 100 mtorr). The vacuum was then released with nitrogen and the reaction mass allowed to cool to room temperature. An additional 60.5 grams of distillate was recovered and 404.7 grams of a solid product was recovered.

The sample was measured for laboratory relative viscosity (LRV) as described above and was found to have an LRV of 23.36. This sample was calculated to have an inherent viscosity of 0.67 dL/g.

The sample underwent differential scanning calorimetry (DSC) analysis. A crystalline melting temperature (Tm) was observed at 206.5° C. (22.9 J/g).

This sample underwent biodegradation testing as described above. After 22.9 days of composting, 17.6 weight percent of the sample was found to have been biodegraded.

### PREPARATIVE EXAMPLE PE 22

To a 1.0 liter glass flask was added bis(2-hydroxyethyl)terephthalate (475.89 grams), dimethyl glutarate (102.67 grams), dimethyl 5-sulfoisophthalate, sodium salt (15.19 grams), tris(2-hydroxyethyl)trimellitate (2.21 grams), polyethylene glycol (average molecular weight=1450, 42.16 grams), sodium acetate (0.75 grams), manganese(II) acetate tetrahydrate (0.2351 grams), and antimony(III) trioxide (0.1893 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1 hour. The reaction mixture was then heated to 275° C. over 1.3 hours with stirring under a slight nitrogen purge. The resulting reaction mixture was stirred at 275° C. for 1 hour while under a slight nitrogen purge. 72.5 grams of a colorless distillate was collected over this heating cycle. The reaction mixture was then staged to full vacuum with stirring at 275° C. The resulting reaction mixture was stirred for 3.3 hours under full vacuum (pressure less than 100 mtorr). The vacuum was then released with nitrogen and the reaction mass allowed to cool to room temperature. An additional 56.4 grams of distillate was recovered and 413.7 grams of a solid product was recovered.

The sample was measured for laboratory relative viscosity (LRV) as described above and was found to have an LRV of 24.35. This sample was calculated to have an inherent viscosity of 0.69 dL/g.

The sample underwent differential scanning calorimetry (DSC) analysis. A glass transition temperature (Tg) was found with an onset temperature of 31.1° C., a midpoint temperature of 32.7° C., and an endpoint temperature of 34.2° C. A broad crystalline melting temperature (Tm) was observed at 196.0° C. (17.7 J/g).

This sample underwent biodegradation testing as described above. After 26.5 days of composting, 26.4 weight percent of the sample was found to have been biodegraded.

### PREPARATIVE EXAMPLE PE 23

To a 1.0 liter glass flask was added bis(2-hydroxyethyl)terephthalate (380.71 grams), dimethyl glutarate (82.14 grams), dimethyl 5-sulfoisophthalate, sodium salt (12.16 grams), tris(2-hydroxyethyl)trimellitate (1.77 grams), polyethylene glycol (average molecular weight=1450, 33.73 grams), sodium acetate (0.60 grams), manganese(II) acetate tetrahydrate (0.1881 grams), antimony(III) trioxide (0.1514 grams) and a 50 weight percent slurry of calcium carbonate in ethylene glycol (210.81 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1 hour. The reaction mixture was then heated to 275° C. over 1.6 hours with stirring under a slight nitrogen purge. The resulting reaction mixture was stirred at 275° C. for 1 hour while under a slight nitrogen purge. 138.4 grams of a colorless distillate was collected over this heating cycle. The reaction mixture was then staged to full vacuum with stirring at 275° C. The resulting reaction mixture was stirred for 2.1 hours under full vacuum (pressure less than 100 mtorr). The vacuum was then released with nitrogen and the reaction mass allowed to cool to room temperature. An additional 60.3 grams of distillate was recovered and 446.3 grams of a solid product was recovered.

The sample was measured for laboratory relative viscosity (LRV) as described above and was found to have an LRV of 23.09. This sample was calculated to have an inherent viscosity of 0.66 dL/g.

The sample underwent differential scanning calorimetry (DSC) analysis. A glass transition temperature (Tg) was found with an onset temperature of 99.3° C., a midpoint temperature of 101.5° C., and an endpoint temperature of 103.7° C. A crystalline melting temperature (Tm) was observed at 182.3° C. (13.7 J/g).

This sample underwent biodegradation testing as described above. After 26.5 days of composting, 21.2 weight percent of the sample was found to have been biodegraded.

### PREPARATIVE EXAMPLE PE 24

To a 1.0 liter glass flask was added bis(2-hydroxyethyl)terephthalate (443.27 grams), dimethyl glutarate (123.20 grams), dimethyl 5-sulfoisophthalate, sodium salt (15.19 grams), tris(2-hydroxyethyl)trimellitate (1.52 grams), polyethylene glycol (average molecular weight=1450, 41.94 grams), sodium acetate (0.75 grams), manganese(II) acetate tetrahydrate (0.2339 grams), and antimony(III) trioxide (0.1883 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1 hour. The reaction mixture was then heated to 275° C. over 1.2 hours with stirring under a slight nitrogen purge. The resulting reaction mixture was stirred at 275° C. for 1 hour while under a slight nitrogen purge. 71.8 grams of a colorless distillate was collected over this heating cycle. The reaction mixture was then staged to full vacuum with stirring at 275° C. The resulting reaction mixture was stirred for 4.1 hours under full vacuum (pressure less than 100 mtorr). The vacuum was then released with nitrogen and the reaction mass allowed to cool to room temperature. An additional 55.7 grams of distillate was recovered and 445.6 grams of a solid product was recovered.

The sample was measured for laboratory relative viscosity (LRV) as described above and was found to have an LRV of 19.91. This sample was calculated to have an inherent viscosity of 0.61 dL/g.

The sample underwent differential scanning calorimetry (DSC) analysis. A glass transition temperature (Tg) was found with an onset temperature of 27.2° C., a midpoint temperature of 28.2° C., and an endpoint temperature of 28.3° C. A broad crystalline melting temperature (Tm) was observed at 187.5° C. (16.1 J/g).

This sample underwent biodegradation testing as described above. After 26.5 days of composting, 29.9 weight percent of the sample was found to have been biodegraded.

### PREPARATIVE EXAMPLE PE 25

To a 1.0 liter glass flask was added bis(2-hydroxyethyl)terephthalate (310.29 grams), dimethyl glutarate (86.24 grams), dimethyl 5-sulfoisophthalate, sodium salt (10.63 grams), tris(2-hydroxyethyl)trimellitate (1.06 grams), polyethylene glycol (average molecular weight=1450, 29.36 grams), sodium acetate (0.53 grams), manganese(II) acetate tetrahydrate (0.1637 grams), antimony(III) trioxide (0.1318 grams) and a 50 weight percent slurry of calcium carbonate in ethylene glycol (38.63 grams). The reaction mixture was stirred and heated to 180° C. under a slow nitrogen purge. After achieving 180° C., the reaction mixture was heated to 200° C. over 0.4 hours with stirring under a slow nitrogen purge. The resulting reaction mixture was stirred at 200° C. under a slight nitrogen purge for 1.0 hour. The reaction mixture was then heated to 275° C. over 0.6 hours with stirring under a slight nitrogen purge. The resulting reaction mixture was stirred at 275° C. for 1.0 hour while under a slight nitrogen purge. 60.4 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 41.9 grams of distillate was recovered and 308.9 grams of a solid product was recovered.

The sample was measured for laboratory relative viscosity (LRV) as described above and was found to have an LRV of 43.99. This sample was calculated to have an inherent viscosity of 1.04 dL/g.

The sample underwent differential scanning calorimetry (DSC) analysis. A broad crystalline melting temperature (Tm) was observed at 184.4° C. (17.3 J/g).

This sample underwent biodegradation testing as described above. After 31 days of composting, 10.8 weight percent of the sample was found to have been biodegraded.

### PREPARATIVE EXAMPLE PE 26

To a 1.0 liter glass flask was added bis(2-hydroxyethyl)terephthalate (310.29 grams), dimethyl glutarate (86.24 grams), dimethyl 5-sulfoisophthalate, sodium salt (10.63 grams), tris(2-hydroxyethyl)trimellitate (1.06 grams), polyethylene glycol (average molecular weight=1450, 29.36 grams), sodium acetate (0.53 grams), manganese(II) acetate tetrahydrat (0.1637 grams), antimony(III) trioxide (0.1318 grams) and a 50 weight percent slurry of calcium carbonate in ethylene glycol (81.55 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 0.9 hours. The reaction mixture was then heated to 275° C. over 0.9 hours with stirring under a slight nitrogen purge. The resulting reaction mixture was stirred at 275° C. for 1.3 hours while under a slight nitrogen purge. 74.3 grams of a colorless distillate was collected over this heating cycle. The reaction mixture was then staged to full vacuum with stirring at 275° C. The resulting reaction mixture was stirred for 2.2 hours under full vacuum (pressure less than 100 mtorr). The vacuum was then released with nitrogen and the reaction mass allowed to cool to room temperature. An additional 47.0 grams of distillate was recovered and 351.0 grams of a solid product was recovered.

The sample was measured for laboratory relative viscosity (LRV) as described above and was found to have an LRV of 38.48. This sample was calculated to have an inherent viscosity of 0.94 dL/g.

The sample underwent differential scanning calorimetry (DSC) analysis. During the first heating cycle, a glass transition temperature (Tg) was found with an onset temperature of 64.7° C., a midpoint temperature of 71.0° C., and an endpoint temperature of 77.4° C. This glass transition temperature was not observed within the second heating cycle of the DSC experiment. Within the second heating cycle of the DSC experiment, a broad crystalline melting temperature (Tm) was observed at 177.5° C. (16.2 J/g).

This sample underwent biodegradation testing as described above. After 31 days of composting, 9.6 weight percent of the sample was found to have been biodegraded.

### PREPARATIVE EXAMPLE PE 27

To a 1.0 liter glass flask was added bis(2-hydroxyethyl)terephthalate (310.29 grams), dimethyl glutarate (86.24 grams), dimethyl 5-sulfoisophthalate, sodium salt (10.63 grams), tris(2-hydroxyethyl)trimellitate (1.06 grams), polyethylene glycol (average molecular weight=1450, 29.36 grams), sodium acetate (0.53 grams), manganese(II) acetate tetrahydrate (0.1637 grams), antimony(III) trioxide (0.1318 grams) and a 50 weight percent slurry of calcium carbonate in ethylene glycol (183.48 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 0.9 hours. The reaction mixture was then heated to 275° C. over 0.9 hours with stirring under a slight nitrogen purge. The resulting reaction mixture was stirred at 275° C. for 1.4 hours while under a slight nitrogen purge. 118.3 grams of a colorless distillate was collected over this heating cycle. The reaction mixture was then staged to full vacuum with stirring at 275° C. The resulting reaction mixture was stirred for 1.3 hours under full vacuum (pressure less than 100 mtorr). The vacuum was then released with nitrogen and the reaction mass allowed to cool to room temperature. An additional 50.3 grams of distillate was recovered and 404.5 grams of a solid product was recovered.

The sample was measured for laboratory relative viscosity (LRV) as described above and was found to have an LRV of 23.80. This sample was calculated to have an inherent viscosity of 0.68 dL/g.

The sample underwent differential scanning calorimetry (DSC) analysis. A broad crystalline melting temperature (Tm) was observed at 167.0° C. (11.0 J/g).

This sample underwent biodegradation testing as described above. After 31 days of composting, 14.8 weight percent of the sample was found to have been biodegraded.

### COMPARATIVE PREPARATIVE EXAMPLE CPE 3

To a 1.0 liter glass flask was added bis(2-hydroxyethyl)terephthalate (443.27 grams), DBE dibasic ester (20:60:20 mole percent dimethyl succinate:dimethyl glutarate:dimethyl adipate) (123.20 grams), dimethyl 5-sulfoisophthalate, sodium salt (15.19 grams), tris(2-hydroxyethyl)trimellitate (0.20 grams), sodium acetate (0.75 grams), manganese(II) acetate tetrahydrate (0.2339 grams), and TYZOR® PC-42 organic titanate (6.3 weight percent titanium, a DuPont Company Product composed of 50 weight percent water, 38.5 weight percent of an organic titanate complex and 11.5 weight percent of an inorganic phosphorous compound) (0.1248 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1.1 hours. The reaction mixture was then heated to 275° C. over 0.8 hours with stirring under a slight nitrogen purge. The resulting reaction mixture was stirred at 275° C. for 1.1 hours while under a slight nitrogen purge. 77.3 grams of a colorless distillate was collected over this heating cycle. The reaction mixture was then staged to full vacuum with stirring at 275° C. The resulting reaction mixture was stirred for 2.5 hours under full vacuum (pressure less than 100 mtorr). The vacuum was then released with nitrogen and the reaction mass allowed to cool to room temperature. An additional 47,6 grams of distillate was recovered and 415.2 grams of a solid product was recovered.

The sample was measured for laboratory relative viscosity (LRV) as described above, and was found to have a LRV of 19.64. This sample was calculated to have an inherent viscosity (IV) of 0.60 dL/g.

The sample underwent differential scanning calorimetry (DSC) analysis. A broad crystalline melting temperature (Tm) was observed at 186.9° C. (8.9 J/g).

This sample underwent biodegradation testing as described above. After 26.3 days of composting, 13.0 weight percent of the sample was found to have been biodegraded.

### PREPARATIVE EXAMPLE PE 28

To a 1.0 liter glass flask was added bis(2-hydroxyethyl)terephthalate (443.27 grams), DBE dibasic ester (20:60:20 mole percent dimethyl succinate:dimethyl glutarate:dimethyl adipate) (123.20 grams), dimethyl 5-sulfoisophthalate, sodium salt (15.19 grams), tris(2-hydroxyethyl)trimellitate (0.20 grams), poly(ethylene glycol) (average molecular weight of 1500) (41.94 grams), sodium acetate (0.75 grams), manganese(II) acetate tetrahydrate (0.2339 grams), and TYZOR® PC-42 organic titanate (6.3 weight percent titanium, a DuPont Company Product composed of 50 weight percent water, 38.5 weight percent of an organic titanate complex and 11.5 weight percent of an inorganic phosphorous compound) (0.1248 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1.0 hour. The reaction mixture was then heated to 275° C. over 0.8 hours with stirring under a slight nitrogen purge. The resulting reaction mixture was stirred at 275° C. for 1.0 hour while under a slight nitrogen purge. 70.8 grams of a colorless distillate was collected over this heating cycle. The reaction mixture was then staged to full vacuum with stirring at 275° C. The resulting reaction mixture was stirred for 2.9 hours under full vacuum (pressure less than 100 mtorr). The vacuum was then released with nitrogen and the reaction mass allowed to cool to room temperature. An additional 49.3 grams of distillate was recovered and 470.5 grams of a solid product was recovered.

The sample was measured for laboratory relative viscosity (LRV) as described above, and was found to have a LRV of 21.79. This sample was calculated to have an inherent viscosity (IV) of 0.64 dL/g.

The sample underwent differential scanning calorimetry (DSC) analysis. A broad crystalline melting temperature (Tm) was observed at 182.5° C. (17.9 J/g).

This sample underwent biodegradation testing as described above. After 26.3 days of composting, 31.6 weight percent of the sample was found to have been biodegraded.

### PREPARATIVE EXAMPLE PE 29

To a 1.0 liter glass flask was added bis(2-hydroxyethyl)terephthalate (443.27 grams), DBE dibasic ester (20:60:20 mole percent dimethyl succinate:dimethyl glutarate:dimethyl adipate) (123.20 grams), dimethyl 5-sulfoisophthalate, sodium salt (15.19 grams), tris(2-hydroxyethyl)trimellitate (0.20 grams), poly(ethylene glycol) (average molecular weight of 3400) (41.94 grams), sodium acetate (0.75 grams), manganese(II) acetate tetrahydrate (0.2339 grams), and TYZOR® PC-42 organic titanate (6.3 weight percent titanium, a DuPont Company Product composed of 50 weight percent water, 38.5 weight percent of an organic titanate complex and 11.5 weight percent of an inorganic phosphorous compound) (0.1248 grams). The reaction mixture was stirred and heated to 180° C. under a slow nitrogen purge. After achieving 180° C., the reaction mixture was heated to 200° C. over 0.2 hours with stirring under a slow nitrogen purge. The resulting reaction mixture was stirred at 200° C. under a slight nitrogen purge for 1.0 hour. The reaction mixture was then heated to 275° C. over 0.9 hours with stirring under a slight nitrogen purge. The resulting reaction mixture was stirred at 275° C. for 1.0 hour while under a slight nitrogen purge. 67.3 grams of a colorless distillate was collected over this heating cycle. The reaction mixture was then staged to full vacuum with stirring at 275° C. The resulting reaction mixture was stirred for 3.2 hours under full vacuum (pressure less than 100 mtorr). The vacuum was then released with nitrogen and the reaction mass allowed to cool to room temperature. An additional 50.9 grams of distillate was recovered and 466.1 grams of a solid product was recovered.

The sample was measured for laboratory relative viscosity (LRV) as described above, and was found to have a LRV of 27.16. This sample was calculated to have an inherent viscosity (IV) of 0.74 dL/g.

The sample underwent differential scanning calorimetry (DSC) analysis. A broad crystalline melting temperature (Tm) was observed at 178.0° C. (14.9 J/g).

This sample underwent biodegradation testing as described above. After 26.3 days of composting, 36.7 weight percent of the sample was found to have been biodegraded.

### PREPARATIVE EXAMPLE PE 30

To a 1.0 liter glass flask was added bis(2-hydroxyethyl)terephthalate (443.27 grams),dimethyl adipate (134.0 grams), dimethyl 5-sulfoisophthalate, sodium salt (15.19 grams), tris(2-hydroxyethyl)trimellitate (0.20 grams), poly(pthylene glycol) (average molecular weight of 1500) (41.94 grams), sodium acetate (0.75 grams), manganese(II) acetate tetrahydrate (0.2339 grams), and TYZOR® PC-42 organic titanate (6.3 weight percent titanium, a DuPont Company Product composed of 50 weight percent water, 38.5 weight percent of an organic titanate complex and 11.5 weight percent of an inorganic phosphorous compound) (0.1248 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 0.6 hours. The reaction mixture was then heated to 275° C. over 0.8 hours with stirring under a slight nitrogen purge. The resulting reaction mixture was stirred at 275° C. for 1.0 hour while under a slight nitrogen purge. 96.2 grams of a colorless distillate was collected over this heating cycle. The reaction mixture was then staged to full vacuum with stirring at 275° C. The resulting reaction mixture was stirred for 3.3 hours under full vacuum (pressure less than 100 mtorr). The vacuum was then released with nitrogen and the reaction mass allowed to cool to room temperature. An additional 37.5 grams of distillate was recovered and 448.9 grams of a solid product was recovered.

The sample was measured for laboratory relative viscosity (LRV) as described above, and was found to have a LRV of 14.85. This sample was calculated to have an inherent viscosity (IV) of 0.51 dL/g.

The sample underwent differential scanning calorimetry (DSC) analysis. A broad crystalline melting temperature (Tm) was observed at 193.2° C. (23.1 J/g).

This sample underwent biodegradation testing as described above. After 26.3 days of composting, 28.0 weight percent of the sample was found to have been biodegraded.

### PREPARATIVE EXAMPLE PE 31

To a 250 milliliter glass flask was added bis(2-hydroxyethyl)terephthalate (114.03 grams), DBA dibasic acid (20:60:20 mole percent mixture of succinic acid:glutaric acid:adipic acid) (25.43 grams), dimethyl 5-sulfoisophthalate, sodium salt (0.19 grams), poly(ethylene glycol) (average molecular weight of 1500) (10.60 grams), manganese(II) acetate tetrahydrate (0.0591 grams), antimony(III) oxide (0.0476 grams), and a 50 weight percent slurry of calcium carbonate in ethylene glycol (29.42 grams). The reaction mixture was stirred and heated to 180° C. under a slow nitrogen purge. After achieving 180° C., the reaction mixture was heated to 200° C. over 0.5 hours with stirring under a slow nitrogen purge. The resulting reaction mixture was stirred at 200° C. under a slight nitrogen purge for 1.3 hours. The reaction mixture was then heated to 275° C. over 1.7 hours with stirring under a slight nitrogen purge. The resulting reaction mixture was stirred at 275° C. for 0.9 hours while under a slight nitrogen purge. 21.8 grams of a colorless distillate was collected over this heating cycle. The reaction mixture was then staged to full vacuum with stirring at 275° C. The resulting reaction mixture was stirred for 2.8 hours under full vacuum (pressure less than 100 mtorr). The vacuum was then released with nitrogen and the reaction mass allowed to cool to room temperature. An additional 13.8 grams of distillate was recovered and 125.4 grams of a solid product was recovered.

The sample was measured for laboratory relative viscosity (LRV) as described above, and was found to have a LRV of 17.92. This sample was calculated to have an inherent viscosity (IV) of 0.57 dL/g.

The sample underwent differential scanning calorimetry (DSC) analysis. A broad crystalline melting temperature (Tm) was observed at 178.9° C. (14.8 J/g).

### PREPARATIVE EXAMPLE PE 32

To a 1.0 liter glass flask was added bis(2-hydroxyethyl)terephthalate (287.48 grams), dimethyl glutarate (100.62 grams), dimethyl 5-sulfoisophthalate, sodium salt (10.63 grams), tris(2-hydroxyethyl)trimellitate (1.06 grams), polyethylene glycol (average molecular weight=1450, 28.44 grams), sodium acetate (0.53 grams), manganese(II) acetate tetrahydrate (0.1637 grams), antimony(III) trioxide (0.1318 grams) and a 50 weight percent slurry of calcium carbonate in ethylene glycol (177.73 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 1 hour. The reaction mixture was then heated to 275° C. over 1.2 hours with stirring under a slight nitrogen purge. The resulting reaction mixture was stirred at 275° C. for 1.4 hours while under a slight nitrogen purge. 101.9 grams of a colorless distillate was collected over this heating cycle. The reaction mixture was then staged to full vacuum with stirring at 275° C. The resulting reaction mixture was stirred for 1.5 hours under full vacuum (pressure less than 100 mtorr). The vacuum was then released with nitrogen and the reaction mass allowed to cool to room temperature. An additional 54.7 grams of distillate was recovered and 412.0 grams of a solid product was recovered.

The sample was measured for laboratory relative viscosity (LRV) as described above and was found to have an LRV of 31.44. This sample was calculated to have an inherent viscosity of 0.82 dL/g.

The sample underwent differential scanning calorimetry (DSC) analysis. A broad crystalline melting temperature (Tm) was observed at 155.5° C. (13.4 J/g).

This sample underwent biodegradation testing as described above. After 31 days of composting, 14.6 weight percent of the sample was found to have been biodegraded.

### PREPARATIVE EXAMPLE PE 33

To a 1.0 liter glass flask was added bis(2-hydroxyethyl)terephthalate (378.09 grams), dimethyl glutarate (164.27 grams), dimethyl 5-sulfoisophthalate, sodium salt (15.19 grams), tris(2-hydroxyethyl)trimellitate (0.67 grams), ethylene glycol (70.03 grams), polyethylene glycol (average molecular weight=1450, 41.94 grams), sodium acetate (0.75 grams), manganese(II) acetate tetrahydrate (0.2339 grams), and antimony(III) trioxide (0.1883 grams). The reaction mixture was stirred and heated to 180° C. under a slow nitrogen purge. After achieving 180° C., the reaction mixture was heated to 200° C. over 0.3 hours with stirring under a slow nitrogen purge. The resulting reaction mixture was stirred at 200° C. under a slight nitrogen purge for 0.9 hours. The reaction mixture was then heated to 275° C. over 1.8 hours with stirring under a slight nitrogen purge. The resulting reaction mixture was stirred at 275° C. for 1.0 hour while under a slight nitrogen purge. 104.5 grams of a colorless distillate was collected over this heating cycle. The reaction mixture was then staged to full vacuum with stirring at 275° C. The resulting reaction mixture was stirred for 5.6 hours under full vacuum (pressure less than 100 mtorr). The vacuum was then released with nitrogen and the reaction mass allowed to cool to room temperature. An additional 74.8 grams of distillate was recovered and 454.0 grams of a solid product was recovered.

The sample was measured for laboratory relative viscosity (LRV) as described above and was found to have an LRV of 21.82. This sample was calculated to have an inherent viscosity of 0.64 dL/g.

The sample underwent differential scanning calorimetry (DSC) analysis. A broad crystalline melting temperature (Tm) was observed at 157.6° C. (0.3 J/g).

### PREPARATIVE EXAMPLE PE 34

To a 1.0 liter glass flask was added bis(2-hydroxyethyl)terephthalate (264.66 grams), dimethyl glutarate (114.99 grams), dimethyl 5-sulfoisophthalate, sodium salt (10.63 grams), tris(2-hydroxyethyl)trimellitate (1.06 grams), polyethylene glycol (average molecular weight=1450, 28.17 grams), sodium acetate (0.53 grams), manganese(II) acetate tetrahydrate (0.1637 grams), antimony(III) trioxide (0.1318 grams) and a 50 weight percent slurry of calcium carbonate in ethylene glycol (176.08 grams). The reaction mixture was stirred and heated to 180° C. under a slow nitrogen purge. After achieving 180° C., the reaction mixture was heated to 200° C. over 0.4 hours with stirring under a slow nitrogen purge. The resulting reaction mixture was stirred at 200° C. under a slight nitrogen purge for 0.9 hours. The reaction mixture was then heated to 275° C. over 0.8 hours with stirring under a slight nitrogen purge. The resulting reaction mixture was stirred at 275° C. for 1.1 hours while under a slight nitrogen purge. 105.6 grams of a colorless distillate was collected over this heating cycle. The reaction mixture was then staged to full vacuum with stirring at 275° C. The resulting reaction mixture was stirred for 1.5 hours under full vacuum (pressure less than 100 mtorr). The vacuum was then released with nitrogen and the reaction mass allowed to cool to room temperature. An additional 51.5 grams of distillate was recovered and 384.7 grams of a solid product was recovered.

The sample was measured for laboratory relative viscosity (LRV) as described above and was found to have an LRV of 27.73. This sample was calculated to have an inherent viscosity of 0.75 dL/g.

The sample underwent differential scanning calorimetry (DSC) analysis. Within the first heating cycle, a glass transition temperature (Tg) was found with an onset temperature of 42.8° C., a midpoint temperature of 45.7° C., and an endpoint temperature of 48.5° C. This Tg was not observed during the second heating cycle of the DSC experiment. Within the second heating cycle, a broad crystalline melting temperature (Tm) was observed at 151.8° C. (1.8 J/g).

This sample underwent biodegradation testing as described above. After 31 days of composting, 19.5 weight percent of the sample was found to have been biodegraded.

### PREPARATIVE EXAMPLE PE 35

To a 1.0 liter glass flask was added bis(2-hydroxyethyl)terephthalate (219.03 grams), dimethyl glutarate (143.74 grams), dimethyl 5-sulfoisophthalate, sodium salt (10.63 grams), tris(2-hydroxyethyl)trimellitate (1.06 grams), polyethylene glycol (average molecular weight=1450, 27.64 grams), sodium acetate (0.53 grams), manganese(II) acetate tetrahydrate (0.1637 grams), antimony(III) trioxide (0.1318 grams) and a 50 weight percent slurry of calcium carbonate in ethylene glycol (172.78 grams). The reaction mixture was stirred and heated to 180° C. under a slow nitrogen purge. After achieving 180° C., the reaction mixture was heated to 200° C. over 0.6 hours with stirring under a slow nitrogen purge. The resulting reaction mixture was stirred at 200° C. under a slight nitrogen purge for 1.0 hour. The reaction mixture was then heated to 275° C. over 0.8 hours with stirring under a slight nitrogen purge. The resulting reaction mixture was stirred at 275° C. for 1.4 hours while under a slight nitrogen purge. 90.1 grams of a colorless distillate was collected over this heating cycle. The reaction mixture was then staged to full vacuum with stirring at 275° C. The resulting reaction mixture was stirred for 1.9 hours under full vacuum (pressure less than 100 mtorr). The vacuum was then released with nitrogen and the reaction mass allowed to cool to room temperature. An additional 48.9 grams of distillate was recovered and 384.7 grams of a solid product was recovered.

The sample was measured for laboratory relative viscosity (LRV) as described above and was found to have an LRV of 37.71. This sample was calculated to have an inherent viscosity of 0.93 dL/g.

The sample underwent differential scanning calorimetry (DSC) analysis. Within the first heating cycle, a glass transition temperature (Tg) was found with an onset temperature of 46.6° C., a midpoint temperature of 48.7° C., and an endpoint temperature of 50.9° C. This Tg was not observed during the second heating cycle of the DSC experiment. Within the second heating cycle, a small crystalline melting temperature (Tm) was observed at 138.5° C. (0.1 J/g).

This sample underwent biodegradation testing as described above. After 31 days of composting, 28.3 weight percent of the sample was found to have been biodegraded.

### PREPARATIVE EXAMPLE PE 36

To a 250 milliliter glass flask was added dimethyl terephthalate (66.02 grams), DBE dibasic ester (20:60:20 mole percent dimethyl succinate:dimethyl glutarate:dimethyl adipate) (24.03 grams), dimethyl 5-sulfoisophthalate, sodium salt (2.96 grams), 1,3-propanediol (60.88 grams), poly(tetramethylene glycol) (average molecular weight of 2000) (5.00 grams), and titanium(IV) isopropoxide (0.058 grams). The reaction mixture was stirred and heated to 180° C. under a slow nitrogen purge. After achieving 180° C., the reaction mixture was heated to 190° C. over 0.5 hours with stirring under a slight nitrogen purge. The resulting reaction mixture was stirred at 190° C. for 1.0 hour with a slight nitrogen purge. The reaction mixture was then heated to 200° C. over 0.4 hours with stirring under a slow nitrogen purge. The resulting reaction mixture was stirred at 200° C. under a slight nitrogen purge for 1.0 hour. The reaction mixture was then heated to 255° C. over 1.9 hours with stirring under a slight nitrogen purge. The resulting reaction mixture was stirred at 255° C. for 0.4 hours while under a slight nitrogen purge. 28.5 grams of a colorless distillate was collected over this heating cycle. The reaction mixture was then staged to full vacuum with stirring at 255° C. The resulting reaction mixture was stirred for 2.8 hours under full vacuum (pressure less than 100 mtorr). The vacuum was then released with nitrogen and the reaction mass allowed to cool to room temperature. An additional 17.7 grams of distillate was recovered and 95.9 grams of a solid product was recovered.

The sample was measured for laboratory relative viscosity (LRV) as described above, and was found to have a LRV of 30.23. This sample was calculated to have an inherent viscosity (IV) of 0.79 dL/g.

The sample underwent differential scanning calorimetry (DSC) analysis. A crystalline melting temperature (Tm) was observed at 167.6° C. (29.9 J/g).

### PREPARATIVE EXAMPLE PE 37

To a 250 milliliter glass flask was added dimethyl terephthalate (47.58 grams), DBE dibasic ester (20:60:20 mole percent dimethyl succinate:dimethyl glutarate:dimethyl adipate) (40.04 grams), dimethyl 5-sulfoisophthalate, sodium salt (1.48 grams), 1,3-propanediol (60.88 grams), poly(tetramethylene glycol) (average molecular weight of 2000) (20.08 grams), kaolin (12.04 grams), and titanium(IV) isopropoxide (0.062 grams). The reaction mixture was stirred and heated to 180° C. under a slow nitrogen purge. After achieving 180° C., the reaction mixture was heated to 190° C. over 0.4 hours with stirring under a slight nitrogen purge. The resulting reaction mixture was stirred at 190° C. for 1.0 hour with a slight nitrogen purge. The reaction mixture was then heated to 200° C. over 0.4 hours with stirring under a slow nitrogen purge. The resulting reaction mixture was stirred at 200° C. under a slight nitrogen purge for 0.9 hours. The reaction mixture was then heated to 255° C. over 2.0 hours with stirring under a slight nitrogen purge. The resulting reaction mixture was stirred at 255° C. for 0.6 hours while under a slight nitrogen purge. 34.1 grams of a colorless distillate was collected over this heating cycle. The reaction mixture was then staged to full vacuum with stirring at 255° C. The resulting reaction mixture was stirred for 1.5 hours under full vacuum (pressure less than 100 mtorr). The vacuum was then released with nitrogen and the reaction mass allowed to cool to room temperature. An additional 1.4 grams of distillate was recovered and 85.5 grams of a solid product was recovered.

The sample was measured for laboratory relative viscosity (LRV) as described above, and was found to have a LRV of 3.99. This sample was calculated to have an inherent viscosity (IV) of 0.32 dL/g.

### PREPARATIVE EXAMPLE PE 38

To a 250 milliliter glass flask was added dimethyl terephthalate (66.70 grams), dimethyl adipate (25.61 grams), dimethyl 5-sulfoisophthalate, sodium salt (2.52 grams), 1,2,4,5-benzenetetracarboxylic dianhydride (pyromellitic dianhydride, PMDA) (0.22 grams), 1,4-butanediol (72.10 grams), poly(ethylene glycol) (average molecular weight of 1500) (15.00 grams), and titanium(IV) isopropoxide (0.062 grams). The reaction mixture was stirred and heated to 180° C. under a slow nitrogen purge. After achieving 180° C., the reaction mixture was heated to 190° C. over 0.4 hours with stirring under a slight nitrogen purge. The resulting reaction mixture was stirred at 190° C. for 1.0 hour with a slight nitrogen purge. The reaction mixture was then heated to 200° C. over 0.6 hours with stirring under a slow nitrogen purge. The resulting reaction mixture was stirred at 200° C. under a slight nitrogen purge for 1.0 hours. The reaction mixture was then heated to 255° C. over 1.6 hours with stirring under a slight nitrogen purge. The resulting reaction mixture was stirred at 255° C. for 0.9 hours while under a slight nitrogen purge. 44.0 grams of a colorless distillate was collected over this heating cycle. The reaction mixture was then staged to full vacuum with stirring at 255° C. The resulting reaction mixture was stirred for 2.0 hours under full vacuum (pressure less than 100 mtorr). The vacuum was then released with nitrogen and the reaction mass allowed to cool to room temperature. An additional 2.8 grams of distillate was recovered and 113.4 grams of a solid product was recovered.

The sample was measured for laboratory relative viscosity (LRV) as described above, and was found to have a LRV of 45.69. This sample was calculated to have an inherent viscosity (IV) of 1.07 dL/g.

The sample underwent differential scanning calorimetry (DSC) analysis. A crystalline melting temperature (Tm) was observed at 167.8° C. (20.9 J/g).

### PREPARATIVE EXAMPLE PE 39

To a 250 milliliter glass flask was added dimethyl terephthalate (66.02 grams), DBE dibasic ester (20:60:20 mole percent dimethyl succinate:dimethyl glutarate:dimethyl adipate) (24.03 grams), dimethyl 5-sulfoisophthalate, sodium salt (3.40 grams), 1,4-butanediol (72.10 grams), poly(tetramethylene glycol) (average molecular weight of 2000) (2.08 grams), and titanium(IV) isopropoxide (0.062 grams). The reaction mixture was stirred and heated to 180° C. under a slow nitrogen purge. After achieving 180° C., the reaction mixture was heated to 190° C. over 0.3 hours with stirring under a slight nitrogen purge. The resulting reaction mixture was stirred at 190° C. for 1.0 hour with a slight nitrogen purge. The reaction mixture was then heated to 200° C. over 0.4 hours with stirring under a slow nitrogen purge. The resulting reaction mixture was stirred at 200° C. under a slight nitrogen purge for 1.1 hours. The reaction mixture was then heated to 255° C. over 1.8 hours with stirring under a slight nitrogen purge. The resulting reaction mixture was stirred at 255° C. for 0.5 hours while under a slight nitrogen purge. 49.9 grams of a colorless distillate was collected over this heating cycle. The reaction mixture was then staged to full vacuum with stirring at 255° C. The resulting reaction mixture was stirred for 3.1 hours under full vacuum (pressure less than 100 mtorr). The vacuum was then released with nitrogen and the reaction mass allowed to cool to room temperature. An additional 0.4 grams of distillate was recovered and 99.9 grams of a solid product was recovered.

The sample was measured for laboratory relative viscosity (LRV) as described above, and was found to have a LRV of 9.50. This sample was calculated to have an inherent viscosity (IV) of 0.42 dL/g.

The sample underwent differential scanning calorimetry (DSC) analysis. A crystalline melting temperature (Tm) was observed at 171.9° C. (27.6 J/g).

### PREPARATIVE EXAMPLE PE 40

To a 250 milliliter glass flask was added dimethyl terephthalate (47.58 grams), DBE dibasic ester (20:60:20 mole percent dimethyl succinate:dimethyl glutarate:dimethyl adipate) (40.04 grams), dimethyl 5-sulfoisophthalate, sodium salt (1.48 grams), 1,4-butanediol (72.10 grams), poly(tetramethylene glycol) (average molecular weight of 2000) (20.08 grams), silica (12.04 grams), and titanium(IV) isopropoxide (0.062 grams). The reaction mixture was stirred and heated to 180° C. under a slow nitrogen purge. After achieving 180° C., the reaction mixture was heated to 190° C. over 0.3 hours with stirring under a slight nitrogen purge. The resulting reaction mixture was stirred at 190° C. for 1.0 hour with a slight nitrogen purge. The reaction mixture was then heated to 200° C. over 0.1 hours with stirring under a slow nitrogen purge. The resulting reaction mixture was stirred at 200° C. under a slight nitrogen purge for 1.1 hours. The reaction mixture was then heated to 255° C. over 0.6 hours with stirring under a slight nitrogen purge. The resulting reaction mixture was stirred at 255° C. for 0.5 hours while under a slight nitrogen purge. 37.9 grams of a colorless distillate was collected over this heating cycle. The reaction mixture was then staged to full vacuum with stirring at 255° C. The resulting reaction mixture was stirred for 3.6 hours under full vacuum (pressure less than 100 mtorr). The vacuum was then released with nitrogen and the reaction mass allowed to cool to room temperature. An additional 13.6 grams of distillate was recovered and 120.1 grams of a solid product was recovered.

The sample was measured for laboratory relative viscosity (LRV) as described above, and was found to have a LRV of 13.98. This sample was calculated to have an inherent viscosity (IV) of 0.50 dL/g.

The sample underwent differential scanning calorimetry (DSC) analysis. A crystalline melting temperature (Tm) was observed at 115.9° C. (12.1 J/g).

### COMPARATIVE EXAMPLE CE 1

Biomax® 6926, (a commercial product of the DuPont Company), was dried in a hopper dryer for 8 hours at 100 C to a −40 C dew point. The material was then fed at a rate of 20 pounds per hour into the feed section of a ½-inch diameter single screw Davis Standard extruder, (screw L/D of 24:1 model number DS-15H). The extruder conditions and temperature profile is noted below. The molten polymer was then fed into a Killion 3 roll stack sheet line with the conditions and temperature profile noted below.

Extruder Zone 1 temperature, (feed section): 410° F.

Extruder Zone 2 temperature: 445° F.

Extruder Zone 3 temperature: 445° F.

Extruder Zone 4 (front) temperature: 430° F.

Flange: 445° F.

Pipe: 445° F.

Flange: 445° F.

Die temperature: 430° F.

Die Lips: 430° F.

Melt Temperature: 447° F.

Extruder Amps: 3.4

Extruder RPM: 50

Chill Roll Top temperature: 70° F.

Chill Roll Middle temperature: 70° F.

Chill Roll Bottom temperature: 70° F. Film Take Off Speed: 275 inches/minute

A film 8 inches wide with a thickness of 0.003 inches, (3 mils), was produced. The as produced film was conditioned for 40 hours at 72 F and 50% humidity. The conditioned film was tested for Elmendorf Tear as per ASTM test method 1922 and found to have 14 g/mil in the machine direction, (MD), and 14 g/mil in the transverse direction, (TD). The conditioned film was tested for Graves Tear as per ASTM test method D1004, (crosshead tear rate of 0.5 inches/minute), and found to have 0.78 lbs/mil in the machine direction and 0.81 lbs/mil in the transverse direction. The conditioned film was tested for tensile modulus as per ASTM test method D882 and found to have 248,768 psi in the machine direction and 282,782 psi in the transverse direction. The conditioned films were tested for tensile strength at break as per ASTM test method D882, (crosshead rate 20 inches/minute), and found to have 3291 psi in the machine direction and 5634 psi in the transverse direction. The conditioned film was tested for percent elongation at break as per ASTM test method D882 and found to have 404 percent in the machine direction. Attempts to measure the percent elongation transverse direction were not possible due to breaks. The film was tested for moisture vapor transmission rates, (MVTR), at 32 C and 100 percent relative humidity, (RH), with the result of 7.3 grams/100 in²/day.

### EXAMPLE 1

Material produced similarly to as described above was dried in a hopper dryer for 8 hours at 100° C. to a −40° C. dew point. The material was a sulfonated aliphatic-aromatic polyetherester which comprised 95.6 mole percent ethylene glycol, 2.1 mole percent diethylene glycol, 2.3 mole percent poly(ethylene glycol) with an average molecular weight of 1000, 75.7 mole percent dimethyl terephthalate, 23.0 mole percent dimethyl glutarate, and 1.3 mole percent dimethyl 5-sulfoisophthalate, sodium salt. The material was then fed at a rate of 20 pounds per hour into the feed section of a 1½-inch diameter single screw Davis Standard extruder (screw L/D of 24:1, model number DS-15H). The extruder conditions and temperature profile is noted below. The molten polymer was then fed into a Killion 3 roll stack sheet line with the conditions and temperature profile noted below.

Extruder Zone 1 temperature, (feed section): 395° F.

Extruder Zone 2 temperature: 425° F.

Extruder Zone 3 temperature: 410° F.

Extruder Zone 4 (front) temperature: 410° F.

Flange: 410° F.

Pipe: 410° F.

Flange: 410° F.

Die temperature: 410° F.

Die Lips: 410° F.

Melt Temperature: 426° F.

Extruder Amps: 5°

Extruder RPM: 50°

Chill Roll Top temperature: 70° F.

Chill Roll Middle temperature: 70° F.

Chill Roll Bottom temperature: 70° F.

Film Take Off Speed: 235 inches/minute

A film 8 inches wide with a thickness of 0.003 inches, (3 mils), was produced. The as produced film was conditioned for 40 hours at 72° F. and 50% humidity. The conditioned film was tested for Elmendorf Tear as per ASTM test method 1922 and found to have 23 g/mil in the machine direction, (MD), and 23 g/mil in the transverse direction, (TD). The conditioned film was tested for Graves Tear as per ASTM test method D1004, (crosshead tear rate of 0.5 inches/minute), and found to have 0.62 lbs/mil in the machine direction and 0.64 lbs/mil in the transverse direction. The conditioned film was tested for tensile modulus as per ASTM test method D882 and found to have 61,119 psi in the machine direction and 66,230 psi in the transverse direction. The conditioned film was tested for tensile strength at break as per ASTM test method D882, (crosshead rate of 20 inches/minute), and found to have 4,278 psi in the machine direction and 4,326 psi in the transverse direction. The conditioned film was tested for percent elongation as per ASTM test method D882 and found to have 599 percent in the machine direction and 608 percent in the transverse direction. The film was tested for moisture vapor transmission rates, (MVTR), at 32 C and 100 percent relative humidity, (RH), with the result of 8.7 grams/100 in²/day.

The film was tested as a fast food sandwich wrap packaging and found to have excellent deadfold performance.

### EXAMPLE 2

A polymer prepared similarly to as described for Preparative Example PE 1, except at a larger scale, is dried in a hopper dryer for 8 hours at 100° C. to a −40° C. dew point. The material is then fed at a rate of 20 pounds per hour into the feed section of a 1½-inch diameter single screw Davis Standard extruder, (screw L/D of 24:1, model number DS-15H). The extruder conditions and temperature profile is noted below. The molten polymer is then fed into a Killion 3 roll stack sheet line with the conditions and temperature profile noted below.

Extruder Zone 1 temperature, (feed section): 410° F.

Extruder Zone 2 temperature: 445° F.

Extruder Zone 3 temperature: 445° F.

Extruder Zone 4 (front) temperature: 430° F.

Flange: 445° F.

Pipe: 445° F.

Flange: 445° F.

Die temperature: 430° F.

Die Lips: 430° F.

Melt Temperature: 447° F.

Extruder Amps: 3.4

Extruder RPM: 50

Chill Roll Top temperature: 70° F.

Chill Roll Middle temperature: 70° F.

Chill Roll Bottom temperature: 70° F.

Film Take Off Speed: 275 inches/minute

A film 8 inches wide with a thickness of 0.003 inches, (3 mils), was produced.

The film is tested as a fast food sandwich wrap packaging and found to have excellent deadfold performance.

### EXAMPLE 3

2 inch squares of this film produced above is preheated to 50° C. for 4 minutes, (being careful not to allow the hot air to impinge directly onto the film so as to avoid hot spots), and biaxially oriented on a tenter frame T. M. Long Biaxial stretcher. The draw ratio of the stretcher is set at 3 times 3 and the stretching rate is 5 inches per second (12.7 cm/second). The biaxially stretched film is found to have at least a 10 percent greater tensile strength in both the machine direction, (MD), and in the transverse direction, (TD), then found for the undrawn film. The biaxially stretched film is tested as a fast food sandwich wrap packaging and found to have excellent deadfold performance.

### EXAMPLES 4-37 AND COMPARATIVE EXAMPLES CE 2 AND CE 3

Polymers prepared similarly to as described above in Preparative Examples PE 2, except at a larger scale, are dried in a hopper dryer for 8 hours at 60° C. to a −40° C. dew point. The materials are placed in the hopper of a single screw volumetric feeder, (K-tron Model No. 7), from which they free fall to the inlet of a 28 mm Werner and Pfleider twin screw extruder with a vacuum port maintained at house vacuum attached to a 10 inch wide film die with about a 0.010 inch gap. A dry nitrogen purge is maintained in the feed hopper and the feed throat of the extruder. The extruder is operated at a 150 RPM screw speed with the heater profile noted within Table 1.

TABLE 1

| | | Extruder Heater Profile | | | | | | |
|---|---|---|---|---|---|---|---|---|
| Preparative | | Zone 1 | Zone 2 | Zone 3 | Zone 4 | Zone 5 | Die | Melt |
| Example | Example | (° C.) | (° C.) | (° C.) | (° C.) | (° C.) | (° C.) | (° C.) |
| CE 2 | CPE 1 | 205 | 225 | 235 | 235 | 235 | 240 | 235 |
| CE 3 | CPE 2 | 240 | 260 | 270 | 270 | 270 | 275 | 270 |
| 4 | PE 1 | 195 | 215 | 225 | 225 | 225 | 230 | 225 |
| 5 | PE 3 | 170 | 195 | 205 | 205 | 205 | 210 | 215 |
| 6 | PE 4 | 180 | 215 | 225 | 225 | 225 | 230 | 235 |
| 7 | PE 5 | 170 | 190 | 200 | 200 | 200 | 205 | 210 |
| 8 | PE 6 | 180 | 210 | 215 | 215 | 215 | 220 | 225 |
| 9 | PE 7 | 180 | 210 | 215 | 215 | 215 | 220 | 225 |
| 10 | PE 8 | 175 | 200 | 210 | 210 | 210 | 215 | 220 |
| 11 | PE 9 | 195 | 215 | 225 | 225 | 225 | 230 | 235 |
| 12 | PE 10 | 165 | 190 | 195 | 195 | 195 | 200 | 205 |
| 13 | PE 11 | 195 | 215 | 225 | 225 | 225 | 230 | 235 |
| 14 | PE 12 | 205 | 225 | 235 | 235 | 235 | 240 | 245 |
| 15 | PE 13 | 200 | 220 | 230 | 230 | 230 | 235 | 240 |
| 16 | PE 14 | 160 | 185 | 195 | 195 | 195 | 200 | 205 |
| 17 | PE 15 | 150 | 175 | 185 | 185 | 185 | 190 | 195 |
| | PE 16 | 190 | 215 | 225 | 225 | 225 | 230 | 235 |
| | PE 17 | 190 | 215 | 225 | 225 | 225 | 230 | 235 |
| | PE 18 | 190 | 215 | 225 | 225 | 225 | 230 | 235 |
| | PE 19 | 185 | 210 | 220 | 220 | 220 | 225 | 230 |
| | PE 20 | 185 | 210 | 220 | 220 | 220 | 225 | 230 |
| | PE 21 | 185 | 210 | 220 | 220 | 220 | 225 | 230 |
| | PE 22 | 175 | 200 | 210 | 210 | 210 | 215 | 220 |
| | PE 23 | 160 | 185 | 190 | 190 | 190 | 195 | 200 |
| | PE 24 | 165 | 190 | 205 | 205 | 205 | 210 | 215 |
| | PE 25 | 165 | 190 | 200 | 200 | 200 | 205 | 210 |
| | PE 26 | 160 | 185 | 190 | 190 | 190 | 195 | 200 |
| | PE 27 | 150 | 175 | 180 | 180 | 180 | 185 | 190 |
| 30 | PE 28 | 160 | 190 | 200 | 200 | 200 | 205 | 210 |
| 31 | PE 29 | 160 | 185 | 195 | 195 | 195 | 200 | 205 |
| 32 | PE 30 | 170 | 195 | 205 | 205 | 205 | 210 | 215 |
| 33 | PE 31 | 160 | 185 | 195 | 195 | 195 | 200 | 205 |
| 34 | PE 32 | 140 | 160 | 175 | 175 | 175 | 180 | 185 |
| 35 | PE 33 | 140 | 160 | 175 | 175 | 175 | 180 | 185 |
| 36 | PE 34 | 135 | 155 | 170 | 170 | 170 | 175 | 180 |
| 37 | PE 35 | 120 | 145 | 160 | 160 | 160 | 165 | 170 |

The extruded polymer films are electrostatically pinned on an 12 inch diameter smooth quench drum maintained at a temperature of 26° C. with cold water and collected on release paper using a standard tension roll. The quench drum speed is adjusted from 5 to 15 feet per minute to obtain film samples with a thickness of about 8 mils to about 1.5 mils. The films are tested as fast food sandwich wraps and are found to have excellent deadfold performance.

Pieces of the above films of Comparative Examples CE 2 and CE 3 and Example 4, (8-inch by 8-inch squares), are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The film of Example 4 is found to disinigrate at a rate at least 10 percent faster than is found for the film of Comparative Example CE 2 and CE 3.

### EXAMPLE 38

A polymer prepared similarly to as described in Preparative Example PE 36, except at a larger scale, is dried in a hopper dryer for 8 hours at 90 C to a −40° C. dew point. The material is placed in the hopper of a single screw volumetric feeder, (K-tron Model No. 7), from which it free falls to the inlet of a 28 mm Werner and Pfleider twin screw extruder with a vacuum port maintained at house vacuum attached to a 10 inch wide film die with about a 0.010 inch gap. A dry nitrogen purge is maintained in the feed hopper and the feed throat of the extruder. The extruder is operated at a 150 RPM screw speed with the following heater profile:

| Zone 1 | Zone 2 | Zone 3 | Zone 4 | Zone 5 | Die | Melt |
|---|---|---|---|---|---|---|
| (° C.) | (° C.) | (° C.) | (° C.) | (° C.) | (° C.) | (° C.) |
| 145 | 175 | 185 | 185 | 185 | 190 | 195 |

The extruded polymer film is electrostatically pinned on an 12 inch diameter smooth quench drum maintained at a temperature of 26 C with cold water and collected on release paper using a standard tension roll. The quench drum speed is adjusted from 5 to 15 feet per minute to obtain film samples with a thickness of about 8 mils to about 1.5 mils.

### COMPARATIVE EXAMPLE CE 4

A copolyester prepared substantially as disclosed within U.S. Pat. No. 6,258,924, Example 3, except at a larger scale, is dried in a hopper dryer for 8 hours at 60° C. to a −40° C. dew point. This copolyester is disclosed to consist of 80 mole percent 1,4-butanediol, 20 mole percent poly(ethylene glycol) with an average molecular weight of 1500, 68.7 mole percent of terephthalic acid, 29.4 mole percent adipic acid, 1.7 mole percent of sodium dimethyl 5-sulfoisophthalate, and 0.2 mole percent pyromellitic dianhydride. This polymer is further disclosed to have a crystalline melting point of 107.8° C. The material is then fed at a rate of 20 pounds per hour into the feed section of a 1½-inch diameter single screw Davis Standard extruder, (screw L/D of 24:1, model number DS-15H). The extruder conditions and temperature profile is noted below. The molten polymer is then fed into a Killion 3 roll stack sheet line with the conditions and temperature profile noted below.

Extruder Zone 1 temperature, (feed section): 275° F.

Extruder Zone 2 temperature: 310° F.

Extruder Zone 3 temperature: 310° F.

Extruder Zone 4 (front) temperature: 295° F.

Flange: 310° F.

Pipe: 310° F.

Flange: 310° F.

Die temperature: 295° F.

Die Lips: 295° F.

Melt Temperature: 310° F.

Extruder Amps: 3.4

Extruder RPM: 50

Chill Roll Top temperature: 70° F.

Chill Roll Middle temperature: 70° F.

Chill Roll Bottom temperature: 70° F.

Film Take Off Speed: 275 inches/minute

A film 8 inches wide with a thickness of 0.003 inches, (3 mils), is produced. A low yield is evidenced due to film sticking, (blocking), during the process and in the film form.

8 Inch by 16 inch rectangles are cut out of the film and the size accurately measured. The film rectangles are placed in a Fisher Scientific Isotemp Incubator, Model Number 625D, heated to 60 C for 1 hour. The film rectangles are then accurately remeasured.

### EXAMPLE 39

Material produced similarly to as described above for Preparative Example PE 38, except at a larger scale, is dried in a hopper dryer for 8 hours at 90° C. to a −40° C. dew point. The material is then fed at a rate of 20 pounds per hour into the feed section of a 1½-inch diameter single screw Davis Standard extruder, (screw L/D of 24:1, model number DS-15H). The extruder conditions and temperature profile is noted below. The molten polymer is then fed into a Killion 3 roll stack sheet line with the conditions and temperature profile noted below.

Extruder Zone 1 temperature, (feed section): 365° F.

Extruder Zone 2 temperature: 395° F.

Extruder Zone 3 temperature: 380° F.

Extruder Zone 4 (front) temperature: 380° F.

Flange: 380° F.

Pipe: 380° F.

Flange: 380° F.

Die temperature: 380° F.

Die Lips: 380° F.

Melt Temperature: 395° F.

Extruder Amps: 5

Extruder RPM: 50

Chill Roll Top temperature: 70° F.

Chill Roll Middle temperature: 70° F.

Chill Roll Bottom temperature: 70° F.

Film Take Off Speed: 235 inches/minute

A film 8 inches wide with a thickness of 0.003 inches, (3 mils), is produced. A high film yield is evidenced through this process. 8 Inch by 16 inch rectangles are cut out of the film and the size accurately measured. The film rectangles are placed in a Fisher Scientific Isotemp Incubator, Model Number 625D, heated to 60° C. for 1 hour. The film rectangles are then accurately remeasured. It is found that the film rectangles of Example 39 shrink at least 10 percent less than the film rectangles of Comparative Example CE 4.

The film is tested as a fast food sandwich wrap packaging and found to have excellent deadfold performance.

### EXAMPLE 40

A polymer prepared similarly to as described in Preparative Example PE 39, except at a larger scale, is dried in a hopper dryer for 8 hours at 100° C. to a −40° C. dew point. The material is placed in the hopper of a single screw volumetric feeder, (K-tron Model No. 7), from which it free falls to the inlet of a 28 mm Werner and Pfleider twin screw extruder with a vacuum port maintained at house vacuum attached to a 10 inch wide film die with about a 0.010 inch gap. A dry nitrogen purge is maintained in the feed hopper and the feed throat of the extruder. The extruder is operated at a 150 RPM screw speed with the following heater profile:

| Zone 1 | Zone 2 | Zone 3 | Zone 4 | Zone 5 | Die | Melt |
|---|---|---|---|---|---|---|
| (° C.) | (° C.) | (° C.) | (° C.) | (° C.) | (° C.) | (° C.) |
| 150 | 180 | 190 | 190 | 190 | 195 | 200 |

The extruded polymer film is electrostatically pinned on an 12 inch diameter smooth quench drum maintained at a temperature of 26° C. with cold water and collected on release paper using a standard tension roll. The quench drum speed is adjusted from 5 to 15 feet per minute to obtain film samples with a thickness of about 8 mils to about 1.5 mils.

### EXAMPLES 41-61

The films produced in the Examples listed below in Table 2, with a thickness of between about 1.5 mils to 8 mils, are sent through a Machine Direction Orienter (MDO) Model Number 7200 from the Marshall and Williams Company of Providence, Rhode Island. The MDO unit was preheated to the temperature listed in Table 2, below, and the film is stretched as noted below in Table 2 while at that temperature. For example, “Stretched 3X” means that a 1-meter long film would be stretched to a resultant length of 3 meters.

TABLE 2

| | | MDO | |
|---|---|---|---|
| | Cast Film | Temperature | MDO |
| Example | Example | (° C.) | Stretch |
| 41 | 4 | 50 | 3X |
| 42 | 5 | 50 | 3.5X |
| 43 | 6 | 60 | 3.5X |
| 44 | 7 | 50 | 4X |
| 45 | 8 | 80 | 3X |
| 46 | 9 | 60 | 3.5X |
| 47 | 10 | 50 | 4.5X |
| 48 | 21 | 60 | 4X |
| 49 | 22 | 60 | 4X |
| 50 | 24 | 50 | 4X |
| 51 | 25 | 70 | 3.5X |
| 52 | 26 | 40 | 4X |
| 53 | 27 | 50 | 3.5X |
| 54 | 28 | 70 | 3.5X |
| 55 | 29 | 70 | 3.5X |
| 56 | 34 | 50 | 3.5X |
| 57 | 35 | 40 | 4X |
| 58 | 36 | 40 | 4X |
| 59 | 37 | 40 | 4X |
| 60 | 38 | 40 | 3.5X |
| 61 | 40 | 40 | 3.5X |

The uniaxially stretched films are found to have at least a 10 percent greater tensile strength in the machine direction, (MD), then found for the corresponding undrawn films.

The uniaxially stretched films are tested as a fast food sandwich wrap packaging and found to have excellent deadfold performance.

### EXAMPLES 62-73

2 inch squares of the films produced above and detailed in Table 3 below are preheated to the temperature noted below in Table 3 for 4 minutes, (being careful not to allow the hot air to impinge directly onto the film so as to avoid hot spots), and biaxially oriented on a tenter frame T. M. Long Biaxial stretcher. The draw ratio of the stretcher is set at 3 times 3 and the stretching rate is 5 inches per second (12.7 cm/second).

TABLE 3

| Cast Film | Biaxial Stretch | Temperature |
|---|---|---|
| Example | Example | (° C.) |
| 62 | 11 | 75 |
| 63 | 12 | 50 |
| 64 | 18 | 60 |
| 65 | 22 | 70 |
| 66 | 24 | 60 |
| 67 | 26 | 50 |
| 68 | 29 | 80 |
| 69 | 34 | 60 |
| 70 | 35 | 50 |
| 71 | 37 | 40 |
| 72 | 38 | 50 |
| 73 | 40 | 50 |

The biaxially stretched films are found to have at least a 10 percent greater tensile strength in both the machine direction, (MD), and in the transverse direction, (TD), then found for the undrawn film. The biaxially stretched films are tested as a fast food sandwich wrap packaging and found to have excellent deadfold performance.

### EXAMPLES 74-78

A polymer prepared similarly to as described in Preparative Example PE 3, except at a larger scale, is dried in a hopper dryer for 8 hours at 100° C. to a −40° C. dew point. The material is powder blended with 0.10 weight percent, (based on polymer weight), Irganox-1010, a hindered phenolic anitoxidant from the Ciba Company. The material is placed in the hopper of a single screw volumetric feeder, (K-tron Model No. 7), from which it free falls to the inlet of a 28 mm Werner and Pfleider twin screw extruder with a vacuum port maintained at house vacuum attached to a 10 inch wide film die with about a 0.010 inch gap. A dry nitrogen purge is maintained in the feed hopper and the feed throat of the extruder. The extruder is operated at a 150 RPM screw speed with the following heater profile:

| Zone 1 | Zone 2 | Zone 3 | Zone 4 | Zone 5 | Die |
|---|---|---|---|---|---|
| (° C.) | (° C.) | (° C.) | (° C.) | (° C.) | (° C.) |
| 160 | 195 | 205 | 205 | 205 | 210 |

A plasticizer, acetyl tri-n-butyl citrate, from Morflex, Inc., is injected into zone 2 at a rate to provide the compositions listed below in Table 4 with an Accurate® feeder. The plasticizer level shown in Table 4 is based on the weight of the total composition.

TABLE 4

| | Plasticizer |
|---|---|
| | Level |
| Example | (wt. %) |
| 0 | |
| 75 | 5 |
| 76 | 10 |
| 77 | 15 |
| 78 | 20 |

The extruded polymer film is electrostatically pinned on an 12 inch diameter smooth quench drum maintained at a temperature of 26° C. with cold water and collected on release paper using a standard tension roll. The quench drum speed is adjusted from 5 to 15 feet per minute to obtain film samples with a thickness of about 8 mils to about 1.5 mils.

The films are tested as fast food sandwich wrap packaging and are found to have excellent deadfold performance.

### PREPARATIVE EXAMPLES PE 41-46

The polymer prepared similarly to that described for Preparative Example PE 33, above, except at a larger scale, is dried overnight in a large tray dryer at 60° C. with hot dry air recirculation to a moisture content of less than 0.04 percent. Corn starch, (Corn Products 3005 from CPC International, Inc.), and rice starch, (Sigma Chemicals catalog number S7260), are dried in a large tray vacuum oven at 90 C and less than 1 mm Hg vacuum to a moisture content of less than 1 percent and stored in sealed containers until used. Polyethylene adipate, (Rucoflex® S-101-55, nominal molecular weight of 2000, from the Ruco Polymer Corporation), is used directly as received without pretreatment.

Blends of the polymer and starch are made by manually tumbling the materials in plastic bags. The dry starch is added to the warm polymer from the dryer, and the still warm mixture fed to the extruder. When polyethylene adipate, (Rucoflex®), is used, the Rucoflex® is melted and liquid injected into the second heater zone of the extruder through a metering pump. The final compositions listed in Table 5, below are prepared.

TABLE 5

| Preparative | Polymer | Cornstarch | rice starch | Rucoflex ® |
|---|---|---|---|---|
| Example | (wt. %) | (wt. %) | (wt. %) | (wt. %) |
| PE 41 | 80 | 20 | | |
| PE 42 | 60 | 40 | | |
| PE 43 | 55 | 40 | | 5 |
| PE 44 | 45 | 35 | | 20 |
| PE 45 | 60 | | 40 | |
| PE 46 | 45 | 35 | | 20 |

The blends are placed in the feed hopper, (with a nitrogen purge), of a Ktron twin screw feeder, (Model Number T-35 with 190 6300 controller), and metered to a Werner and Pfleider ZSK 30 mm twin-screw extruder. This extruder has an L/D of 30/1 with a vacuum port and a mild mixing screw. The temperature of the extruder barrel is electrically heated from 140 C at the feed end of the extruder to 180° C. at the discharge. The extruder is operated at 150 RPM, and the vacuum port is connected to house vacuum and permitted to fluctuate with process conditions. A single hole die, (⅛-inch diameter), is used for discharge. The resulting strand is quenched in a 6-foot long water trough, dewatered with an air knife and cut into pellets with a Conair cutter, (Model number 304). Specific operating conditions for the individual compositions are listed below in

TABLE 6

| Preparative | Feed | Screw | Die | Melt | Vacuum |
|---|---|---|---|---|---|
| Example | Rate | Torque | Pressure | Temperature | (Inches |
| Number | (pph) | (% max.) | (psig) | (° C.) | Hg) |
| PE 41 | 34 | 58 | 800 | 190 | 13 |
| PE 42 | 32 | 60 | 800 | 210 | 13 |
| PE 43 | 31 | 50 | 750 | 205 | 12 |
| PE 44 | 32 | 35 | 600 | 185 | 12 |
| PE 45 | 33 | 60 | 800 | 210 | 13 |
| PE 46 | 32 | 35 | 600 | 185 | 13 |

### EXAMPLES 79-84

The polymer-starch blends prepared above in Preparative Examples PE 41-46 (see table 7) are dried in a hopper dryer for 8 hours at 100° C. to a −40° C. dew point. The materials are placed in the hopper of a single screw volumetric feeder, (K-tron Model No. 7), from which they free fall to the inlet of a 28 mm Werner and Pfleider twin screw extruder with a vacuum port maintained at house vacuum attached to a 10 inch wide film die with about a 0.010 inch gap. A dry nitrogen purge is maintained in the feed hopper and the feed throat of the extruder. The extruder is operated at a 150 RPM screw speed with the following heater profile:

| Zone 1 | Zone 2 | Zone 3 | Zone 4 | Zone 5 | Die | Melt |
|---|---|---|---|---|---|---|
| (° C.) | (° C.) | (° C.) | (° C.) | (° C.) | (° C.) | (° C.) |
| 145 | 170 | 190 | 190 | 190 | 195 | 200 |

The extruded polymer films are electrostatically pinned on an 12 inch diameter smooth quench drum maintained at a temperature of 26° C. with cold water and collected on release paper using a standard tension roll. The quench drum speed is adjusted from 5 to 15 feet per minute to obtain film samples with a thickness of about 8 mils to about 1.5 mils.

TABLE 7

| Preparative | |
|---|---|
| Example | Example |
| 79 | PE 41 |
| 80 | PE 42 |
| 81 | PE 43 |
| 82 | PE 44 |
| 83 | PE 45 |
| 84 | PE 46 |

The films are tested as fast food sandwich packaging and found to have excellent deadfold performance.

### PREPARATIVE EXAMPLES PE 47-53

The polymer prepared similarly to that described for Preparative Example PE 24, above, except at a larger scale, is dried overnight in a large tray dryer at 60° C. with hot dry air recirculation to a moisture content of less than 0.04 percent. Talc, (from Luzenac, located in Englewood, Colo., having a particle size of 3.8 microns), titanium dioxide, (supplied by Kerr-McGee Chemical, LLC, located in Oklahoma City, Okla., grade Tronox® 470, having a particle size of 0.17 micron), and calcium carbonate, (from ECCA Calcium Products, Inc., of Sylacauga, Ala., ECC Supercoat(T) grade with a 1 micron average particle size), are dried in a large tray vacuum oven at 90° C. and less than 1 mm Hg vacuum to a moisture content of less than 1 percent and stored in sealed containers until used.

Blends of the polymer and the inorganic fillers are made by manually tumbling the materials in plastic bags. The dry inorganic fillers are added to the warm polymer from the dryer, and the still warm mixture fed to the extruder. The final compositions listed in Table 8, below, are prepared.

TABLE 8

| | | | Titanium | Calcium |
|---|---|---|---|---|
| Preparative | Polymer | Talc | dioxide | carbonate |
| Example | (wt. %) | (wt. %) | (wt. %) | (wt. %) |
| PE 47 | 85 | 2.5 | 5 | 7.5 |
| PE 48 | 70 | 5 | 5 | 20 |
| PE 49 | 70 | 5 | 10 | 15 |
| PE 50 | 30 | 10 | 15 | 45 |
| PE 51 | 95 | 5 | | |
| PE 52 | 95 | | 5 | |
| PE 53 | 70 | | | 30 |

The blends are placed in the feed hopper, (with a nitrogen purge), of a Ktron twin screw feeder, (Model Number T-35 with 190 6300 controller), and metered to a Werner and Pfleider ZSK 30 mm twin-screw extruder. This extruder has an L/D of 30/1 with a vacuum port and a hard mixing screw. The temperature of the extruder barrel is electrically heated from 170° C. at the feed end of the extruder to 215° C. at the discharge. The extruder is operated at 150 RPM, and the vacuum port is connected to house vacuum and permitted to fluctuate with process conditions. A single hole die, (⅛-inch diameter), is used for discharge. The resulting strand is quenched in a 6-foot long water trough, dewatered with an air knife and cut into pellets with a Conair cutter, (Model number 304). Specific operating conditions for the individual compositions are listed below in Table 9.

| Preparative | Feed | Screw | Die | Melt | Vacuum |
|---|---|---|---|---|---|
| Example | Rate | Torque | Pressure | Temperature | (Inches |
| Number | (pph) | (% max.) | (psig) | (° C.) | Hg) |
| 47 | 34 | 58 | 800 | 210 | 13 |
| 48 | 30 | 70 | 800 | 230 | 13 |
| 49 | 31 | 70 | 800 | 230 | 12 |
| 50 | 32 | 80 | 800 | 240 | 12 |
| 51 | 33 | 50 | 600 | 210 | 13 |
| 52 | 32 | 50 | 600 | 210 | 13 |
| 53 | 30 | 70 | 800 | 230 | 12 |

### EXAMPLES 85-90

The polymer-inorganic filler blends prepared above in Preparative Examples 47-53 and a polymer prepared similarly to that described for Preparative Example 24, above, except at a larger scale, are dried in a hopper dryer for 8 hours at 100° C. to a −40° C. dew point. The materials are placed in the hopper of a single screw volumetric feeder, (K-tron Model No. 7), from which they free fall to the inlet of a 28 mm Werner and Pfleider twin screw extruder with a vacuum port maintained at house vacuum attached to a 10 inch wide film die with about a 0.010 inch gap. Example 88 is composed of a tumbled blend of 50 weight percent of Preparative Example PE 24 and 50 weight percent of Preparative Example PE 50. A dry nitrogen purge is maintained in the feed hopper and the feed throat of the extruder. The extruder is operated at a 150 RPM screw speed with the following heater profile:

| Zone 1 | Zone 2 | Zone 3 | Zone 4 | Zone 5 | Die | Melt |
|---|---|---|---|---|---|---|
| (° C.) | (° C.) | (° C.) | (° C.) | (° C.) | (° C.) | (° C.) |
| 170 | 195 | 210 | 210 | 210 | 215 | 220 |

The extruded polymer films are electrostatically pinned on an 12 inch diameter smooth quench drum maintained at a temperature of 26° C. with cold water and collected on release paper using a standard tension roll. The quench drum speed is adjusted from 5 to 15 feet per minute to obtain film samples with a thickness of about 8 mils to about 1.5 mils.

TABLE 10

| Preparative | |
|---|---|
| Example | Example |
| 85 | PE 47 |
| 86 | PE 48 |
| 87 | PE 49 |
| 88 | 50 wt. % polymer from Prep. Example PE 50, 50 wt. % |
| | polymer from Prep. Example PE 24 |
| 89 | PE 51 |
| 90 | PE 52 |

The films are tested as fast food sandwich packaging and found to have excellent deadfold performance. The films further are found to resemble paper, both in feel and appearance.

### EXAMPLES 91-96

The polymers prepared similarly as described for the Preparative Examples noted below in Table 11, except at a larger scale, are dried overnight at 60° C. in a dehumidified air dryer. The dried polymers are fed to a laboratory scale blown film line that consisted of a Killion 1.25 inch diameter extruder with a 15:1 gear reducer. The extruder heater zones are set around the temperature noted below in Table 11. The screw is a Maddock mixing type with an L/D of 24 to 1. The compression ratio for the mixing screw is 3.5:1. The screw speed is 25 to 30 RPM. A 1.21 inch diameter die with a 25-mil die gap is used. The air ring is a Killion single-lip, No. 2 type. Blowing conditions can be characterized by the blow up ratio, (BUR), which is the ratio of the bubble diameter to die the die diameter and which gives an indication of hoop or transverse direction, (TD), stretch, or the draw-down ratio, (DDR), which is an indication of the axial or machined direction, (MD), stretch. The greater the level of stretch, the greater the level of orientation in the film.

TABLE 11

| Preparative | Extruder | Heater | Film | | |
|---|---|---|---|---|---|
| Example | Example | Zones | Thickness | | |
| Number | Number | (° C.) | (mils) | BUR | DDR |
| 91 | PE 3 | 220 | 2.5 | 3.2 | 3.9 |
| 92 | PE 24 | 220 | 2.0 | 2.6 | 4.6 |
| 93 | PE 33 | 180 | 1.2 | 3.1 | 8.0 |
| 94 | PE 36 | 190 | 2.0 | 2.5 | 5.0 |
| 95 | PE 40 | 135 | 1.5 | 3.0 | 7.0 |
| 96 | PE 49 | 220 | 2.3 | 2.0 | 2.0 |

The tubular films are slit and tested as fast food sandwich packaging and found to have excellent deadfold performance.

### EXAMPLES 97-99

Bilayer films are produced on a 10 inch, two layer, Streamlined Coextrusion Die, (SCD), blown film die manufactured by Brampton Engineering. Layer configuration of the die is as follows from outside to inside layers of the die, A/B. Two 3½ inch David Standard extruders fed the A and B layers. The process line further utilizes a Brampton Engineering rotating air ring for polymer cooling. Layer A contains a polymer prepared similarly to that described for Preparative Example PE 5, except at a larger scale. Layer B contains a polymer prepared similarly to that described for Preparative Example PE 33, except at a larger scale. Both polymers are dried in a dehumidified dryer at 60° C. The operation was tailored to provide the layer ratios for the films noted below in Table 12 as of the total film structure. The thickness of the film is about 2.25 mil (0.00225 inch). The processing conditions for the film are provided in Table 13, below.

TABLE 12

| | Layer A | Layer B |
|---|---|---|
| Example | (wt. %) | (wt. %) |
| 97 | 25 | 75 |
| 98 | 50 | 50 |
| 99 | 75 | 25 |

TABLE 13

| | Extruder A | Extruder B |
|---|---|---|
| Zone 1 | 165° C. | 145° C. |
| Zone 2 | 190° C. | 165° C. |
| Zone 3 | 205° C. | 180° C. |
| Zone 4 | 205° C. | 180° C. |
| Zone 5 | 210° C. | 185° C. |
| Screen Changer | 205° C. | 180° C. |
| Adapter 1 | 205° C. | 180° C. |
| Adapter 2 | 205° C. | 180° C. |
| Adapter 4 | 205° C. | 180° C. |
| Die 1 | 205° C. | 205° C. |
| Die 2 | 205° C. | 205° C. |
| Die 3 | 205° C. | 205° C. |
| Line Speed | 122 feet per minute | |
| Notes | PE 5 | PE 33 |

The multilayer films prepared above are converted into bags using an inline bag machine manufactured by Battenfeld Gloucester Engineering Co., Inc. downstream of the extrusion line nips.

The slit films are tested as fast food sandwich wraps and are found to have excellent deadfold performance.

### EXAMPLES 100-102

Bilayer films are produced on a 10 inch, two layer, Streamlined Coextrusion Die, (SCD), blown film die manufactured by Brampton Engineering. Layer configuration of the die is as follows from outside to inside layers of the die, A/B. Two 3½ inch David Standard extruders fed the A and B layers. The process line further utilizes a Brampton Engineering rotating air ring for polymer cooling. Layer A contains a polymer prepared similarly to that described for Preparative Example PE 23, except at a larger scale. Layer B contains a polymer prepared similarly to that described for Preparative Example PE 35, except at a larger scale. Both polymers are dried in a dehumidified dryer at 60° C. The operation was tailored to provide the layer ratios for the films noted below in Table 14 as of the total film structure. The thickness of the film is about 2.25 mil (0.00225 inch). The processing conditions for the film are provided in Table 15, below.

TABLE 14

| | Layer A | Layer B |
|---|---|---|
| Example | (wt. %) | (wt. %) |
| 100 | 25 | 75 |
| 101 | 50 | 50 |
| 102 | 75 | 25 |

TABLE 15

| | Extruder A | Extruder B |
|---|---|---|
| Zone 1 | 165° C. | 135° C. |
| Zone 2 | 190° C. | 145° C. |
| Zone 3 | 205° C. | 160° C. |
| Zone 4 | 205° C. | 160° C. |
| Zone 5 | 210° C. | 165° C. |
| Screen Changer | 205° C. | 160° C. |
| Adapter 1 | 205° C. | 160° C. |
| Adapter 2 | 205° C. | 160° C. |
| Adapter 4 | 205° C. | 160° C. |
| Die 1 | 205° C. | 205° C. |
| Die 2 | 205° C. | 205° C. |
| Die 3 | 205° C. | 205° C. |
| Line Speed | 122 feet per minute | |
| Notes | PE 23 | PE 35 |

The multilayer films prepared above are converted into bags using an inline bag machine manufactured by Battenfeld Gloucester Engineering Co., Inc. downstream of the extrusion line nips.

The slit films are tested as fast food sandwich wraps and are found to have excellent deadfold performance.

### EXAMPLES 103-105

Bilayer films are produced on a 10 inch, two layer, Streamlined Coextrusion Die, (SCD), blown film die manufactured by Brampton Engineering. Layer configuration of the die is as follows from outside to inside layers of the die, A/B. Two 3½ inch David Standard extruders fed the A and B layers. The process line further utilizes a Brampton Engineering rotating air ring for polymer cooling. Layer A contains a starch-filled polymer prepared similarly to that described for Preparative Example PE 42. Layer B contains Eastar® Bio, from the Eastman Chemical Company and as described above. Both polymers are dried in a dehumidified dryer at 60° C. The operation was tailored to provide the layer ratios for the films noted below in Table 16 as of the total film structure. The thickness of the film is about 2.25 mil (0.00225 inch). The processing conditions for the film are provided in Table 17, below.

TABLE 16

| | Layer A | Layer B |
|---|---|---|
| Example | (wt. %) | (wt. %) |
| 103 | 25 | 75 |
| 104 | 50 | 50 |
| 105 | 75 | 25 |

TABLE 17

| | Extruder A | Extruder B |
|---|---|---|
| Zone 1 | 155° C. | 100° C. |
| Zone 2 | 190° C. | 115° C. |
| Zone 3 | 205° C. | 130° C. |
| Zone 4 | 205° C. | 130° C. |
| Zone 5 | 210° C. | 135° C. |
| Screen Changer | 205° C. | 130° C. |
| Adapter 1 | 205° C. | 130° C. |
| Adapter 2 | 205° C. | 130° C. |
| Adapter 4 | 205° C. | 130° C. |
| Die 1 | 205° C. | 205° C. |
| Die 2 | 205° C. | 205° C. |
| Die 3 | 205° C. | 205° C. |

| | |
|---|---|
| Line Speed | 122 feet per minute |

| | | |
|---|---|---|
| Notes | PE 42 | Eastar ® Bio |

The multilayer films prepared above are converted into bags using an inline bag machine manufactured by Battenfeld Gloucester Engineering Co., Inc. downstream of the extrusion line nips.

The slit films are tested as fast food sandwich wraps and are found to have excellent deadfold performance.

### EXAMPLES 106-144 AND COMPARATIVE EXAMPLES CE 5 AND CE 6

The polyester resins prepared similarly to that described in the Preparative Examples listed below in Table 18, except at a larger scale, are dried in a desiccant air dryer with a dew point of −40° C. overnight at a temperature of 60° C. The polyester resins are extrusion coated onto paperboard stock by feeding the dried pellets into a 2.5-inch commercial extruder having a barrel length to diameter ratio of 28:1. The five zones of the extruder are maintained at a temperature in the range noted below within Table 18. A single flight screw having eight compression flights, four metering flights, a two flight mixing section and six metering flights is used in the extruder. The screw speed is maintained at 180 revolutions per minute, (RPM). The molten polyester resins are passed through three 24×24 mesh screens. The polymers are passed through a center fed die with 0.75-inch lands having a die opening of 36 inches by 0.02 inches. The extrusion feed rate is held constant at 460 pounds per hour. The resulting extrudates are passed through a 5-inch air gap into the nip formed by a rubber-covered pressure roll and a chill roll. At the same time the paperboard stock noted below in Table 18, that is 32 inches wide, is fed into the nip with the roll in contact with the film. A nip pressure of 100 pounds per linear inch is applied. A 24-inch diameter mirror finished chill roll is maintained at a temperature of 19 C during the extrusion trials. The coated paperboard is taken off the chill roll at a point 180° from the nip formed by the pressure roll and the chill roll. The chill roll is operated at linear speeds of 300 feet per minute. At this coating speed, a polyester resin thickness of 1.25 mils is obtained. The polyester resin thickness may be varied through operational modifications.

TABLE 18

| Pre- | | | |
|---|---|---|---|
| par- | Ex- | Tem- | |
| ative | truder | per- | |
| Exam- | Exam- | ature | Paper/Paperboard |
| ple | ple | (° C.) | Stock |
| CE 5 | CPE 1 | 250 | Parchment |
| CE 6 | CPE 2 | 280 | Parchment |
| 106 | PE 1 | 240 | Parchment |
| 107 | PE 6 | 235 | 15 pound basis weight kraft paper |
| 108 | PE 9 | 250 | 18 pound basis weight natural paper |
| 109 | PE 17 | 250 | 18 pound basis weight bleached paper |
| 110 | PE 20 | 245 | 5 pound basis weight bleached kraft paper |
| 111 | PE 22 | 240 | 35 pound basis weight natural kraft paper |
| 112 | PE 24 | 230 | Parchment |
| 113 | PE 27 | 210 | 15 pound basis weight kraft paper |
| 114 | PE 30 | 230 | 18 pound basis weight bleached paper |
| 115 | PE 33 | 200 | 18 pound basis weight natural paper |
| 116 | PE 36 | 210 | 25 pound weight basis bleached kraft paper |
| 117 | PE 39 | 210 | 35 pound basis weight natural kraft paper |
| 118 | PE 42 | 230 | Parchment |
| 119 | PE 47 | 230 | 18 pound basis weight natural paper |
| 120 | PE 3 | 230 | Trilayered cup paperboard (210 g/m2 weight) |
| 121 | PE 7 | 240 | Trilayered cup paperboard (210 g/m2 weight) |
| 122 | PE 10 | 210 | Trilayered cup paperboard (210 g/m2 weight) |
| 123 | PE 18 | 250 | Trilayered cup paperboard (210 g/m2 weight) |
| 124 | PE 23 | 220 | Trilayered cup paperboard (210 g/m2 weight) |
| 125 | PE 25 | 225 | Trilayered cup paperboard (210 g/m2 weight) |
| 126 | PE 28 | 220 | Trilayered cup paperboard (210 g/m2 weight) |
| 127 | PE 31 | 220 | Trilayered cup paperboard (210 g/m2 weight) |
| 128 | PE 34 | 190 | Trilayered cup paperboard (210 g/m2 weight) |
| 129 | PE 37 | 160 | Trilayered cup paperboard (210 g/m2 weight) |
| 130 | PE 40 | 155 | Trilayered cup paperboard (210 g/m2 weight) |
| 131 | PE 44 | 210 | Trilayered cup paperboard (210 g/m2 weight) |
| 132 | PE 48 | 250 | Trilayered cup paperboard (210 g/m2 weight) |
| 133 | PE 5 | 230 | 18 point paperboard |
| 134 | PE 11 | 250 | 12 point paperboard |
| 135 | PE 16 | 250 | 18 point paperboard |
| 136 | PE 19 | 245 | 12 point paperboard |
| 137 | PE 22 | 250 | 18 point paperboard |
| 138 | PE 26 | 220 | 12 point paperboard |
| 139 | PE 29 | 220 | 18 point paperboard |
| 140 | PE 32 | 195 | 12 point paperboard |
| 141 | PE 35 | 180 | 18 point paperboard |
| 142 | PE 38 | 210 | 12 point paperboard |
| 143 | PE 46 | 210 | 18 point paperboard |
| 144 | PE 49 | 250 | 12 point paperboard |

Examples 106-119 are tested as fast food sandwich wrap packaging and are found to have excellent deadfold performance.

Examples 106-119 are formed and heat sealed by conventional processes into the shape of envelopes, bags, including for, for example, waste, trash, leaf, air-sickness, and groceries, and the like.

Examples 120-132 are formed by conventional processes into the shape of cups, glasses, bowls, trays, liquid containers and cartons, including for, for example, milk, juice, water, wine, yogurt, cream, and soda, and the like.

Examples 133-144 are formed by conventional processes into the shape of trays, boxes, lidded sandwich containers, lidded salad containers, hinged lid sandwich containers, hinged lid salad containers, and the like.

Pieces of the above laminates of Comparative Examples CE 5 and CE 6 and Example 106, (8-inch by 8-inch squares), are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The laminate of Example 106 is found to disintegrate at a rate at least 10 percent faster than is found for the laminates of Comparative Example CE 5 and CE 6.

### EXAMPLE 145

Extrusion-coated paper laminates are prepared as described below. A resin produced similarly as described above in Preparative Example PE 37, above, except at a larger scale, is dried at 60° C. overnight. The resin is then placed in a hopper above the inlet of a 1 inch, (2.5 cm), extruder, (Echlin Manufacturing Company Serial Number 0717), with an 18 inch wide film die with a 0.007 inch gap. An 18 inch wide nonwoven fabric is led continuously at a speed of 47-106 feet/minute through an extrusion coating machine made by Bertek Inc., of St. Albans, Vt. The paper to be coated, (11 inch wide, 18 pound paperstock), is fed over this support fabric, and the assembly is led through a corona treatment, (made by Intercon), through an S-warp between tow 4 inch diameter rolls, heated to 150-260° F., onto a polytetrafluoroethylene-coated, matte-finished chill roll with a diameter of 12 inches, (30 cm.), at 100-200° F., around 300 degrees of the circumference of this 12 inch diameter roll, while the resin is extruded through the die at a delivery rate found appropriate to yield a coating of the desired thickness, at a position between the chill and nip rolls as close as possible to the chill roll, (about 0.25-0.50 inches). The polymer temperature in the extruder is 315° F. and the polymer temperature in the die is 320° F. The polymer temperature may be adjusted to minimize flow irregularity. A film with 0.5-mil thickness is applied to the paper.

The paper laminate is tested as a fast food sandwich wrap packaging and found to have excellent deadfold performance.

Pieces of the above laminates, (8-inch by 8-inch squares), are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The laminates of the present invention are found to rapidly disintegrate.

### EXAMPLE 146

Extrusion-coated paper laminates are prepared as described below. A resin produced similarly as described above in Preparative Example PE 40, above, except at a larger scale, is dried at 60° C. overnight. The resin is then placed in a hopper above the inlet of a 1 inch, (2.5 cm), extruder, (Echlin Manufacturing Company Serial Number 0717), with an 18 inch wide film die with a 0.007 inch gap. An 18 inch wide nonwoven fabric is led continuously at a speed of 47-106 feet/minute through an extrusion coating machine made by Bertek Inc., of St. Albans, Vt. The paper to be coated, (11 inch wide, 18 pound basis weight bleached Kraft paperstock), is fed over this support fabric, and the assembly is led through a corona treatment, (made by Intercon), through an S-warp between tow 4 inch diameter rolls, heated to 150-260° F., onto a polytetrafluoroethylene-coated, matte-finished chill roll with a diameter of 12 inches, (30 cm.), at 100-200° F., around 300 degrees of the circumference of this 12 inch diameter roll, while the resin is extruded through the die at a delivery rate found appropriate to yield a coating of the desired thickness, at a position between the chill and nip rolls as close as possible to the chill roll, (about 0.25-0.50 inches). The polymer temperature in the extruder is 315° F. and the polymer temperature in the die is 320° F. The polymer temperature may be adjusted to minimize flow irregularity. A film with 0.5-mil thickness is applied to the paper.

The paper laminate is tested as a fast food sandwich wrap packaging and found to have excellent deadfold performance.

Pieces of the above laminates, (8-inch by 8-inch squares), are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The laminates of the present invention are found to rapidly disintegrate.

### EXAMPLE 147

A polymer prepared similarly to as described in Preparative Example 33, except at a larger scale, and poly(lactide), (from the Cargill Dow Company), are dried in a hopper dryer overnight at 60° C. to a −40° C. dew point. On a trilayered paperboard that weighed 210 grams/meter2 with a forward speed of 150 meters/minute is coextruded said Preparative Example 33 polymer and poly(lactide) in a weight ratio of 1:3. The melt temperature of the Preparative Example 33 polymer is 210° C. and the melt temperature of the poly(lactide) is 240 C. A coated paperboard is obtained where the total weight of the polymeric coating is 19.4 grams/meter² in a weight ratio of 75 weight percent of the poly(lactide), which formed the outer layer, and 25 weight percent of the polymer from Preparative Example 33, which formed the inner layer adhered to the paperboard.

The paperboard prepared above is formed by conventional processes into the shape of cups, glasses, bowls, trays, liquid containers and cartons, including for, for example, milk, juice, water, wine, yogurt, cream, and soda, and the like.

### EXAMPLES 148-153

Calendered paper laminates are prepared by making an assembly of the film produced as described above in Examples noted below in Table 19, coated onto release paper, in contact with a similar sized sheet of paper to be coated, and then pressing this assembly through the nip between a heated polished metal top roll and an unheated resilient (silk) roll at a surface speed of 5 yards/minute, at a temperature of 200° F. and under a pressure of 10 tons.

Details of the various paper substrates of the laminated paper products of the present invention are given in Table 19, below.

TABLE 19

| Film | Paper | | |
|---|---|---|---|
| Exam- | Exam- | | Paper Basis Wt./Thickness |
| ple | ple | Substrate | (oz/yd.sup.2/mils) |
| 148 | 4 | Towel, (Scott, Viva) | 1.2/6 |
| 149 | 8 | Towel, (G. P., Sparkle) | 1.3/10 |
| 150 | 25 | Toilet Tissue, (Charmin) | 0.9/6 |
| 151 | 30 | Wrapping Tissue, (white) | 0.5/2 |
| 152 | 35 | Newsprint | 1.5/4 |
| 153 | 83 | Kraft, (recycled) | 2.8/6 |

Pieces of the above laminates, (8-inch by 8-inch squares), are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The laminates of the present invention are found to rapidly disintegrate.

### EXAMPLE 154

A laminated stock is produced from a combination of a paperboard and a corona-treated polyester film using a combination of two water-based acrylic adhesive formulations. The paperboard base stock is a bleached white paperboard of the type typically referred to as a solid bleached sulfate (SBS) paperboard, which is well known as a base stock for food packaging materials. The particular paperboard used here is uncoated milk carton stock with a thickness of 0.0235 inch and weighing 282 pounds per 3,000 square feet. The film is produced as described in Example 24, above, and is corona discharge treated by conventional techniques on one side to enhance adhesive bonding. The lamination process is run on a conventional wet-bond laminating machine with adhesive stations for applying adhesive to both the paperboard and to the film. Adhesive is applied to the paperboard with a 110-line gravure roll applicator delivering about 3 pounds of wet adhesive per 1,000 square feet of paperboard. The adhesive applied to the paperboard consists of 200 pounds of Rhoplex® N-1 031 acrylic latex from the Rohm & Haas Company and 1.5 ounces of Foamaster NXZ defoamer (predispersed in an equal volume of water) from the Diamond Shamrock Chemical Company. Adhesive is applied to the corona-treated side of the polyester film. The adhesive applied consists of 375 pounds of Rhoplex® N-1 031 acrylic latex from the Rohm & Haas Company, 11.5 pounds of Cymele 325 melamine-formaldehyde crosslinking agent, 11.5 pounds of isopropyl alcohol, 23 pounds of water, and 3 ounces of Foamaster NXZ defoamer (predispersed in an equal volume of water) from the Diamond Shamrock Chemicals Company.

The laminating process is run with the paperboard and the film running simultaneously through the respective adhesive application stations, and then the paperboard and the film are both directed into a laminating nip where the two adhesive-coated surfaces are joined with the adhesive still moist on both surfaces. The laminating machine is run at a rate of 300 to 350 feet per minute. The laminated stock is run the laminating nip into a hot air oven with an air temperature of 400° F. Residence time for the laminated stock in the oven is about 5 seconds. The laminated stock is then run over a chill roll and rewound into a finished roll.

The laminated stock prepared above is formed by conventional processes into the shape of cups, glasses, bowls, trays, liquid containers and cartons, including for, for example, milk, juice, water, wine, yogurt, cream, and soda, and the like.

### EXAMPLES 155-188 AND COMPARATIVE EXAMPLES CE 7 AND CE 8

These examples demonstrate the lamination of the films of the present invention onto preformed substrates. The operation is conducted in a Lab Form Inc. forming machine with a 10 by 10-inch platen. The preformed substrate is shuttled onto the platen. The film is unrolled, preheated for the time noted below in Table 20 by “Black Box Heating” with infrared type heaters. The preheated film is then positioned over the preformed substrate and pulled down onto the preformed substrate. Examples 155-165 and Comparative Examples CE 7 and CE 8 utilize vacuum lamination by drawing a vacuum through the preformed substrate, which, in turn, draws the film onto the contours of the preformed substrate. Examples 166-177 utilize plug assisted vacuum lamination whereby, in addition to the above described vacuum, a plug helps to push the preheated film from the side opposite the preformed substrate to help reduce film thinning into deep draw preformed substrates. Examples 178-188 utilize pressure lamination by applying an air pressure to the preheated film side opposite to the preformed substrate, which forces the film onto the contours of the preformed substrate. The lamination process typically takes from 5 to 100 seconds, at which time excess film is trimmed off the laminated substrate and the laminated substrate is ejected and cooled.

The preformed substrates used within these examples of the present invention are as follows. A 9-inch molded “pulp plate”, prepared by conventional processes. A formed frozen dinner paperboard “tray”, prepared by conventional processes. A formed paperboard coffee “cup”, 3.5 inches tall, prepared by conventional processes. A formed paperboard “bowl”, 3 inches tall and 4 inches in diameter, prepared by conventional processes. A 9-inch “foam plate”, obtained by carefully stripping off the barrier film from commercially available plates obtained from the EarthShell Company, (Stock Number PL9V00001). A 12-ounce “foam bowl”, obtained by carefully stripping off the barrier film from commercially available bowls obtained from the EarthShell Company, (Stock Number BL12V00001). Hinged-lid salad and sandwich “foam containers” with a double-tab closure mechanism, obtained by carefully stripping off the barrier film from commercially available containers obtained from the EarthShell Company, (Stock Number CLS00001).

The laminated pulp plates of Comparative Examples CE 7 and CE 8 and Example 155 are placed in a rotary composter with about 0.5 cubic yards squared of mixed municipal solid waste, (from which glass, cans, and much of the light plastic and paper is removed), and sewage sludge in the ratio of about 2:1. The composter is rotated once a week and the temperature and moisture content is monitored. The laminated pulp plate of Example 155 is found to disintegrate at a rate at least 10 percent faster than is found for the laminated pulp plate of Comparative Example CE 7 and CE 8.

TABLE 20

| | | Film | |
|---|---|---|---|
| | | Preheat | |
| | Film | Time | Preformed |
| Example | Example | (seconds) | Substrate |
| CE 7 | CE 2 | 40 | pulp plate |
| CE 8 | CE 3 | 60 | pulp plate |
| 155 | 4 | 30 | pulp plate |
| 156 | 8 | 40 | tray |
| 157 | 18 | 40 | cup |
| 158 | 24 | 30 | bowl |
| 159 | 29 | 15 | foam plate |
| 160 | 32 | 30 | foam bowl |
| 161 | 35 | 15 | foam containers |
| 162 | 38 | 20 | pulp plate |
| 163 | 45 | 50 | tray |
| 164 | 76 | 20 | foam plate |
| 165 | 79 | 20 | foam containers |
| 166 | 5 | 40 | cup |
| 167 | 9 | 40 | bowl |
| 168 | 21 | 40 | foam bowl |
| 169 | 25 | 30 | foam containers |
| 170 | 30 | 20 | cup |
| 171 | 33 | 20 | bowl |
| 172 | 36 | 10 | foam bowl |
| 173 | 40 | 20 | foam containers |
| 174 | 51 | 40 | cup |
| 175 | 77 | 15 | bowl |
| 176 | 80 | 30 | foam bowl |
| 177 | 86 | 40 | foam containers |
| 178 | 6 | 40 | pulp plate |
| 179 | 10 | 30 | tray |
| 180 | 22 | 40 | cup |
| 181 | 26 | 25 | bowl |
| 182 | 30 | 25 | foam plate |
| 183 | 34 | 20 | foam bowl |
| 184 | 37 | 10 | foam containers |
| 185 | 59 | 20 | pulp plate |
| 186 | 78 | 10 | tray |
| 187 | 82 | 20 | foam plate |
| 188 | 87 | 40 | pulp plate |

Although illustrated and described above with reference to specific embodiments, the present invention is nevertheless not intended to be limited to the details shown. Rather, various modifications may be made in the details within the scope and range of equivalents of the claims and without departing from the spirit of the invention.

1. A film comprising a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylehe ether) glycol component, and 0 to 5.0 mole percent of a polyfunctional branching agent, based on a total of 100 mole percent of glycol components and branching agent.

2. A film according to claim 1, further comprising at least one filler.

3. A film according to claim 2, wherein said filler comprises a space filling mixture of a first set of particles and a second set of particles, said first set of particles having average particle diameters of about 5 microns or more, and said second set of particles having average particle diameters of about 0.7 microns or less.

4. A film according to claim 2 in which the filler is selected from the group consisting of inorganic fillers, organic fillers and clay fillers.

5. A film according to claim 4, wherein said inorganic filler is selected from the group consisting of calcium carbonate, titanium dioxide, silica, talc, barium sulfate, glass beads, glass fiber, carbon black, ceramics, chalk and mixtures thereof.

6. A film according to claim 4, wherein said organic filler is selected from the group consisting of natural starch, modified starch, chemically modified starch, rice starch, corn starch, wood flour, cellulose, and mixtures thereof.

7. A film according to claim 4, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

8. A film comprising a blend comprising about 95.0 to about 5.0 weight percent of a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent and about 5.0 to about 95.0 weight percent of a polymeric material.

9. A film according to claim 8, wherein the polymeric material is selected from the group consisting of biodegradable materials, nonbiodegradable materials, naturally derived materials, modified naturally derived materials, synthetic materials, and mixtures thereof.

10. A film according to claim 9, wherein said polymeric material is a biodegradable material.

11. A film according to claim 10, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

12. A film according to claim 9, wherein said polymeric material is a nonbiodegradable material.

13. A film according to claim 8, further comprising a filler.

14. A film according to claim 13, wherein said filler comprises a space filling mixture of a first set of particles and a second set of particles, said first set of particles having average particle diameters of about 5 microns or more, and said second set of particles having average particle diameters of about 0.7 microns or less.

15. A film according to claim 13 in which the filler is selected from the group consisting of inorganic fillers, organic fillers and clay fillers.

16. A film according to claim 15, wherein said inorganic filler is selected from the group consisting of calcium carbonate, titanium dioxide, silica, talc, barium sulfate, glass beads, glass fiber, carbon black, ceramics, chalk and mixtures thereof.

17. A film according to claim 15, wherein said organic filler is selected from the group consisting of natural starch, modified starch, chemically modified starch, rice starch, corn starch, wood flour, cellulose, and mixtures thereof.

18. A film according to claim 15, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

19. A film comprising a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent.

20. A film comprising a blend comprising about 95.0 to about 5.0 weight percent of a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent and about 5.0 to about 95.0 weight percent of a polymeric material.

21. A film according to claim 20, wherein the polymeric material is selected from the group consisting of biodegradable materials, nonbiodegradable materials, naturally derived materials, modified naturally derived materials, synthetic materials, and mixtures thereof.

22. A film according to claim 21, wherein said polymeric material is a biodegradable material.

23. A film according to claim 22, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

24. A film according to claim 22, wherein said polymeric material is a nonbiodegradable material.

25. A film according to claim 20, further comprising at least one filler.

26. A film according to claim 25, wherein said filler comprises a space filling mixture of a first set of particles and a second set of particles, said first set of particles having average particle diameters of about 5 microns or more, and said second set of particles having average particle diameters of about 0.7 microns or less.

27. A film according to claim 25 in which the filler is selected from the group consisting of inorganic fillers, organic fillers and clay fillers.

28. A film according to claim 27, wherein said inorganic filler is selected from the group consisting of calcium carbonate, titanium dioxide, silica, talc, barium sulfate, glass beads, glass fiber, carbon black, ceramics, chalk and mixtures thereof.

29. A film according to claim 27, wherein said organic filler is selected from the group consisting of natural starch, modified starch, chemically modified starch, rice starch, corn starch, wood flour, cellulose, and mixtures thereof.

30. A film according to claim 27, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

31. A multilayer film comprising 2 to 6 layers with at least one layer comprising a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent and at least one layer comprising a polymeric material.

32. A multilayer film according to claim 31, wherein the polymeric material is selected from the group consisting of biodegradable materials, nonbiodegradable materials, naturally derived materials, modified naturally derived materials, synthetic materials, and mixtures thereof.

33. A multilayer film according to claim 31, wherein said polymeric material is a biodegradable material.

34. A multilayer film according to claim 33, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

35. A multilayer film according to claim 28, wherein said polymer is a nonbiodegradable material.

36. A multilayer film according to claim 31, further comprising at least one filler.

37. A multilayer film according to claim 36, wherein said filler comprises a space filling mixture of a first set of particles and a second set of particles, said first set of particles having average particle diameters of about 5 microns or more, and said second set of particles having average particle diameters of about 0.7 microns or less.

38. A multilayer film according to claim 36 in which the filler is selected from the group consisting of inorganic fillers, organic fillers and clay fillers.

39. A multilayer film according to claim 38, wherein said inorganic filler is selected from the group consisting of calcium carbonate, titanium dioxide, silica, talc, barium sulfate, glass beads, glass fiber, carbon black, ceramics, chalk and mixtures thereof.

40. A multilayer film according to claim 38, wherein said organic filler is selected from the group consisting of natural starch, modified starch, chemically modified starch, rice starch, corn starch, wood flour, cellulose, and mixtures thereof.

41. A multilayer film according to claim 38, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

42. A multilayer film comprising 2 to 6 layers, wherein at least one layer comprises a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent, wherein at least one layer comprises a polymeric material.

43. A multilayer film according to claim 42, wherein the polymeric material is selected from the group consisting of biodegradable materials, nonbiodegradable materials, naturally derived materials, modified naturally derived materials, synthetic materials, and mixtures thereof.

44. A multilayer film according to claim 43, wherein said polymeric material is a biodegradable material.

45. A multilayer film according to claim 44, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

46. A multilayer film according to claim 43, wherein said polymeric material is a nonbiodegradable material.

47. A multilayer film according to claim 42, further comprising at least one filler.

48. A multilayer film according to claim 47, wherein said filler comprises a space filling mixture of a first set of particles and a second set of particles, said first set of particles having average particle diameters of about 5 microns or more, and said second set of particles having average particle diameters of about 0.7 microns or less.

49. A multilayer film according to claim 47 wherein the filler is selected from the group consisting of inorganic fillers, organic fillers and clay fillers.

50. A multilayer film according to claim 49, wherein said inorganic filler is selected from the group consisting of calcium carbonate, titanium dioxide, silica, talc, barium sulfate, glass beads, glass fiber, carbon black, ceramics, chalk and mixtures thereof.

51. A multilayer film according to claim 49, wherein said organic filler is selected from the group consisting of natural starch, modified starch, chemically modified starch, rice starch, corn starch, wood flour, cellulose, and mixtures thereof.

52. A multilayer film according to claim 49, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

53. An oriented film comprising a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

54. An oriented film according to claim 53, further comprising a filler.

55. An oriented film according to claim 54, wherein said filler comprises a space filling mixture of a first set of particles and a second set of particles, said first set of particles having average particle diameters of about 5 microns or more, and said second set of particles having average particle diameters of about 0.7 microns or less.

56. An oriented film according to claim 54 wherein the filler is selected from the group consisting of inorganic fillers, organic fillers and clay fillers.

57. An oriented film according to claim 56, wherein said inorganic filler is selected from the group consisting of calcium carbonate, titanium dioxide, silica, kaolin, barium sulfate, glass beads, glass fiber, carbon black, ceramics, chalk and mixtures thereof.

58. An oriented film according to claim 56, wherein said organic filler is selected from the group consisting of natural starch, modified starch, chemically modified starch, rice starch, corn starch, wood flour, cellulose, and mixtures thereof.

59. An oriented film according to claim 56, wherein said clay filler is selected from the group consisting of natural clays, synthetic clays, treated clays, untreated clays, organoclays, smectite clays, bentonite clays, hectorite clays, wollastonite clays, montmorillonite clays and mixtures thereof.

60. An oriented film comprising a blend comprising about 95.0 to about 5.0 weight percent of a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent and about 5.0 to about 95.0 weight percent of a polymeric material.

61. An oriented film according to claim 60, wherein the polymeric material is selected from the group consisting of biodegradable materials, nonbiodegradable materials, naturally derived materials, modified naturally derived materials, synthetic materials, and mixtures thereof.

62. An oriented film according to claim 61, wherein said polymeric material is a biodegradable material.

63. An oriented film according to claim 62, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

64. An oriented film according to claim 60, wherein said polymer is a nonbiodegradable material.

65. An oriented film according to claim 60, further comprising at least one filler.

66. An oriented film according to claim 65, wherein said filler comprises a space filling mixture of a first set of particles and a second set of particles, said first set of particles having average particle diameters of about 5 microns or more, and said second set of particles having average particle diameters of about 0.7 microns or less.

67. An oriented film according to claim 65 wherein the filler is selected from the group consisting of inorganic fillers, organic fillers and clay fillers.

68. An oriented film according to claim 67, wherein said inorganic filler is selected from the group consisting of calcium carbonate, titanium dioxide, silica, talc, barium sulfate, glass beads, glass fiber, carbon black, ceramics, chalk and mixtures thereof.

69. An oriented film according to claim 67, wherein said organic filler is selected from the group consisting of natural starch, modified starch, chemically modified starch, rice starch, corn starch, wood flour, cellulose, and mixtures thereof.

70. An oriented film according to claim 67, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

71. An oriented film comprising a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent.

72. An oriented film according to claim 71, further comprising a filler.

73. An oriented film according to claim 71, wherein said filler comprises a space filling mixture of a first set of particles and a second set of particles, said first set of particles having average particle diameters of about 5 microns or more, and said second set of particles having average particle diameters of about 0.7 microns or less.

74. An oriented film according to claim 71 in which the filler is selected from the group consisting of inorganic fillers, organic fillers and clay fillers.

75. An oriented film according to claim 74, wherein said inorganic filler is selected from the group consisting of calcium carbonate, titanium dioxide, silica, talc, barium sulfate, glass beads, glass fiber, carbon black, ceramics, chalk and mixtures thereof.

76. An oriented film according to claim 74, wherein said organic filler is selected from the group consisting of natural starch, modified starch, chemically modified starch, rice starch, corn starch, wood flour, cellulose, and mixtures thereof.

77. An oriented film according to claim 74, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

78. An oriented film comprising a blend comprising about 95.0 to about 5.0 weight percent of a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent and about 5.0 to about 95.0 weight percent of a polymeric material.

79. An oriented film according to claim 78, wherein the polymeric material is selected from the group consisting of biodegradable materials, nonbiodegradable materials, naturally derived materials, modified naturally derived materials, synthetic materials, and mixtures thereof.

80. An oriented film according to claim 79, wherein said polymeric material is a biodegradable material.

81. An oriented film according to claim 80, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

82. An oriented film according to claim 79, wherein said polymeric material is a nonbiodegradable material.

83. An oriented film according to claim 78, further comprising at least one filler.

84. An oriented film according to claim 83, wherein said filler comprises a space filling mixture of a first set of particles and a second set of particles, said first set of particles having average particle diameters of about 5 microns or more, and said second set of particles having average particle diameters of about 0.7 microns or less.

85. An oriented film according to claim 83 wherein the filler is selected from the group consisting of inorganic fillers, organic fillers and clay fillers.

86. An oriented film according to claim 85, wherein said inorganic filler is selected from the group consisting of calcium carbonate, titanium dioxide, silica, talc, barium sulfate, glass beads, glass fiber, carbon black, ceramics, chalk and mixtures thereof.

87. An oriented film according to claim 85, wherein said organic filler is selected from the group consisting of natural starch, modified starch, chemically modified starch, rice starch, corn starch, wood flour, cellulose, and mixtures thereof.

88. An oriented film according to claim 85, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

89. An oriented multilayer film comprising 2 to 6 layers wherein at least one layer comprises a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent and at least one layer comprising a polymeric material.

90. An oriented multilayer film according to claim 89, wherein the polymeric material is selected from the group consisting of biodegradable materials, nonbiodegradable materials, naturally derived materials, modified naturally derived materials, synthetic materials, and mixtures thereof.

91. An oriented multilayer film according to claim 90, wherein said polymeric material is a biodegradable material.

92. An oriented multilayer film according to claim 91, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

93. An oriented multilayer film according to claim 90, wherein said polymer is a nonbiodegradable material.

94. An oriented film according to claim 89, further comprising at least one filler.

95. An oriented film according to claim 94, wherein said filler comprises a space filling mixture of a first set of particles and a second set of particles, said first set of particles having average particle diameters of about 5 microns or more, and said second set of particles having average particle diameters of about 0.7 microns or less.

96. A film according to claim 2 in which the filler is selected from the group consisting of inorganic fillers, organic fillers and clay fillers.

97. An oriented film according to claim 96, wherein said inorganic filler is selected from the group consisting of calcium carbonate, titanium dioxide, silica, talc, barium sulfate, glass beads, glass fiber, carbon black, ceramics, chalk and mixtures thereof.

98. An oriented film according to claim 96, wherein said organic filler is selected from the group consisting of natural starch, modified starch, chemically modified starch, rice starch, corn starch, wood flour, cellulose, and mixtures thereof.

99. An oriented film according to claim 96, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

100. An oriented multilayer film comprising 2 to 6 layers with at least one layer comprising a sulfonated aliphatic-aromatic copolyetherester, said sulfonated aliphatic-aromatic copolyetherester comprising:
from about 80.0 to about 50.0 mole percent of an aromatic dicarboxylic acid component, from about 20.0 to about 50.0 mole percent of an aliphatic dicarboxylic acid component, and from about 0.1 to about 4.0 mole percent of a sulfonate component, based on a total of 100 mole percent of total dicarboxylic acid and sulfonate components; and
from about 99.9 to about 91.0 mole percent of a first glycol component selected from the group consisting of ethylene glycol, 1,3-propanediol and 1.4-butanediol, from about 0.1 to about 4.0 mole percent of a poly(alkylene ether) glycol component, and 0 to 1.0 mole percent of a polyfunctional branching agent, based on a total of 100 mole percent of glycol components and branching agent and at least one layer comprising a polymeric material.

101. An oriented multilayer film according to claim 100, wherein the polymeric material is selected from the group consisting of biodegradable materials, nonbiodegradable materials, naturally derived materials, modified naturally derived materials, synthetic materials, and mixtures thereof.

102. An oriented multilayer film according to claim 101, wherein said polymeric material is a biodegradable material.

103. An oriented multilayer film according to claim 102, wherein said biodegradable material is selected from the group consisting of poly(alkanoate)s, aliphatic polyesters, aliphatic-aromatic polyesters, aliphatic-aromatic polyetheresters, aliphatic-aromatic polyamideesters, sulfonated aliphatic-aromatic polyesters, sulfonated aliphatic-aromatic polyetheresters, thermoplastic starch, and mixtures thereof.

104. An oriented multilayer film according to claim 101, wherein said polymeric material is a nonbiodegradable material.

105. An oriented film according to claim 100, further comprising at least one filler.

106. An oriented film according to claim 105, wherein said filler comprises a space filling mixture of a first set of particles and a second set of particles, said first set of particles having average particle diameters of about 5 microns or more, and said second set of particles having average particle diameters of about 0.7 microns or less.

107. An oriented film according to claim 105 wherein the filler is selected from the group consisting of inorganic fillers, organic fillers and clay fillers.

108. An oriented film according to claim 107, wherein said inorganic filler is selected from the group consisting of calcium carbonate, titanium dioxide, silica, talc, barium sulfate, glass beads, glass fiber, carbon black, ceramics, chalk and mixtures thereof.

109. An oriented film according to claim 107, wherein said organic filler is selected from the group consisting of natural starch, modified starch, chemically modified starch, rice starch, corn starch, wood flour, cellulose, and mixtures thereof.

110. An oriented film according to claim 107, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

111. An article comprising a substrate and a film, said film containing a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

112. An article according to claim 111, wherein said substrate is selected from the group consisting of paper, paperboard, inorganic foams, organic foams, inorganic-organic foams.

113. An article according to claim 111, wherein said film further comprises a filler.

114. An article according to claim 113, wherein said filler comprises a space filling mixture of a first set of particles and a second set of particles, said first set of particles having average particle diameters of about 5 microns or more, and said second set of particles having average particle diameters of about 0.7 microns or less.

115. An oriented film according to claim 105 wherein the filler is selected from the group consisting of inorganic fillers, organic fillers and clay fillers.

116. An oriented film according to claim 107, wherein said inorganic filler is selected from the group consisting of calcium carbonate, titanium dioxide, silica, talc, barium sulfate, glass beads, glass fiber, carbon black, ceramics, chalk and mixtures thereof.

117. An oriented film according to claim 107, wherein said organic filler is selected from the group consisting of natural starch, modified starch, chemically modified starch, rice starch, corn starch, wood flour, cellulose, and mixtures thereof.

118. An oriented film according to claim 107, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

119. A process for producing a package, comprising:
providing a substrate;
forming said substrate into a desired package form;
providing a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent; and
laminating or coating said substrate with said sulfonated aliphatic-aromatic copolyetherester to form said package.

120. A process according to claim 119 wherein said substrate comprises a material selected from the group consisting of paper, paperboard, inorganic foams, organic foams, and inorganic-organic foams.

121. A process according to claim 119 wherein said package form is selected from the group consisting of wrappers, stretch wrap films, bags, cups, trays, cartons, boxes, bottles, crates, packaging films, blister pack wrappers, skin packaging, and hinged containers.

122. A package comprising a substrate and a film containing a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

123. A package according to claim 122, wherein said package is selected from the group consisting of wrappers, stretch wrap films, bags, cups, trays, cartons, boxes, bottles, crates, packaging films, blister pack wrappers, skin packaging, and hinged containers.

124. A package according to claim 122, wherein said package comprises a substrate and said film is laminated onto said substrate.

125. A package according to claim 124, wherein said substrate is selected from the group consisting of paper, paperboard, inorganic foams, organic foams, and inorganic-organic foams.

126. A package according to claim 122, wherein said package comprises a substrate coated by said film.

127. A package according to claim 126, wherein said substrate is selected from the group consisting of paper, paperboard, inorganic foams, organic foams, and inorganic-organic foams.

128. A package according to claim 122, wherein said film is uniaxially oriented.

129. A package according to claim 122, wherein said film is biaxially oriented.

130. A package according to claim 122, wherein said sulfonated aliphatic-aromatic copolyetherester contains a filler.

131. A package according to claim 130, wherein said filler comprises a mixture of a first set of particles and a second set of particles, said first set of particles having average particle diameters of about 5 microns or more, and said second set of particles having average particle diameters of about 0.7 microns or less.

132. A package according to claim 130 wherein the filler is selected from the group consisting of inorganic fillers, organic fillers and clay fillers.

133. A package according to claim 132, wherein said inorganic filler is selected from the group consisting of calcium carbonate, titanium dioxide, silica, talc, barium sulfate, glass beads, glass fiber, carbon black, ceramics, chalk and mixtures thereof.

134. A package according to claim 132, wherein said organic filler is selected from the group consisting of natural starch, modified starch, chemically modified starch, rice starch, corn starch, wood flour, cellulose, and mixtures thereof.

135. A package according to claim 132, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

136. A method for packaging food, comprising enclosing said food in a package that comprises a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

137. A method according to claim 136, wherein said package further comprises a substrate, and said sulfonated aliphatic-aromatic copolyetherester is laminated onto or coated onto said substrate.

138. A method according to claim 137, wherein said substrate is selected from the group consisting of paper, paperboard, inorganic foams, organic foams, and inorganic-organic foam.

139. A method according to claim 136, wherein said sulfonated aliphatic-aromatic copolyetherester contains a filler.

140. A method according to claim 139, wherein said filler comprises a mixture of a first set of particles and a second set of particles, said first set of particles having average particle diameters of about 5 microns or more, and said second set of particles having average particle diameters of about 0.7 microns or less.

141. A method according to claim 139 wherein the filler is selected from the group consisting of inorganic fillers, organic fillers and clay fillers.

142. A method according to claim 141, wherein said inorganic filler is selected from the group consisting of calcium carbonate, titanium dioxide, silica, talc, barium sulfate, glass beads, glass fiber, carbon black, ceramics, chalk and mixtures thereof.

143. A method according to claim 141, wherein said organic filler is selected from the group consisting of natural starch, modified starch, chemically modified starch, rice starch, corn starch, wood flour, cellulose, and mixtures thereof.

144. A method according to claim 141, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.

145. A process for producing a package, comprising:
providing a substrate;
providing a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and
from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent; and
laminating or coating said substrate with said sulfonated aliphatic-aromatic copolyetherester;
forming said laminated or coated substrate into a desired package form to form said package.

146. A process according to claim 139 wherein said substrate comprises a material selected from the group consisting of paper, paperboard, inorganic foams, organic foams, and inorganic-organic foams.

147. A process according to claim 139 wherein said package form is selected from the group consisting of wrappers, stretch wrap films, bags, cups, trays, cartons, boxes, bottles, crates, packaging films, blister pack wrappers, skin packaging, and hinged containers.

148. A process for producing a film comprising heating a sulfonated aliphatic-aromatic copolyetherester composition to a molten state, extruding said molten sulfonated aliphatic-aromatic copolyesterester through a die and cooling said film, wherein said film comprises a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and
from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

149. The process of claim 142, further comprising optionally heating the film in the range of above the glass transition temperature of the sulfonated aliphatic-aromatic copolyetherester composition and below the softening point of the sulfonated aliphatic-aromatic copolyetherester and stretching the film in the machine direction 1.5 to 10 times the unstretched length of the original film.

150. The process of claim 142, further comprising optionally heating the film in the range of above the glass transition temperature of the sulfonated aliphatic-aromatic copolyetherester composition and below the softening point of the sulfonated aliphatic-aromatic copolyetherester, stretching the film in the machine direction 1.5 to 10 times the unstretched length of the original film, and stretching the film in the transverse direction 1.5 to 10 times the unstretched width of the original film.

151. A package comprising a film containing a sulfonated aliphatic-aromatic copolyetherester, said sulfonated aliphatic-aromatic copolyetherester comprising:
from about 80.0 to about 20.0 mole percent of an aromatic dicarboxylic acid component, from about 20.0 to about 80.0 mole percent of an aliphatic dicarboxylic acid component, and
from about 0.1 to about 10.0 mole percent of a sulfonate component, based on a total of 100 mole percent of total dicarboxylic acid and sulfonate components; and
from about 99.9 to about 76.0 mole percent of a first glycol component selected from the group consisting of ethylene glycol, 1,3-propanediol and 1.4-butanediol, from 0 to about 5.0 mole percent of a second glycol component, from about 0.1 to about 4.0 mole percent of a poly(alkylene ether) glycol component, and 0 to 5.0 mole percent of a polyfunctional branching agent, based on a total of 100 mole percent of glycol components and branching agent.

152. A package according to claim 145, wherein said package is selected from the group consisting of wrappers, stretch wrap films, bags packaging films, blister pack wrappers, and skin packaging.

153. A package according to claim 145, wherein said film is uniaxially oriented.

154. A package according to claim 145, wherein said film is biaxially oriented.

155. A package according to claim 145, wherein said sulfonated aliphatic-aromatic copolyetherester contains a filler.

156. A package according to claim 149, wherein said filler comprises a mixture of a first set of particles and a second set of particles, said first set of particles having average particle diameters of about 5 microns or more, and said second set of particles having average particle diameters of about 0.7 microns or less.

157. A package according to claim 149 wherein the filler is selected from the group consisting of inorganic fillers, organic fillers and clay fillers.

158. A package according to claim 157, wherein said inorganic filler is selected from the group consisting of calcium carbonate, titanium dioxide, silica, talc, barium sulfate, glass beads, glass fiber, carbon black, ceramics, chalk and mixtures thereof.

159. A package according to claim 157, wherein said organic filler is selected from the group consisting of natural starch, modified starch, chemically modified starch, rice starch, corn starch, wood flour, cellulose, and mixtures thereof.

160. A package according to claim 157, wherein said clay filler is selected from the group consisting of natural clays, synthetic clays, treated clays, untreated clays, organoclays, smectite clays, bentonite clays, hectorite clays, wollastonite clays, montmorillonite clays, kaolin, and mixtures thereof.
